(19) United States
(12) Patent Application Publication
(10) Pub. No.: US 2014/0074932 A1
(43) Pub. Date: Mar. 13, 2014

(54) COMMUNICATION SYSTEM, INFORMATION PROCESSING DEVICE, AND TERMINAL

(71) Applicants: Akihiro MIHARA, Tokyo (JP); Yoshinaga Kato, Kanagawa (JP); Takahiro Asai, Kanagawa (JP); Hiroaki Uchiyama, Kanagawa (JP)

(72) Inventors: Akihiro MIHARA, Tokyo (JP); Yoshinaga Kato, Kanagawa (JP); Takahiro Asai, Kanagawa (JP); Hiroaki Uchiyama, Kanagawa (JP)

(21) Appl. No.: 14/019,966

(22) Filed: Sep. 6, 2013

(30) Foreign Application Priority Data
Sep. 13, 2012 (JP) 2012-201144

(51) Int. Cl. H04L 29/08

(52) U.S. Cl. CPC H04L 67/06
USPC 709/204

(57) ABSTRACT

Disclosed is a communication system including terminals which participate in a conference and a file sharing apparatus that provides a file to the terminals, the communication system including an attribute storage unit that stores attributes of the terminals; a shared folder location information notification unit that transmits location information of a shared folder; and a shared folder storage unit that stores the location information of the shared folder and identification information of the terminals being associated with conference identification information. The file sharing apparatus includes the shared folder; and a file synchronization unit that transmits the file to the terminals. Each of the terminals includes a folder mount unit that mounts the shared folder on the terminal; and another file synchronization unit that transmits another file to the shared folder, the other file being stored in a storage area created by the mounting.

### BACKGROUND OF THE INVENTION

1. Field of the Invention

The present invention relates to a communication system in which video or audio content data is relayed among a plurality of terminals.

2. Description of the Related Art

An electronic conference system has been widely adopted in which terminals located at distant places communicate with each other through a network such as the Internet, and thereby a conference is conducted. In the electronic conference system, an image which is photographed by a camera of the terminal which is operated by one of participants of the conference and sound which is collected by a microphone of the terminal are transmitted to the terminal of the counterpart. Since the terminal of the counterpart displays the image on a display and outputs the sound by a speaker or a headset, the participants may share the image and the sound, even if the terminals are located at the distant places (c.f. Patent Document 1 (Japanese Unexamined Patent Publication No. 2011-254453)). Patent Document 1 discloses a technique for sharing a document which is used for a conference. In the technique, a document which is the same as that of a transmission source is displayed on a terminal of the counterpart of the conference by transmitting the display data of the document to the counterpart.

In many cases, a document which is displayed on the terminal of the transmission source and the terminal of the counterpart is a file of an application program. Contrary to this, a screen which is shared by the electronic conference system is the screen which captures the document (hard copy of the document) which is displayed on the display. Accordingly, it is possible that a participant wishes to view all parts of the document, since the screen includes only a part of the document, or the participant wishes to view the previous page and the next page. Further, it is possible that the participant wishes to magnify a character or a figure, since the character or the figure is small.

A file itself, which is displayed as a document, may be shared between the terminals. As a method of sharing the file, a method can be considered such that the terminal of the transmission source attaches the file to an e-mail, and the e-mail is transmitted to the terminal of the counterpart, or a method can be considered such that a file is shared through a network storage. However, when a user of the terminal (e.g., a presenter), who operates the terminal, transmits an e-mail during operating the terminal, operability of the electronic conference system may be lowered. Further, an e-mail address of the counterpart may be known in advance, and the process may be complicated. Furthermore, for the case of an e-mail, security of the attached document may not be guaranteed on the network. When the network storage is utilized, it may be required to create accounts for the transmitting side and receiving side in advance, and a process may be complicated. Furthermore, security may not be sufficient when the data is shared by using the Internet.

Additionally, a method can be considered such that the service which transmits the image and the sound also transmits the document. However, since this service is performing the process of smoothly transmitting the image and the sound, and the process of smoothly receiving the image and the sound from the terminal of the counterpart, if the document is transmitted and received, the conference may not progress smoothly.

Accordingly, there is a need for a communication system which enables sharing of images and sound such that a document which is used for a conference can be securely shared.

### SUMMARY OF THE INVENTION

According to an aspect of the present invention, there is provided a communication system including a plurality of terminals which participate in a conference and a file sharing apparatus configured to provide a file to the terminals. The communication system includes an attribute storage unit configured to store attributes of the terminals; a shared folder location information notification unit configured to transmit location information of a shared folder, wherein the shared folder is created based on the attributes of the terminals which participate in the conference; and a shared folder storage unit configured to store the location information of the shared folder and identification information of the terminals which mount the shared folder, wherein the shared folder storage unit is configured to associate conference identification information with the location information of the shared folder and the identification information of the terminals. The file sharing apparatus includes the shared folder which is created at a location indicated by the location information of the shared folder; and a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference. Each of the terminals includes a folder mount unit configured to mount the shared folder on the terminal; and a second file synchronization unit configured to transmit a second file to the shared folder, wherein the second file is stored in a storage area created by the mounting.

According to another aspect of the present invention, there is provided an information processing apparatus for providing a file to a plurality of terminals wherein the terminals participate in a conference, and each of the terminals includes a folder mount unit configured to mount a shared folder to the terminal; a second synchronization unit configured to transmit a second file to the shared folder, wherein the second file is stored in a storage area created by the mounting. The information processing apparatus includes an attribute storage unit configured to store attributes of the terminals; a shared folder location information notification unit configured to transmit location information of the shared folder, wherein the shared folder is created based on the attributes of the terminals which participate in the conference; a shared folder storage unit configured to store the location information of the shared folder and identification information of the terminals which mount the shared folder, wherein the shared folder storage unit is configured to associate conference identification information with the location information of the shared folder and the identification information of the terminals; the shared folder which is created at a location indicated by the location information of the shared folder; and a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference.

According to another aspect of the present invention, there is provided a terminal configured to connected to a communication system. The communication system includes a plurality of terminals which participate in a conference; a file sharing apparatus configured to provide a file to the terminals; an attribute storage unit configured to store attributes of the terminals; a shared folder location information notification unit configured to transmit location information of a shared folder, wherein the shared folder is created based on the attributes of the terminals which participate in the conference; and a shared folder storage unit configured to store the location information of the shared folder and identification information of the terminals which mount the shared folder, wherein the shared folder storage unit is configured to associate conference identification information with the location information of the shared folder and the identification information of the terminals. The file sharing apparatus includes the shared folder which is created at a location indicated by the location information of the shared folder; and a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference. The terminal includes a folder mount unit configured to mount the shared folder on the terminal; and a second file synchronization unit configured to transmit a second file to the shared folder, wherein the second file is stored in a storage area created by the mounting.

According to an embodiment of the present invention, there can be provided a communication system which enables sharing of an image and sound such that a document which is used for a conference can be securely shared.

Other objects, features and advantages of the present invention will become more apparent from the following detailed description when read in conjunction with the accompanying drawings.

### BRIEF DESCRIPTION OF THE DRAWINGS

FIGS. 1A and 1B are schematic diagrams of a transmission system according to an embodiment of the present invention;

FIG. 2 is a diagram showing an external view of a transmission terminal device according to the embodiment;

FIG. 3 is a diagram showing a hardware configuration of the transmission terminal device according to the embodiment;

FIG. 4 is a diagram showing an example in which the transmission terminal device is a communication terminal such as a personal computer (PC);

FIG. 5 is a diagram showing a hardware configuration diagram of any one of a transmission management system, a relay device, a program providing system, a file temporary storage device, and a maintenance system according to the embodiment of the present invention;

FIGS. 6A, 6B, 6C, and 6D are functional block diagrams of the terminal device, the communication terminal, the relay device, the file temporary storage device, and the transmission management system, which are included in the transmission system according to the embodiment;

FIG. 7 is a functional block diagram showing details of the relay device selection unit which is shown in FIG. 6B;

FIG. 8 is a conceptual diagram showing a change-quality management table;

FIGS. 9A, 9B, and 9C are conceptual diagrams illustrating image quality of image data;

FIG. 10 is a conceptual diagram showing a relay device management table;

FIG. 11 is a conceptual diagram showing a terminal authentication management table;

FIG. 12 is a conceptual diagram showing a terminal management table;

FIG. 13 is a conceptual diagram showing a destination list management table;

FIG. 14 is a conceptual diagram showing a session management table;

FIG. 15 is a conceptual diagram showing a quality management table;

FIG. 16 is a conceptual diagram showing an attribute management table;

FIGS. 17A, 17B, and 17C are conceptual diagrams showing shared folder tables;

FIG. 18 is a sequence diagram showing a process of managing state information indicating operating states of the corresponding relay devices;

FIG. 19 is a conceptual diagram showing a state of transmitting and receiving image data, audio data, and various types of management data in the transmission system;

FIG. 20 is a sequence diagram showing a preparatory stage to start calling among transmission terminals;

FIG. 21 is a sequence diagram showing a process of selecting a relay device;

FIG. 22 is a conceptual diagram showing the destination list according to the embodiment;

FIG. 23 is a schematic diagram illustrating characteristics of an example of an electronic conference system;

FIG. 24 is a diagram showing an example of an arrangement of shared folders;

FIG. 25 is a schematic configuration diagram of an example of an electronic conference system;

FIG. 26 is a sequence diagram of an example of procedures, in which the terminal devices of the electronic conference system transmit and receive files;

FIG. 27 is a schematic diagram illustrating an example of mounting the shared folder;

FIGS. 28A and 28B are schematic diagrams illustrating an example of sharing a file;

FIGS. 29A and 29B are schematic diagrams illustrating an example of sharing a file;

FIGS. 30A and 30B are schematic diagrams illustrating an example of sharing a file;

FIG. 31 is an example of a sequence diagram of an example of procedures, in which the terminal devices of the electronic conference system transmit and receive files;

FIG. 32 is a sequence diagram showing an example of procedures of terminating a conference conducted with the electronic conference system;

FIG. 33 is a schematic configuration diagram of the electronic conference system according to the embodiment;

FIG. 34 is a sequence diagram showing an example of procedures, in which the terminal devices of the electronic conference system transmit and receive files; and

FIG. 35 is a flowchart showing an example of a procedure for the management system to determine a routing path.

### DETAILED DESCRIPTION OF THE PREFERRED EMBODIMENTS

Hereinafter, there is explained a configuration for implementing an embodiment of the present invention by referring to the accompanying drawings.

### Overall Configuration of the Embodiment

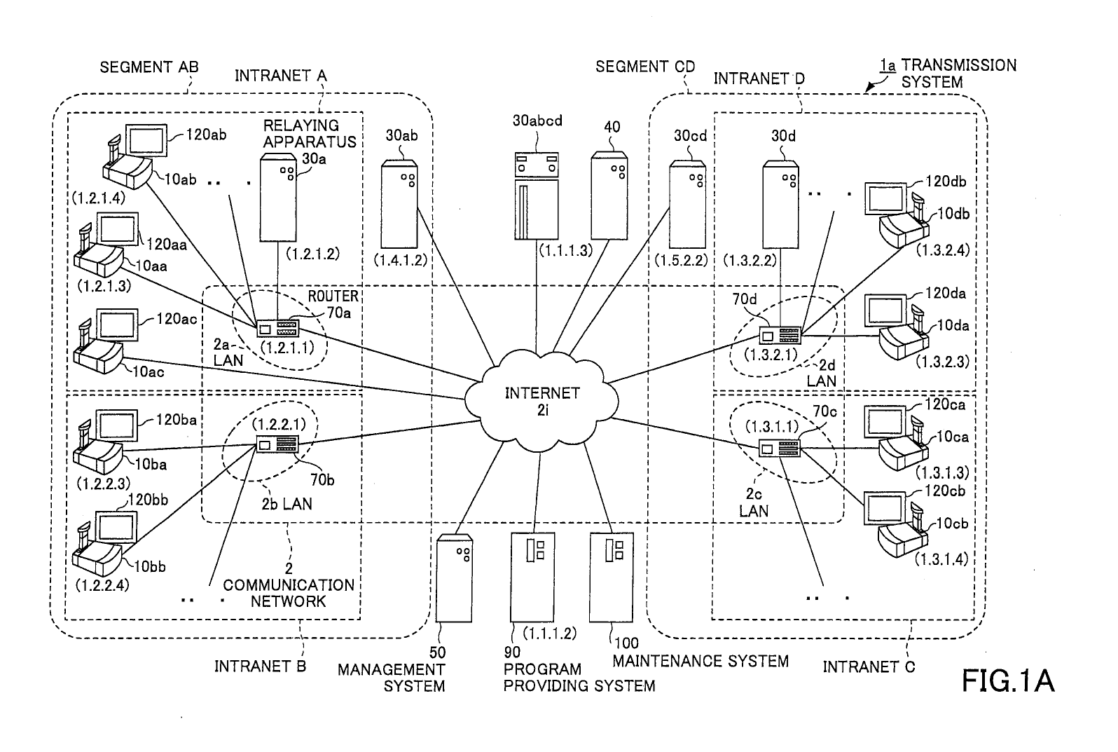

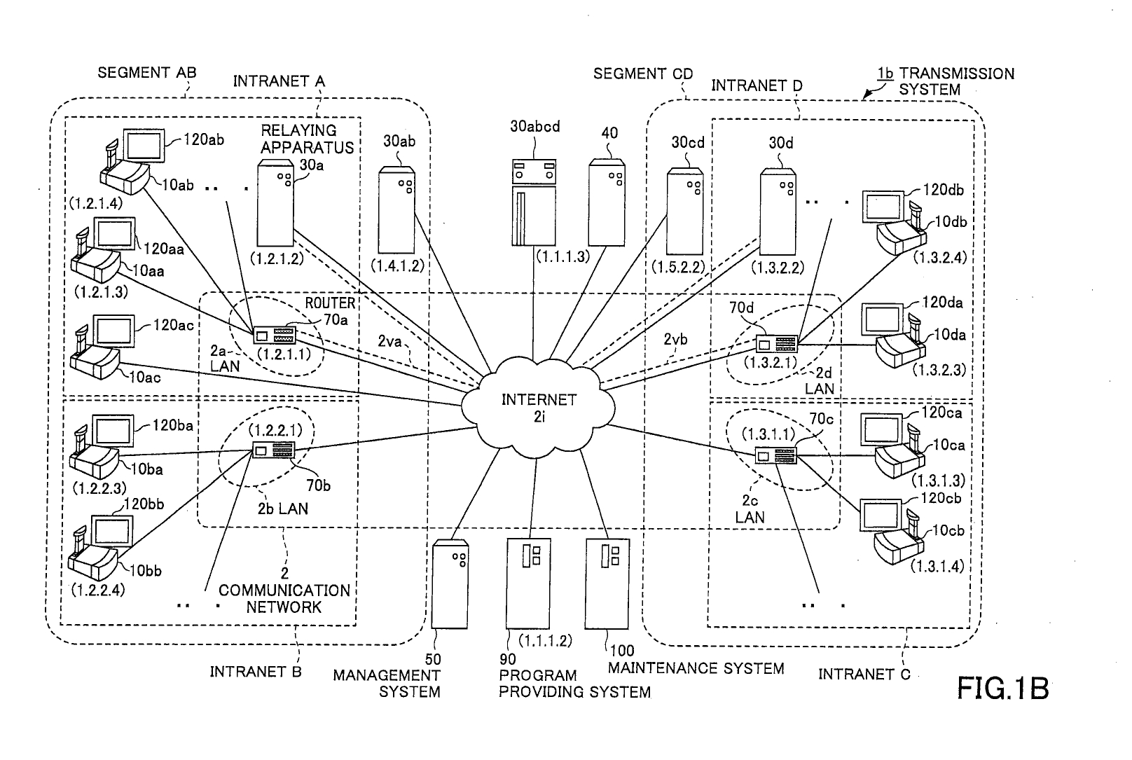

An outline of the embodiment is explained by referring to FIGS. 1A and 1B. FIGS. 1A and 1B are schematic diagrams of transmission systems 1a and 1b according to the embodiment of the present invention, respectively.

The transmission system 1 (1a or 1b) includes a data providing system in which a transmission terminal device unilaterally transmits content data to another transmission terminal device through a transmission management system 50, and a communication system in which plural transmission terminal devices mutually transmit information and impressions through the transmission management system 50. The communication system is for a plurality of communication terminal devices (which correspond to the “transmission terminal devices”) to mutually communicate information and impressions through a communication management system (which corresponds to the “transmission management system 50”). Examples of the communication system includes a video conference system, a videophone system, an audio conferencing system, a voice telephone system, a personal computer (PC) screen sharing system, etc.

In the embodiment, a video conference system is assumed to be an example of the communication system 1, a video conference management system is assumed to be an example of the communication management system 50, and a video conference terminal device is assumed to be an example of the communication terminal device. Based on these assumptions, there is explained the transmission system 1, the transmission management system 50, and the transmission terminal devices. Namely, the transmission terminal devices and the transmission management system 50 according to the embodiment of the present invention can be applied to the video conference system as well as the communication system and a transmission system.

The transmission system 1a shown in FIG. 1A includes plural transmission terminal devices (10aa, 10ab, . . . ); displays (120aa, 120ab, . . . ) for the corresponding transmission terminal devices (10aa, 10ab, . . . ); a plurality of relaying apparatuses (30a, 30ab, 30cd, 30d, and 30abcd); the transmission management system 50; a program providing system 90; a file temporary storage device 40; and a maintenance system 100.

Hereinafter, the “transmission terminal” is simply denoted as the “terminal,” and the “transmission management system 50” is simply denoted as the “management system 50.” In the embodiment, the “terminal 10” represents any one of the transmission terminal devices (10aa, 10ab, . . . ); the “display 120” represents any one of the displays (120aa, 120ab, . . . ), and “the relaying apparatus 30” represents any one of the relaying apparatus (30a, 30ab, 30cd, 30d and 30abcd).

The terminal 10 transmits and receives image data and audio data as an example of content data. Namely, in the embodiment, calling includes transmission and reception of voice data as well as transmission and reception of image data. Namely, the terminal 10 according to the embodiment performs transmission and reception of image data and audio data. However, the terminal 10 may not perform transmission and reception of image data, and the terminal 10 may perform only transmission and reception of voice data.

In the embodiment, there is explained an example case in which an image included in image data is a moving picture. However, the image is not limited to the moving picture, and the image may be a still picture. Further, the image included in the image data may include both the moving picture and the still picture. The relaying apparatus 30 relays image data and audio data among the plurality of terminals 10. The management system 50 centrally manages the terminal 10, the relaying apparatus 30, and the file temporary storage device 40.

Further, FIGS. 1A and 1B show a plurality of routers (70a, 70b, 70c, and 70d). The routers 70a, 70b, 70c, and 70d select corresponding optimum routes for the image data and audio data. In the embodiment, the “router 70” represents any one of the routers (70a, 70b, 70c, and 70d).

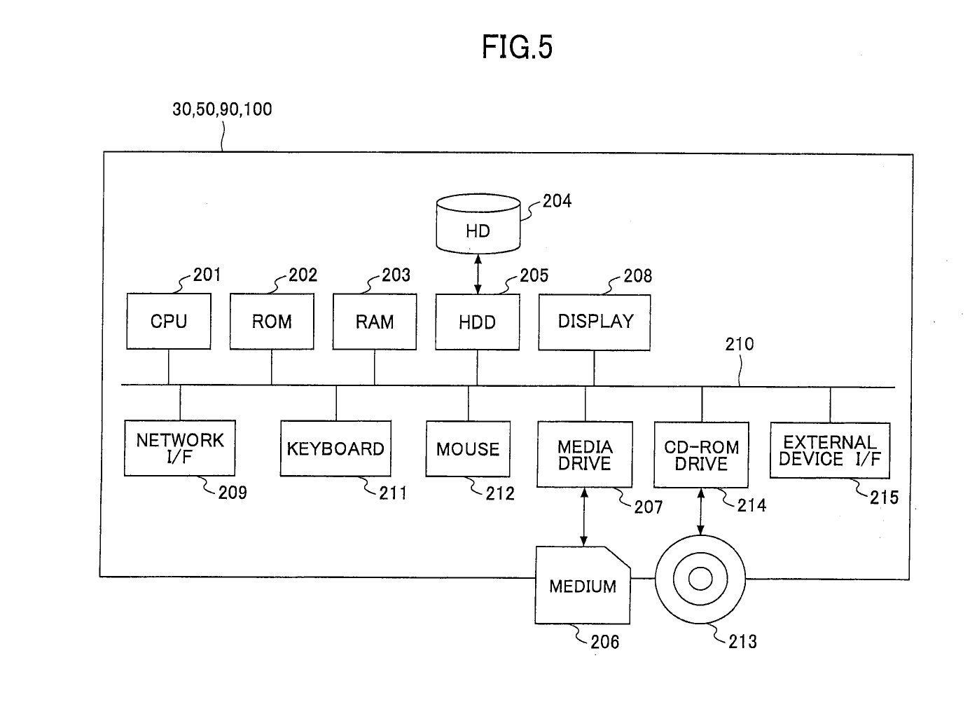

A program providing system 90 includes a hard disk (HD) 204 which is shown in FIG. 5 (FIG. 5 is explained later). The hard disk (HD) 204 stores a terminal program which causes the terminal 10 to perform various types of functions, and to achieve various types of units. The program providing system 90 can transmit the terminal program to the terminal 10. Further, a relaying apparatus program is stored in the hard disk (HD) 204 of the program providing system 90. The relaying apparatus program causes the relaying apparatus 30 to perform various types of functions, or to achieve various types of units. The program providing system 90 can transmit the relaying apparatus program to the relaying apparatus 30. Furthermore, a transmission management program is stored in the hard disk (HD) 204 of the program providing system 90. The transmission management program causes the management system 50 to perform various types of functions, or to achieve various types of units. The program providing system 90 can transmit the transmission management program to the management system 90.

The maintenance system 100 is a computer which is for performing maintenance and/or management of at least one of the terminal 10, the relaying apparatus 30, the management system 50, and the program providing system 90. For example, for a case in which the maintenance system 100 is installed within a country, and the terminal 10, the relaying apparatus 30, the management system 50, or the program providing system 90 is installed outside the country, the maintenance system 100 remotely performs maintenance and management of at least one of the terminal 10, the relaying apparatus 30, the management system 50, and the program providing system 90 through a communication network 2. Further, the maintenance system 100 performs maintenance, such as management of a model number, a serial number, a customer, maintenance and inspection history, or failure history, of at least one of the terminal 10, the relaying apparatus 30, the management system 50, and the program providing system 90, without passing data through the communication network 2.

The terminals (10aa, 10ab, 10a, . . . ), the relaying apparatus 30a, and the router 70 are communicatably connected to a LAN 2a. The terminals (10aa, 10ab, 10a, . . . ), the relaying apparatus 30a, and the router 70 are included in a predetermined intranet A. The terminals (10ba, 10bb, 10b, . . . ), and the router 70b are communicatably connected to a LAN 2b. The terminals (10ba, 10bb, 10b, . . . ), and the router 70b are included in a predetermined intranet B. For example, the intranet A is managed by a company A, and the LAN 2a is installed in an office which is located in Tokyo. The intranet B is managed by a company B, and the LAN 2b is installed in an office which is located in Osaka. Further, the LAN 2a and the LAN 2b are installed in a segment AB. Here, the segment means a region (area) which is divided depending on a location on the communication network 2 or a geographical location. The segment AB is Japan, for example.

The terminals (10ca, 10cb, 10c, . . . ), and the router 70c are communicatably connected to a LAN 2c. The terminals (10ca, 10cb, 10c, . . . ), and the router 70c are installed in a predetermined intranet C. The terminals (10da, 10db, 10d, . . . ), the relaying apparatus 30d, and the router 70d are communicatably connected to a LAN 2d. The terminals (10da, 10db, 10d, . . . ), the relaying apparatus 30d, and the router 70d are installed in a predetermined intranet D. For example, the intranet C is managed by a company C, and the LAN 2c is installed in an office which is located in New York. Further, the intranet D is managed by a company D, and the LAN 2d is installed in an office which is located in Washington D.C. Here, the LAN 2c and the LAN 2d are installed in a segment CD. In the embodiment, the segment CD is the United States, for example. The intranet A, the intranet B, the intranet C, and the intranet D are communicatably connected to the Internet 2i through the corresponding routers (70a, 70b, 70c, and 70d). Here, between the intranets (A, B, C, and D) and the Internet 2i, corresponding firewalls are provided.

The terminal 10 can be moved. The terminal 10 can be connected to the Internet 2i from an area which is different from the area in which the terminal 10 is usually installed, and the terminal 10 can communicate content data with another terminal through the relaying apparatus 30. For example, the terminal 10ac can be connected to the intranet A through the Internet 2i from an area which is different from the area (Tokyo) in which the terminal 10ac is usually installed, and the terminal 10ac can communicate content data with another terminal through the relaying apparatus 30.

As shown in FIG. 1B, in the transmission system 1b, the relay apparatus 30a may be connected to the LAN 2a by a Virtual Private Network (VPN) connection 2va. Similarly, the relay apparatus 30d can be connected to the LAN 2d by a VPN connection 2vb. In this manner, the relaying apparatus 30a can be installed in an area (e.g., a data center of a company which provides the transmission system 1d) which is different from the area in which the LAN 2a is installed (Company A's Tokyo Office). The transmission system 1b of FIG. 1B is the same as the transmission system 1a of FIG. 1A, except for that the relaying apparatuses (30a, and 30d) are connected to the corresponding LANs (2a, and 2d) through the VPN connection. In the embodiment, the “transmission system 1” represents any one of the transmission systems (1a, and 1b).

In the transmission system 1 according to the embodiment, the relaying apparatus 30a is communicatably connected to the terminals (10aa, 10ab, 10ac, . . . ) and the management system 50 through the communication network 2. The relaying apparatus 30a is installed in the LAN 2a or VPN 2va so as to optimize the communication path. When at least one of the terminals (10aa, 10ab, 10ac, . . . ) communicates with another terminal which is installed in the LAN 2a, the relaying apparatus 30a is used for relaying content data.

In the transmission system 1 according to the embodiment, the relaying apparatus 30d is communicatably connected to the terminals (10da, 10db, . . . ) and the management system 50 through the communication network 2. The relaying apparatus 30d is installed in the LAN 2d or VPN 2vd so as to optimize the communication path. When at least one of the terminals (10da, 10db, . . . ) communicates with another terminal which is installed in the LAN 2d, the relaying apparatus 30d is used for relaying content data.

In the transmission system 1 according to the embodiment, the relaying apparatus 30ab is communicatably connected to the terminals (10aa, 10ab, 10ac, 10ba, 10bb, . . . ) and the management system 50 through the communication network 2. The relaying apparatus 30ab is installed in an area other than the area A and the area B, so that the relaying apparatus 30ab may avoid an effect of a traffic amount in the local area, which is the area A or the area B. When at least one of the terminals (10aa, 10ab, 10ac . . . , 10ba, 10bb, . . . ) communicates with another terminal which is installed in the LAN 2a or LAN 2b, the relaying apparatus 30ab is used for relaying content data. Hereinafter, an area including the LAN 2a and the LAN 2b is also referred to as a “segment AB.”

In the transmission system 1 according to the embodiment, the relaying apparatus 30cd is communicatably connected to the terminals (10ca, 10cb, 10da, 10db, . . . ) and the management system 50 through the communication network 2. The relaying apparatus 30cd is installed in an area other than the area C and the area D, so that the relaying apparatus 30cd may avoid an effect of a traffic amount in the local area, which is the area C or the area D. When at least one of the terminals (10ca, 10cb, 10da, 10db, . . . ) communicates with another terminal which is installed in the LAN 2c or LAN 2d, the relaying apparatus 30cd is used for relaying content data. Hereinafter, an area including the LAN 2c and the LAN 2d is also referred to as a “segment CD.”

In the transmission system 1 according to the embodiment, the relaying apparatus 30abcd is communicatably connected to the terminals (10aa, 10ab, 10ac, 10ba, 10bb, 10ca, 10cb, 10da, 10db, . . . ) and the management system 50 through the communication network 2. The relaying apparatus 30abcd is installed in an area other than the areas A, B, C, and D, so that the relaying apparatus 30abcd may avoid an effect of a traffic amount in the local area, which is the area A, B, C, or D. When at least one of the terminals (10aa, 10ab, 10ac, 10ba, 10bb, 10ca, 10cb, 10da, 10db, . . . ) communicates with another terminal which is installed in the LANs 2a, 2b, 2c, or 2d, the relaying apparatus 30abcd is used for relaying content data.

In the transmission system 1 according to the embodiment, the management system 50 and the program providing system 90 are communicatably connected to the terminal 10 and the relaying apparatus 30 through the Internet 2i. The management system 50 and the program providing system 90 may be installed in the area A, B, C, or D. Alternatively, the management system 50 and the program providing system 90 may be installed in an area other than the areas A, B, C, and D.

In the embodiment, the communication network 2 includes the LANs 2a, 2b, 2c, and 2e, and the Internet 2i. The communication network 2 may include not only a portion in which wired communication is performed, but also a portion in which wireless communication is performed.

In FIGS. 1A and 1B, the sets of four numbers indicated below the terminals 10, the relaying apparatuses 30, the transmission management system 50, the routers 70, and the program providing system 90, respectively, show IPv4 IP addresses in a simplified manner. For example, the IP address of the terminal 10aa is (1.2.1.3). Instead of the IPv4 IP addresses, IPv6 IP addresses may be used. For simplicity of explanation, the embodiment is explained using the IPv4 IP addresses.

<<Hardware Configurations According to the Embodiment>>

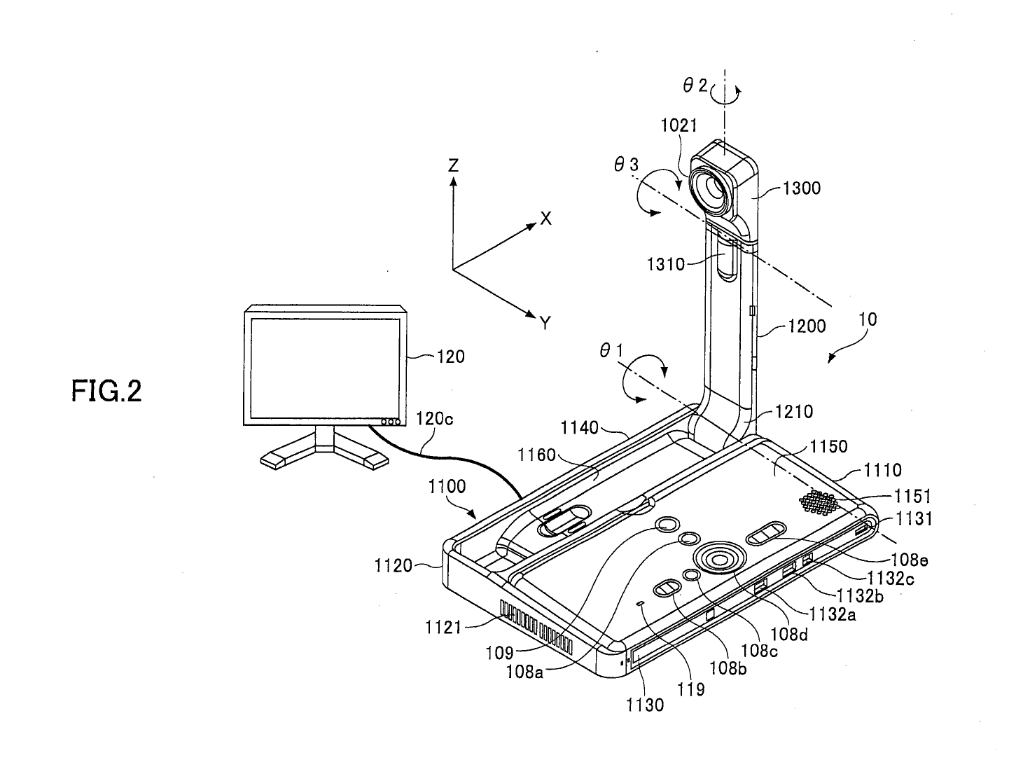

Next, there are explained hardware configurations according to the embodiment. FIG. 2 is an external view of the terminal 10 according to the embodiment. Hereinafter, the hardware configuration of the terminal 10 is explained while assuming that a longitudinal direction of the transmission terminal device 10 is an X-axis direction, a direction perpendicular to the X-axis direction in a horizontal plane is a Y-axis direction, and a direction perpendicular to the X-axis direction and the Y-axis direction (a vertical direction) is a Z-axis direction.

As shown in FIG. 2, the terminal 10 includes a chassis 1100; an arm 1200; and a camera housing 1300. A suction surface (not shown) is formed in a front wall surface 1110 of the chassis 1100. The suction surface includes a plurality of suction holes. An exhaust plane 1121 is formed in a rear wall surface 1120 of the chassis 1100. The exhaust plane 1121 includes a plurality of exhaust holes. With this configuration, the air in front of the transmission terminal device 10 is ingested into the chassis 1100 through the suction surface (not shown) by driving of a cooling fan included in the chassis 1100. Then, the air is exhausted to the rear side of the transmission terminal device 10 through the exhaust plane 1121. A sound pickup hole 1131 is formed at a right wall surface 1130 of the chassis 1100. Voice, other sound, and noise can be picked up by a built-in microphone 114 (described later).

An operations panel 1150 is formed in the chassis 1100 at a side of the right wall surface 1130. The operations panel 1150 includes a plurality of operation buttons (108a-108e), a power switch 109 (described later), and an alarm lamp 119 (described later). Further, the operations panel 1150 includes a sound output plane 1151. The sound output plane 1151 includes a plurality of sound output holes. Output sound from the built-in speaker 115 passes through the sound output holes. Further, an accommodating portion 1160 is formed in the chassis 1100 at a side of a left wall surface 1140 as a concave portion for accommodating the arm 1200 and the camera housing 1300. Further, a plurality of connecting ports 1132a-1132c is formed in the right wall surface 1130 of the chassis 1100. The connecting ports 1132a-1132c are for electrically connecting corresponding cables to an external device connecting I/F 118 (described later). A connecting port (not shown) for electrically connecting a cable 120c for a display 120 to the external device connecting I/F 118 is formed in the left wall surface 1140 of the chassis 1100.

In the explanation below, “the operation button 108” represents any one of the operation buttons 108a-108e, and “the connecting port 1132” represents any one of the connecting ports 1132a-1132c.

The arm 1200 is attached to the chassis 1100 through a torque hinge 1210. The arm 1200 can be pivoted in the vertical direction within a range of a tilt angle θ1 from 0 degrees to 135 degrees with respect to the chassis 1100. FIG. 2 shows a state where the tilt angle θ1 is 90 degrees.

The camera housing 1300 includes a built-in camera 1021. For example, a user, a document, and a room can be photographed. The camera housing 1300 includes the torque hinge 1310. The camera housing 1300 is attached to the arm 1200 through the torque hinge 1310. The camera housing 1300 can be pivoted in the horizontal direction and in the vertical direction with respect to the arm 1200. The camera housing 1300 can be pivoted in the horizontal direction within a range of a pan angle θ2 from −180 degrees to +180 degrees. FIG. 2 shows the state where the pan angle θ2 is 0 degree. Further, the camera housing 1300 can be pivoted in the vertical direction within a range of a tilt angle θ3 from −45 degrees to +45 degrees.

The external view shown in FIG. 2 is merely an example. The terminal 10 may be a PC, a tablet terminal, a smart phone, or a cellular phone, for example.

Since external appearances of the relaying apparatus 30, the management system 50, the program providing system 90, and the maintenance system 100 are the same as that of an information processing apparatus such as a usual server computer, explanations of the external appearances of the relaying apparatus 30, the management system 50, the program providing system 90, and the maintenance system 100 are omitted.

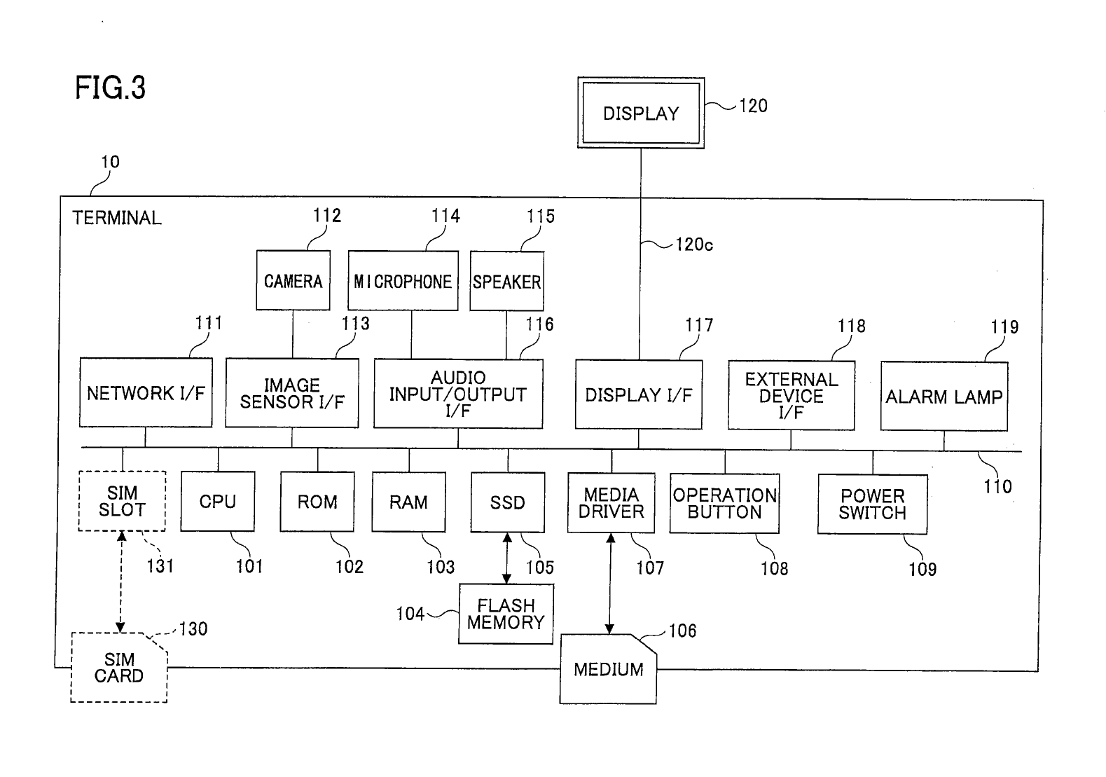

FIG. 3 is a diagram showing a hardware configuration of the terminal 10 according to the embodiment of the present invention. As shown in FIG. 3, the terminal 10 according to the embodiment includes a central processing unit (CPU) 101; a read only memory (ROM) 102; a random access memory (RAM) 103; a flash memory 104; a solid state drive (SSD) 105; and a media drive 107. The CPU 101 controls the operation of the terminal 10 as a whole. The ROM 102 stores the terminal program. The RAM 103 is used by the CPU 101 as a work area. The flash memory 104 stores various types of data such as image data and audio data. The SSD 105 controls reading out of the various types of data from the flash memory 104 and writing of the various types of data into the flash memory 104 in accordance with the control of the CPU 101. The media drive 107 controls reading out of data from a recording medium 106 such as a flash memory and writing (recording) of data into the recording medium 106.

The terminal 10 may include a SIM slot 131. The SIM slot 131 is for the terminal 10 to access a Subscriber Identity Module (SIM) card 130. The SIM card 130 stores authentication information for the terminal 10. The SIM card 130 may include a large memory area. Since the SIM card 130 is individually managed by a user, the SIM card 130 can be used as a secure memory area. The SIM card 130 has an access (reading/writing) control function, which is based on Personal Identification Number (PIN) input. The access control function enhances the security. An IC chip is included inside the SIM card 130. Besides storing the authentication information, the SIM card 130 performs calculation based on secret information which is stored inside the SIM card 130, in response to a request from the management system 50. By the calculation, the SIM card 130 generates information which can only be obtained by a legitimate SIM card. The authentication is performed on the basis of this information.

For a case in which the terminal 10 is compatible with the SIM card 130, the authentication information may only be stored in the SIM card 130, without being stored in the flash memory 104 and the like. When the authentication information of the terminal 10 is stored in the flash memory 104 as well as in the SIM card 130, and when the SIM card 130 is attached to the terminal 10, the authentication information which is stored in the SIM card 130 may be preferentially used. Alternatively, a user may select which authentication information is to be used.

The terminal 10 includes an operation button 108, a power switch 109, and a network interface (I/F) 111. The operation button 108 is for selecting a communication destination of the terminal device 10, for example. The power switch 109 is for turning on and off a power supply of the terminal device. The network I/F 111 is for transmitting data by using the communication network 2 (described later).

Further, the terminal 10 includes a built-in camera 112; an image sensor I/F 113; a built-in microphone 114; a built-in speaker 115; an audio input-output I/F 116; a display I/F 117; the external device connecting I/F 118; an alarm lamp 119; and a bus line 110. The built-in camera 112 photographs an object and obtains image data in accordance with the control of the CPU 101. The image sensor I/F 113 controls driving of the camera 112. The built-in microphone 114 is for audio input. The built-in speaker 115 is for audio output. The audio input/output I/F 116 processes the input and output of audio signals between the microphone 114 and the speaker 115 in accordance with the control of the CPU 101. The display I/F 117 transmits image data to the external display 120 in accordance with the control of the CPU 101. The external device connecting I/F 118 is for connecting various types of external devices. The alarm lamp 119 is for reporting an abnormal state of various types of functions of the terminal 10. The bus line 110 is an address bus and/or a data bus for electrically connecting the above-described components as shown in FIG. 3.

The display 120 is a display screen that includes liquid crystals or organic light-emitting diodes for displaying, for example, an image of an object and an operational icon. The display 120 is connected to the display I/F 117 through the cable 120c. The cable 120c may be a cable for analog RGB (VGA) signals, a cable for the component video, or a cable for High-Definition Multimedia Interface (HDMI) signals or Digital VideoInteractive (DVI) signals.

The camera 112 includes, for example, a lens and a solid state image sensor for converting an image (picture) of an object into electronic data by converting light into charges. As the solid state image sensor, a complementary metal oxide semiconductor (CMOS) or a charge coupled device (CCD) is used, for example.

An external device such as an external camera, an external microphone, and an external speaker can be electrically connected to the external device connecting I/F 118 through a universal serial bus (USB) cable that is connected to the connecting port 1132 of the chassis 1100 shown in FIG. 2. When the external camera is connected to the terminal 10, the external camera is preferentially driven over the built-in camera 112 in accordance with the control of the CPU 101. Similarly, when the external microphone is connected to the terminal 10, the external microphone is preferentially driven over the built-in microphone 114 in accordance with the control of the CPU 101. Further, when the external speaker is connected to the transmission terminal device 10, the external speaker is preferentially driven over the built-in speaker 115 in accordance with the control of the CPU 101.

The recording medium 106 is detachably attached to the terminal 10. Instead of the flash memory 104, an electrically erasable and programmable ROM (EEPROM) may be utilized as a non-volatile memory into which data can be written and from which data can be read out in accordance with the control of the CPU 101.

Further, the above-described terminal program may be stored in a computer readable recording medium (e.g., the recording medium 106) as a file in a format that can be installed or in a format that can be executed. In this case, the computer readable recording medium storing the transmission terminal program may be distributed. Further, the above-described terminal program may be stored in the ROM 102, instead of the flash memory 104.

FIG. 3 is merely an example. For example, the microphone, the camera, and speaker may not be included inside the terminal 10. They can be external devices.

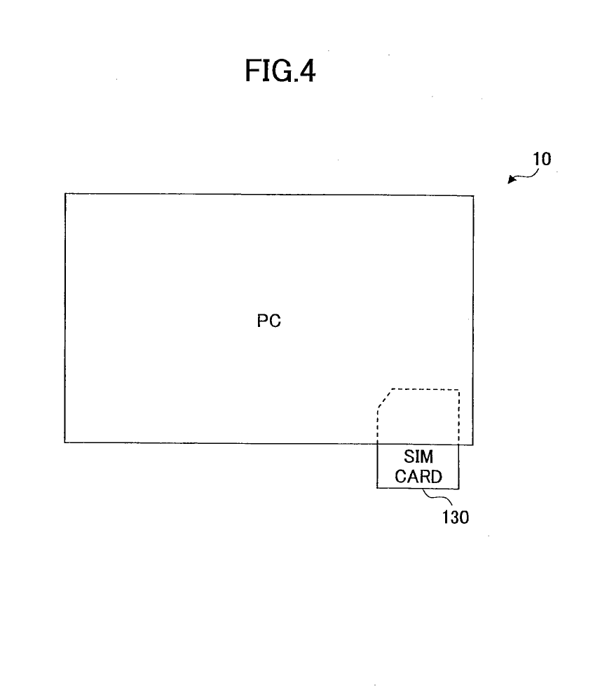

FIG. 4 is a diagram showing an example in which the terminal 10 is a communication terminal such as a personal computer (PC), a tablet terminal, a smart phone, or a cellular phone.

In FIG. 3, a configuration of a so-called “dedicated terminal” is indicated. The terminal 10 may have a configuration such that the SIM card 130 is attached to a generic communication terminal. FIG. 4 shows the terminal 10 having the above-described configuration. With such a terminal 10 which is based on a SIM card, it is possible to participate in a video conference by using a desired communication terminal, such as an office communication terminal or a personal communication terminal. The functions inside the terminal 10 (the terminal 10 which is based on the SIM card) are the same as those of the terminal 10.

For a case in which video and audio are used, it may be required that the communication terminal includes a camera and/or a microphone. However, for a case in which one of the video and audio is not required or neither the video nor audio is required, the communication terminal may not include the camera and/or the microphone. Even if neither the video nor audio is utilized, the shared folder function (described later) can be utilized. Additionally, another communication terminal such as a projector having a communication function may be used.

FIG. 5 is a diagram showing a hardware configuration of the management system 50 according to the embodiment of the present invention. The management system 50 includes a CPU 201; a ROM 202; a RAM 203; a hard disk (HD) 204; a hard disk drive (HDD) 205; a media drive 207; a display 208; a network I/F 209; a keyboard 211; a mouse 212; a CD-ROM drive 214; an external device I/F 215; and a bus line 210. The CPU 201 controls the management system 50 as a whole. The ROM 202 stores the transmission management program. The RAM 203 is used by the CPU 201 as a work area. The HD 204 stores various types of data. The HDD 205 controls reading out of the various types of data from the HD 204 and writing of the various types of data into the HD 204 in accordance with the control of the CPU 201. The media drive 207 controls reading out of data from a recording medium 206 such as a flash memory and writing (recording) of data into the recording medium 206. The display 208 displays various types of information such as a cursor, a menu, a window, a character, and an image. The network I/F 209 is for transmitting data by using the communication network (described later). The keyboard 211 includes plural keys for inputting characters, numbers, and various instructions. The mouse 212 is used for selecting and performing various instructions, selecting an object to be processed, and moving the cursor, for example. The CD-ROM drive 214 controls reading out of data from a compact disc read only memory (CD-ROM) 213 as an example of a removable recording medium and/or writing of data into the CD-ROM 213. The external device I/F 215 is for connecting an external device. The bus line 210 is an address bus and/or a data bus for electrically connecting the above-described components as shown in FIG. 5.

The above-described transmission management program may be stored in a computer readable recording medium such as the recording medium 206 or the CD-ROM 213 as a file in a format that can be installed or in a format that can be executed. In this case, the computer readable recording medium storing the transmission management program may be distributed.

Since the relaying apparatus 30 has a hardware configuration similar to that of the management system 50, the explanation of the hardware configuration of the relaying apparatus 30 is omitted. However, for the case of the relaying apparatus 30, the ROM 202 stores a relaying apparatus program. In this case, the relaying apparatus program may be stored in a computer readable recording medium such as the recording medium 206 or the CD-ROM 213 as a file in a format that can be installed or in a format that can be executed, and the computer readable recording medium storing the program may be distributed.

Since a hardware configuration of the program providing system 90 is the same as that of the management system 50, the explanation of the hardware configuration of the program providing system 90 is omitted. However, for the case of the program providing system 90, the ROM 202 stores a program providing system program, which is for controlling the program providing system 90. In this case, the program providing system program may also be stored in a computer readable recording medium such as the recording medium 206 or the CD-ROM 213 as a file in a format that can be installed or in a format that can be executed, and the computer readable recording medium storing the program may be distributed.

Since a hardware configuration of the maintenance system 100 is the same as that of the management system 50, the explanation of the hardware configuration of the maintenance system 100 is omitted. However, for the case of the maintenance system 100, the ROM 202 stores a maintenance system program, which is for controlling the maintenance system 100. In this case, the maintenance system program may also be stored in a computer readable recording medium such as the recording medium 206 or the CD-ROM 213 as a file in a format that can be installed or in a format that can be executed, and the computer readable recording medium storing the program may be distributed.

Since a hardware configuration of the file temporary storage device 40 is the same as that of the management system 50, the explanation of the hardware configuration of the file temporary storage device 40 is omitted. However, for the case of the file temporary storage device 40, the ROM 202 or the HD 204 stores a file temporary storage device program, which is for controlling the file temporary storage device 40. In this case, the file temporary storage program may also be stored in a computer readable recording medium such as the recording medium 206 or the CD-ROM 213 as a file in a format that can be installed or in a format that can be executed, and the computer readable recording medium storing the program may be distributed.

As another example of the removable recording medium, a compact disc recordable (CD-R), a digital versatile disk (DVD), or a blu-ray disk can be considered. Each of the above-described programs may be recorded in the CD-R, the DVD, or the blu-ray disk, and the CD-R, the DVD, or the blu-ray disk (BD) storing the corresponding program may be distributed.

<<Functional Configuration of the Transmission System>>

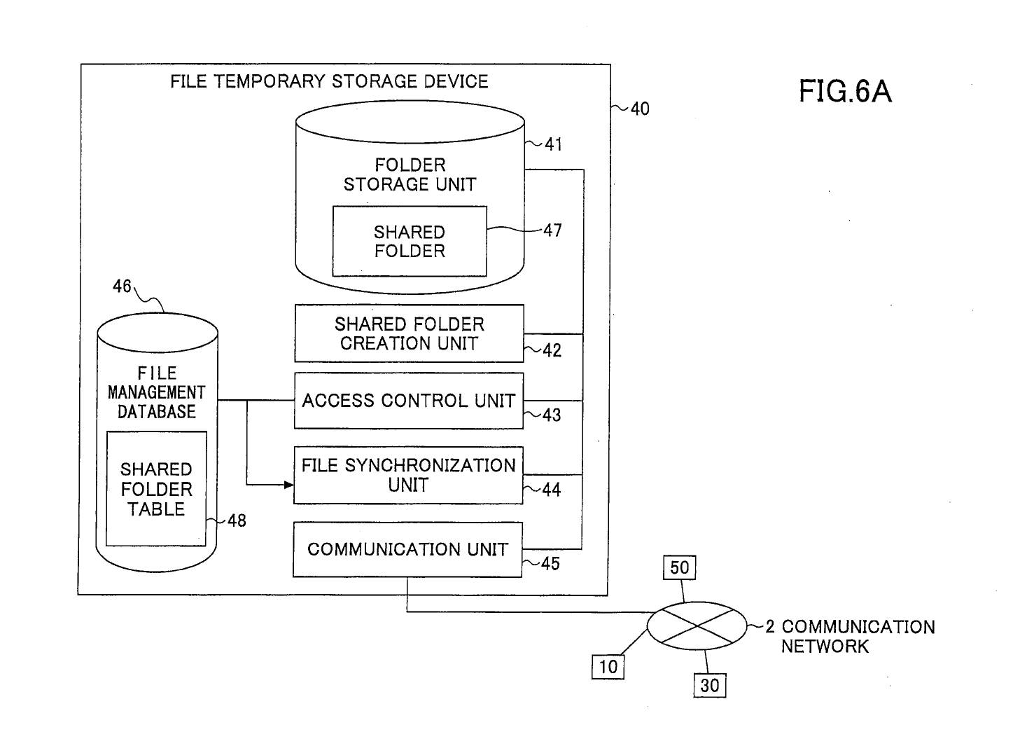

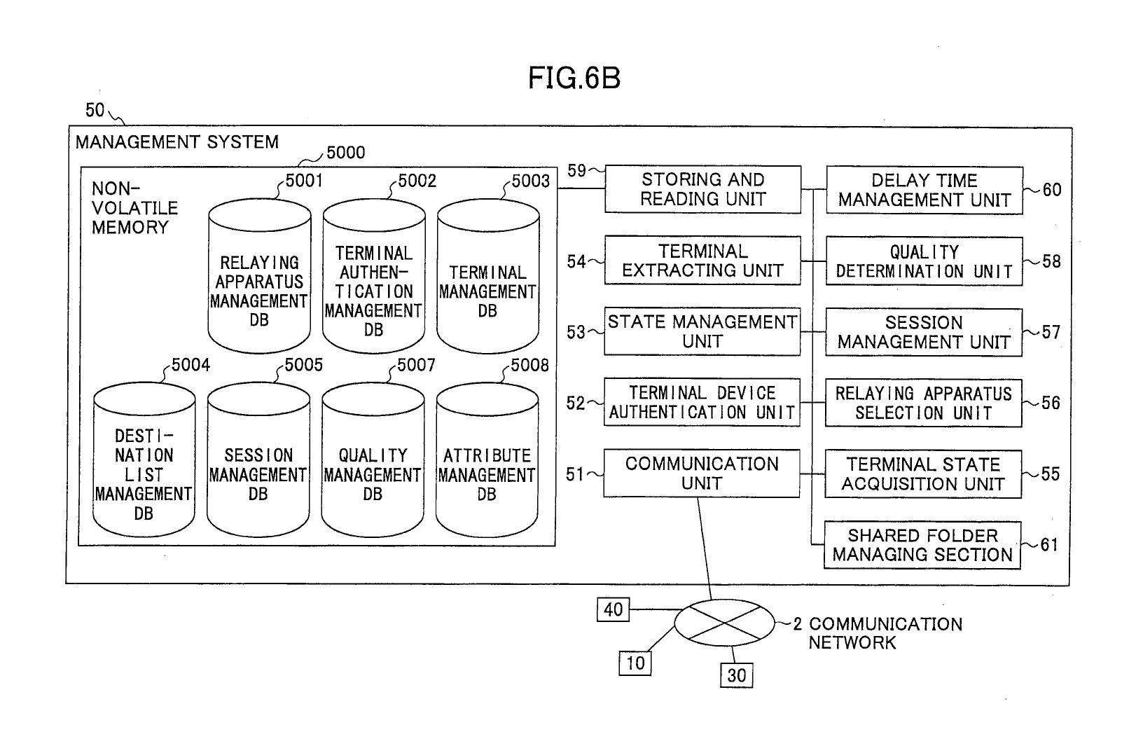

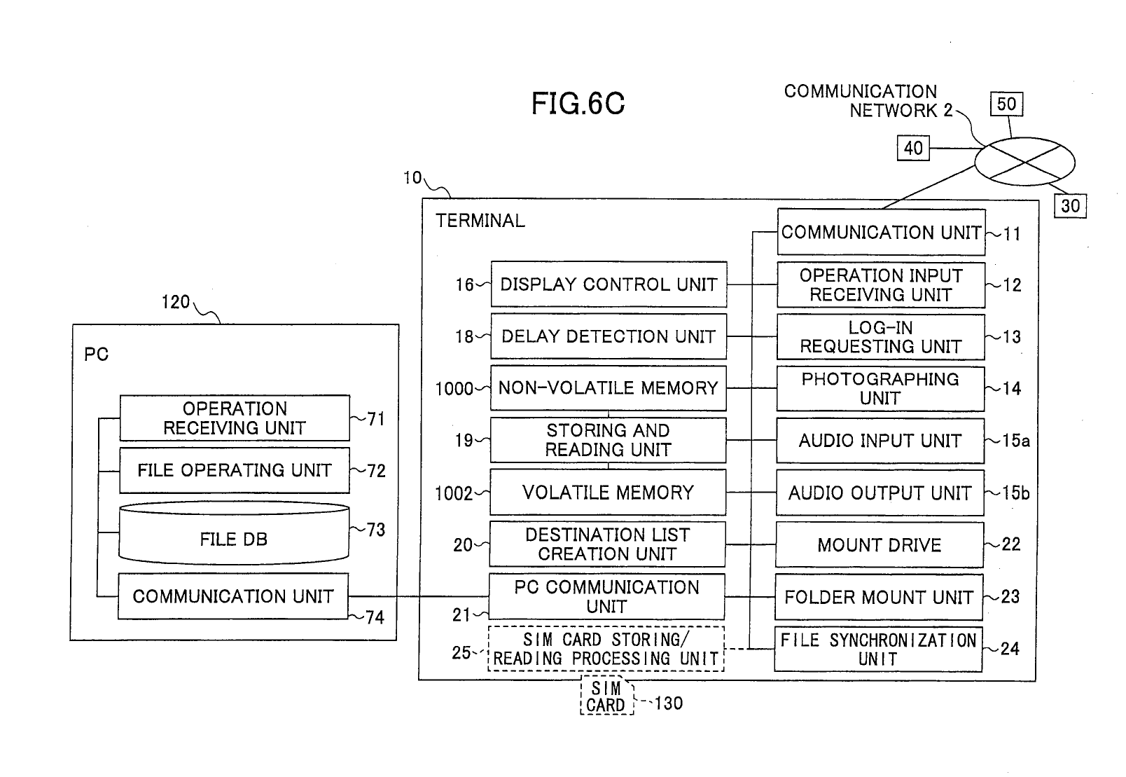

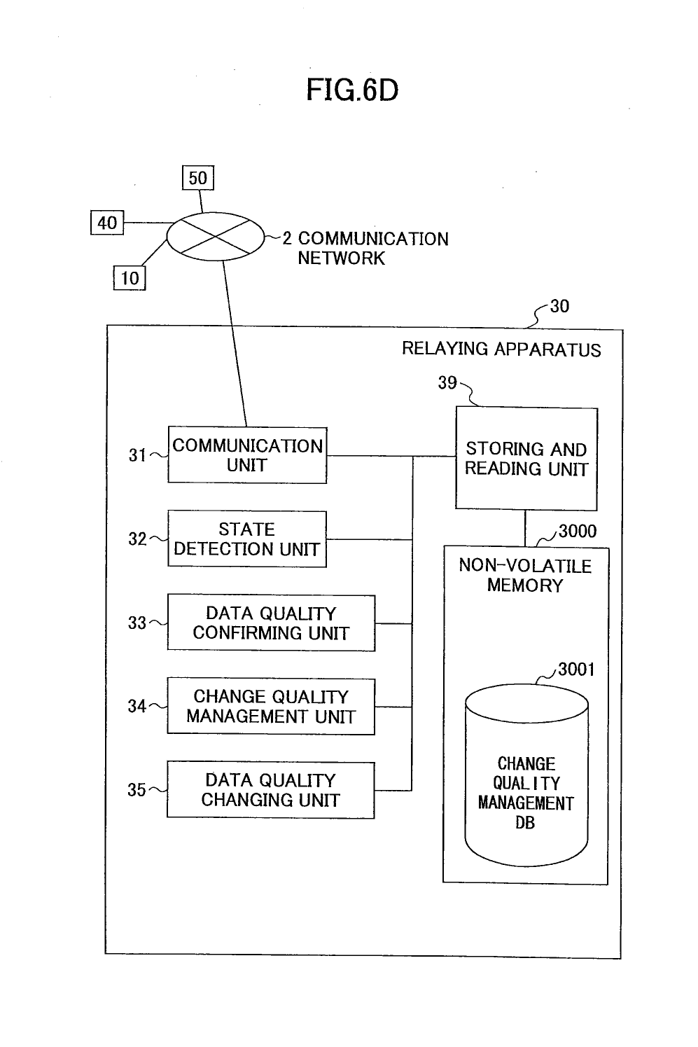

Next, there is explained a functional configuration of the transmission system 1 according to the embodiment. FIGS. 6A, 6B, 6C, and 6D are functional block diagrams of the terminal 10, the relaying apparatus 30, the file temporary storage device 40, the management system 50, and the PC 120, which are included in the transmission system 1 according to the embodiment. In FIGS. 6A, 6B, 6C, and 6D, the transmission terminal device 10, the relaying apparatus 30, the file temporary storage device 40, and the management system 50 are connected to each other through the communication network 2, so that they can perform data communications. Here, since the program providing system 90 and the maintenance system 100, which are shown in FIGS. 1A and 1B, are not directly related to communications for video conferencing, they are omitted in FIGS. 6A, 6B, 6C, and 6D.

<Functional Configuration of the Terminal>

The transmission terminal device 10 includes a communication unit 11; an operation input receiving unit 12; a log-in requesting unit 13; a photographing unit 14a; an audio input unit 15a; an audio output unit 15b; a display control unit 16; a delay detection unit 18; a storing and reading unit 19; a destination list creation unit 20; a PC communication unit 21; a mount drive 22; a folder mount unit 23; a file synchronization unit 24; and a SIM card storing/reading processing unit 25. These functional elements or steps are executed when the corresponding elements shown in FIG. 3 operate in accordance with instructions from the CPU 101. Here, the instructions from the CPU 101 are in accordance with the program stored in the ROM 102. Further, the terminal 10 includes a non-volatile memory 1000 and a volatile memory 1002. The non-volatile memory 1000 includes the flash memory 104, which is shown in FIG. 3. The volatile memory 1002 includes the RAM 103, which is shown in FIG. 3.

<Functional Elements of the Terminal>

Next, functional elements of the terminal device 10 are explained in detail. The communication unit 11 of the terminal 10 includes the network I/F 111 shown in FIG. 3. The communication unit 11 transmits various types of data (information) to and receives various types of data (information) from another device, another apparatus, or another system through the communication network 2. The communication unit 11 starts receiving state information indicating a state of each of the terminals 10 as destination candidates from the management system 50 prior to starting calling with the terminal 10 (destination terminal) as a desired destination. The state information indicates not only an operating state of each of the terminals 10 (a state indicating whether the terminal 10 is on-line or off-line), but also a detailed state such as a state in which the terminal 10 is on-line and in a call. Furthermore, the sate information indicates not only the operating state of each of the terminals 10, but also a state in which cables (120c, 130c, 140c, and 150c) are removed from the terminal 10, a state in which the terminal 10 outputs sound but the terminal 10 is prevented from outputting an image, or a state in which the terminal 10 is prevented from outputting sound. Hereinafter, as an example, a case is explained in which the state information indicates the operating state.

The operation input receiving unit 12 is achieved by an operation button 108 and a power switch 109, which are shown in FIG. 3. The operation input receiving unit 12 receives various types of inputs by a user. For example, when a user turns on the power switch 109, which is shown in FIG. 3, the operation input receiving unit 12 (which is shown in FIG. 6C) receives turning ON of the power supply, and the operation input receiving unit 12 turns on the power supply. The log-in requesting unit 13 is executed by an instruction from the CPU 101, which is shown in FIG. 3. Triggered by the reception of the turning ON of the power supply, the log-in requesting unit 13 automatically transmits log-in request information which indicates that log-in is requested and a current IP address of the terminal 10 (requesting terminal) as a requesting source from the communication unit 11 to the management system 50 through the communication network 2. Further, when a user switches a state of the power switch 109 from an ON state to an OFF state, the communication unit 11 transmits state information indicating that the power supply is to be turned off to the management system 50, and subsequently the operation input receiving unit 12 completely turns off the power supply. In this manner, the management system 50 can recognize that the state of the power supply of the terminal 10 is switched from the ON state to the OFF state.

The photographing unit 14 is achieved by an instruction from the CPU 101, the camera 112, and the image sensor I/F 113, which are shown in FIG. 3. The photographing unit 14 photographs an object by the camera 112, and outputs image data that is obtained by photographing. The audio input unit 15a includes the audio input/output I/F 116 which is shown in FIG. 3. After voice sound of a user is converted into an audio signal by the microphone 114, the audio input unit 15a inputs audio data of the audio signal. The audio output unit 15b is achieved by an instruction from the CPU 101, and the audio input/output I/F 116, which are shown in FIG. 3. The audio output unit 15b outputs a sound signal of the voice data to the speaker 115, and thereby the audio output unit 15b causes the speaker 115 to output the voice sound.

The image display control unit 16 is achieved by the display I/F 117. The image display control unit 16 controls transmission of image data to the external display 120. Furthermore, prior to the requested terminal 10 starting calling of a video conference with a desired destination terminal 10, the display control unit 16 causes the display 120 to display a destination list including destination names, based on the state information received by the communication unit 11.

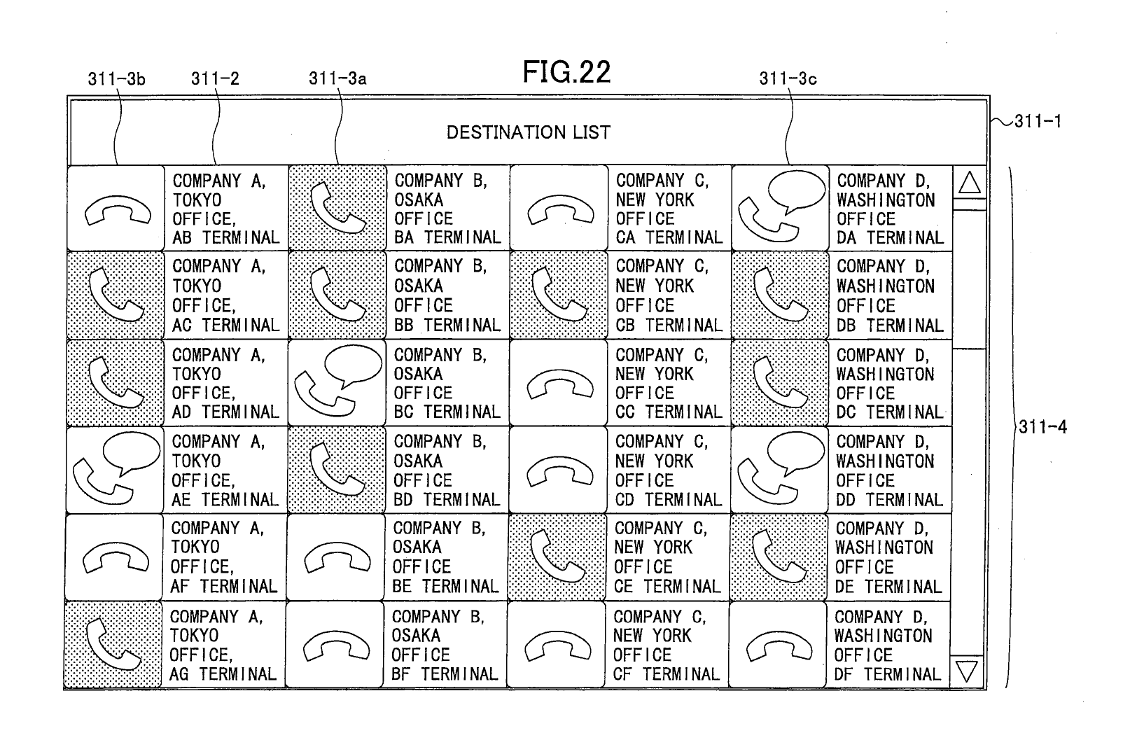

For example, on the display 120, a destination list table 311-1 (c.f., FIG. 22) is displayed by the display control unit 16. In the destination list table 311-1, destination names are displayed, such as a destination name “Company A, Tokyo Office, AB terminal” 311-2. For each of the destination names, icons (311-3a, 311-3b, and 311-3c) are displayed. The icons (311-3a, 311-3b, and 311-3c) indicate corresponding states of the state information. The icon 311-3a indicates that a terminal, which is one of destination candidates, is in an on-line state and waiting for a call. Namely, the icon 311-3a indicates that it is possible to communicate with this terminal. The icon 311-3b indicates that a terminal, which is another one of the destination candidates, is in an off-line state. Namely, the icon 311-3b indicates that it is not possible to communicate with this terminal. The icon 311-3c indicates that a terminal, which is another one of the destination candidates, is in a state in which the terminal is in communication with another terminal. Namely, the icon 311-3c indicates that it is possible to participate in this communication. A scroll bar 311-4 is displayed at a right side of the destination list table 311-1. By selecting an upward triangular icon or a downward triangular icon, an icon indicating a destination name and a state of a destination candidate (which is not shown in FIG. 22) is displayed.

The delay detection unit 18 is executed by an instruction from the CPU 101, which is shown in FIG. 3. The delay detection unit 18 detects a delay time period (ms) of image data or audio data that is transmitted from another terminal 10 through the relaying apparatus 30.

The storing and reading unit 19 is executed by an instruction from the CPU 101, which is shown in FIG. 3, and, as an example, the SSD 105, which is shown in FIG. 3. The storing and reading unit 19 stores various types of data in the non-volatile memory 1000, and reads out various types of data stored in the non-volatile memory 1000. The non-volatile memory 1000 stores a terminal identification (ID) for identifying the terminal 10, and a password, for example. Additionally, the storing and reading unit 19 stores various types of data in the volatile memory 1002, and reads out various types of data stored in the volatile memory 1002. The volatile memory 1002 overwrites and stores image data and audio data each time they are received. Here, the image data and audio data are received during calling with a destination terminal 10. An image is displayed on the display 120 based on the image data prior to overwriting, and sound is output by the speaker 115 based on the audio data prior to overwriting.

The destination list creation unit 20 creates or updates the destination list (cf., FIG. 22), in which the states of the destination candidates are indicated by the corresponding icons, based on destination list information (which is described later) and the state information of the terminals 10 as the destination candidates.

The terminal device ID according to the embodiment is, for example, identifying information such as descriptions, characters, symbols, or various types of marks that are used for uniquely identifying the terminal 10. Similarly, the relaying apparatus ID (described later) is, for example, identifying information such as descriptions, characters, symbols, or various types of marks that are used for uniquely identifying the relaying apparatus 30. Further, the terminal device ID and the relaying apparatus ID may be identifying information in which at least two of the above-described descriptions, characters, symbols, and various types of marks are combined.

The PC communication unit 21 is achieved, for example, by the external device connecting I/F 118, which is shown in FIG. 3. The PC communication unit 21 transmits data, such as a file, to the PC 120, and receives data from the PC 120. Specifically, the PC communication unit 21 is a USB host, a Bluetooth (registered trade mark) host, or a wireless LAN interface, for example. The terminal 10 according to the embodiment conforms to the USB Mass Storage Class standard. The terminal 10 may be recognized by the PC 120 as storage.

The mount drive 22 is created by loading the shared folder 47 by the terminal 10. When the terminal 10 retrieves information of a URI of the shared folder 47 from the management system 50, the folder mount drive unit 23 loads the shared folder 47 onto the terminal 10. The mount drive 22 is created by the loading. By the loading, the shared folder 47 at a source of the loading is synchronized with the file of the mount drive 22.

A file, which is received by the PC communication unit 21 from the PC 120, is written in the mount drive 22. The mount drive 22 is achieved, for example, by the RAM 103 or the flash memory 104, which are shown in FIG. 3.

When the file synchronization unit 24 receives information that the file is written in the mount drive 22 from the PC communication unit 21 (receive interruption), the file synchronization unit 24 may detect that the file is written in the mount drive 22. Alternatively, by periodically monitoring the mount drive 22, the file synchronization unit 24 may detect that the file is written in the mount drive 22.

When the file synchronization unit 24 detects that the file is written in the mount drive 22, the file synchronization unit 24 transmits the file of the mount drive 22 to a file temporary storage device 40 by using the communication unit 11.

When the file synchronization unit 24 receives a file name of the file which is stored in the shared folder 47 from a file synchronization unit 44 of the file temporary storage device 40, the file synchronization unit 24 registers the file name with the mount drive 22. Accordingly, the PC 120 may recognize that the file exists in the mount drive 22.

When the terminal 10 is compatible with the SIM card 130, the SIM card storing/reading processing unit 25 stores information in the SIM card 130, and reads out information in the SIM card 130.

(Functional Configuration of the Relaying Apparatus)

Next, functions and/or units of the relaying apparatus 30 are explained. The relaying apparatus 30 includes a communication unit 31; a state detection unit 32; a data quality confirming unit 33; a change quality management unit 34; a data quality changing unit 35; and a storing and reading unit 39. These functional elements or the units are achieved when the corresponding elements shown in FIG. 5 operate in accordance with instructions from the CPU 201. Here, the instructions from the CPU 201 are in accordance with the program stored in the ROM 202. Further, the relaying apparatus 30 includes a non-volatile memory 3000. The non-volatile memory 3000 is formed of the HD 204 shown in FIG. 5. Even if the power supply of the relaying apparatus 30 is turned off, the non-volatile memory 3000 keeps storing the various data and information.

(Change Quality Management Table)

The non-volatile memory 3000 includes a change quality management data base (DB) 3001 that includes a change quality management table as shown in FIG. 8. FIG. 8 is a conceptual diagram showing the change quality management table. The change quality management table manages an IP address of the terminal 10 as a relay destination of image data; and image quality of the image data that is relayed by the relaying apparatus 30 to the relay destination. In the change quality management table, the image quality of the image data is associated with the IP address of the terminal 10 as shown in FIG. 8, for example.

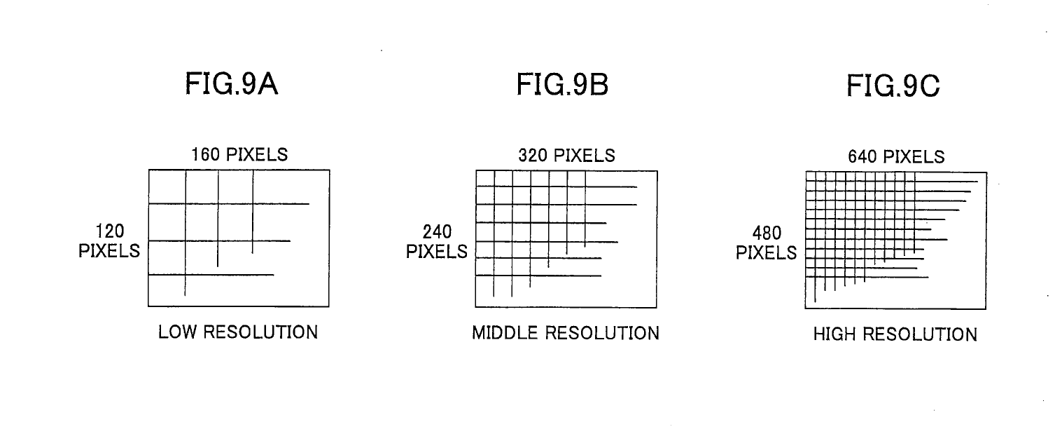

Hereinafter, there is explained resolution of an image of image data according to the embodiment by referring to FIGS. 9A, 9B, and 9C. FIGS. 9A, 9B, and 9C are conceptual diagrams illustrating image quality of image data. Three types of images are considered here. The first one is a low resolution image such as shown in FIG. 9A. The low resolution image is formed of 160 pixels in the horizontal direction and 120 pixels in the vertical direction. The low resolution image is a base image. The second one is a middle resolution image such as shown in FIG. 9B. The middle resolution image is formed of 320 pixels in the horizontal direction and 240 pixels in the vertical direction. The third one is a high resolution image such as shown in FIG. 9C. The high resolution image is formed of 640 pixels in the horizontal direction and 480 pixels in the vertical direction. When the data travels through a narrow bandwidth path, low quality image data is relayed. Here, the low quality image data is formed only of the low resolution image data, which is the base image. When the bandwidth is relatively broad, middle quality image data is relayed. The middle quality image data is formed of the low resolution image data, which is the base image, and the middle resolution image data. Further, when the bandwidth is very broad, high quality image data is relayed. The high quality image data is formed of the low resolution image data, which is the base image, the middle resolution image data, and the high resolution image data. For example, as shown in the change quality management table of FIG. 8, when the relaying apparatus 30 relays image data to a destination terminal (terminal 10db) having the IP address of (1.3.2.4), image quality of the relayed image data (quality of the image) is “high quality.”

<Functional Elements of the Relaying Apparatus>

Next, the functional elements of the relaying apparatus 30 are explained in detail. In the explanation below, while explaining the functional elements of the relaying apparatus 30, there are explained relationships between the functional elements and the major components (among the components shown in FIG. 5) for achieving the functional elements.

The communication unit 31 of the relaying apparatus 30 shown in FIG. 6D is achieved by the network I/F 209, which is shown in FIG. 5. The communication unit 31 transmits various data (information) to and receives various data (information) from another terminal, another apparatus, or another system through the communication network 2. The state detection unit 32 is executed by an instruction from the CPU 201, which is shown in FIG. 5. The state detection unit 32 detects an operating state of the relaying apparatus 30 having the state detection unit 32. The operation states of the relaying apparatus 30 include an online state, an offline state, and a failure state.

The data quality confirming unit 33 is executed by an instruction from the CPU 201 shown in FIG. 5. The data quality confirming unit 33 searches the change quality management table (cf. FIG. 8) of the change quality management DB 3001 for image quality of image data to be relayed by using the IP address of the destination terminal as a search key. The data quality confirming unit 33 confirms the image quality of the image data to be relayed by extracting the image quality corresponding to the IP address of the destination terminal. The change quality management unit 34 is executed by an instruction from the CPU 201, which is shown in FIG. 5. The change quality management unit 34 changes contents of the change quality management table based on quality information (described later) transmitted from the management system 50. For example, during a video conference that is performed by transmitting and receiving high quality image data between the requesting terminal (terminal 10aa) having a terminal ID of “01aa” and the destination terminal (terminal 10db) having a terminal ID of “01db,” when a delay in receiving image data with the destination terminal (terminal 10db) is caused, for example, by starting of another video conference between the requesting terminal (terminal 10bb) and the destination terminal (terminal 10ca) through the communication network 2, the relaying apparatus 30 may be required to lower the image quality of the image data that has been relayed so far from the high quality to the middle quality. In such a case, the contents of the change quality management table is changed based on the quality information indicating the middle quality, so that the image quality of the image data relayed by the relaying apparatus 30 is lowered from the high quality to the middle quality.

The data quality changing unit 35 is executed by an instruction from the CPU 201, which is shown in FIG. 5. The data quality changing unit 35 changes the image quality of the image data that is transmitted from a transmission source terminal 10 based on the contents of the updated change quality management table of the change quality management DB 3001. The storing and reading unit 39 is achieved by the HDD 205 shown in FIG. 5. The storing and reading unit 39 stores various types of data in the non-volatile memory 3000, and the storing and reading unit 39 reads out various types of data stored in the non-volatile memory 3000.

<Functional Configuration of the Management System>

Next, functions and/or units of the management system 50 are explained. The management system 50 includes a communication unit 51; a terminal authentication unit 52; a state management unit 53; a terminal extracting unit 54; a terminal state acquisition unit 55; a relaying apparatus selection unit 56; a session management unit 57; a quality determination unit 58; a storing and reading unit 59; a delay time management unit 60, and a shared folder management unit 61. These functional elements or the units are achieved when the corresponding elements shown in FIG. 5 operate in accordance with an instruction from the CPU 201. Here, the instruction from the CPU 201 is in accordance with the program stored in the ROM 202. Further, the management system 50 includes a non-volatile memory 5000 formed of the HD 204 shown in FIG. 5. The non-volatile memory 5000 keeps storing various types of data and information, even if the power supply of the management system is turned off. The non-volatile memory 5000 stores a destination list table 311-1 (cf., FIG. 22).

(Relaying Apparatus Management Table)

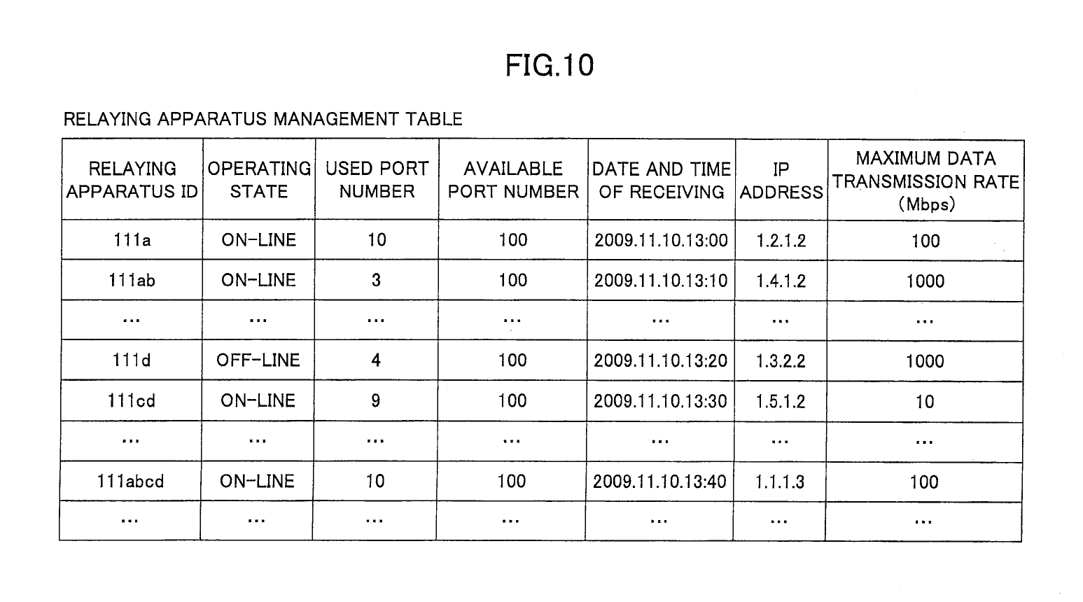

The non-volatile memory 5000 includes a relaying apparatus management DB 5001 that includes a relaying apparatus management table, which is shown in FIG. 10. FIG. 10 is a conceptual diagram showing the relaying apparatus management table. The relaying apparatus management table manages, for each relaying apparatus ID of the corresponding relaying apparatus 30, an operating state of the corresponding relaying apparatus 30; a number of used ports; a number of available ports; date and time of receiving a state information indicating the operating state by the management system 50; an IP address of the corresponding relaying apparatus 30; and the maximum transmission rate (Mbps) of the corresponding relaying apparatus 30. In the relaying apparatus management table, each of the relaying apparatus IDs is associated with the operating state of the corresponding relaying apparatus 30; the number of the used ports; the number of available ports; the date and time of receiving the state information indicating the operating state by the transmission management system 50; the IP address of the corresponding relaying apparatus 30; and the maximum transmission rate (Mbps) of the corresponding relaying apparatus 30. For example, the relaying apparatus management table shown in FIG. 10 indicates that, for the relaying apparatus 30a having the relaying apparatus ID of “111a,” the operating state is the online state, the number of the used ports is “10,” the number of the available ports is “100,” the date and time of receiving the state information by the management system 50 is “13:00, Nov. 10, 2009,” the IP address of the relaying apparatus 30a is (1.2.1.2), and the maximum data transmission rate of the relaying apparatus 30a is 100 Mbps.

(Terminal Device Authentication Management Table)

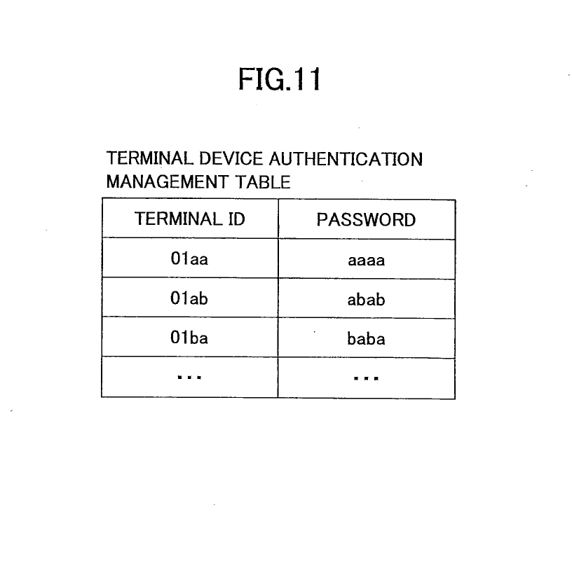

Further, the non-volatile memory 5000 includes a terminal device authentication management DB 5002 that includes a terminal device authentication management table such as shown in FIG. 11. FIG. 11 is a conceptual diagram showing the terminal device authentication management table. The terminal device authentication management table manages the terminal IDs of all of the terminal devices 10 that are managed by the management system 50. In the terminal device authentication management table, the terminal IDs are associated with the corresponding passwords. For example, the terminal device authentication management table shown in FIG. 11 indicates that the terminal ID of the terminal 10aa is “01aa” and the password is “aaaa.” In FIG. 11, an example is shown for the case where the authentication is based on the password. For a case in which a more complicated authentication method is utilized, the corresponding information is stored in the authentication management table.

(Terminal Device Management Table)

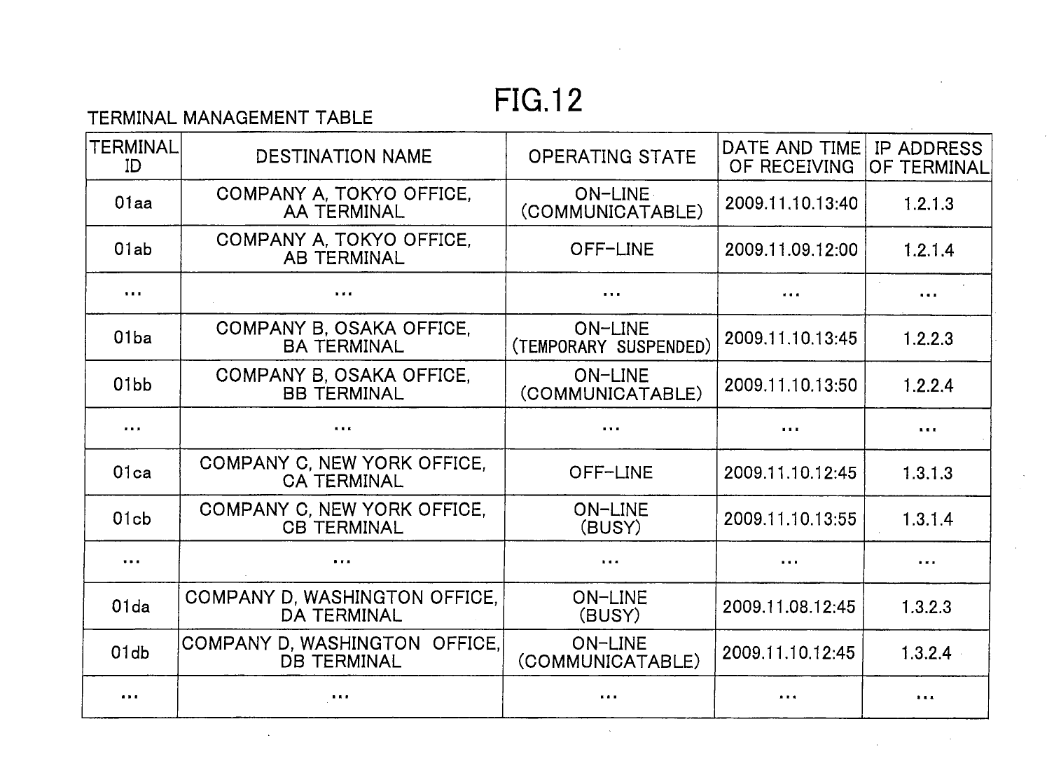

Further, the non-volatile memory 5000 includes a terminal management DB 5003 that includes a terminal management table such as shown in FIG. 12. FIG. 12 is a conceptual diagram showing the terminal management table. The terminal management table manages, for each of the terminal IDs of the terminals 10, a destination name for a case in which the destination is the corresponding terminal 10; an operating state of the corresponding terminal 10; date and time of receiving the log-in request information (described later) by the management system 50; and an IP address of the corresponding terminal 10. In the terminal management table, each of the terminal IDs of the terminals 10 is associated with the operating state of the corresponding terminal 10; the date and time of receiving the log-in request information (described later) by the management system 50; and the IP address of the corresponding terminal 10. For example, the terminal management table shown in FIG. 12 indicates that, for the terminal 10aa having the terminal device ID of “01aa,” the terminal name is “Company A, Tokyo Office, AA terminal,” the operating state is the online state, the date and time of receiving the log-in request information by the management system 50 is “13:40, Nov. 10, 2009,” and the IP address of the terminal 10aa is (1.2.1.3).

(Destination List Management Table)

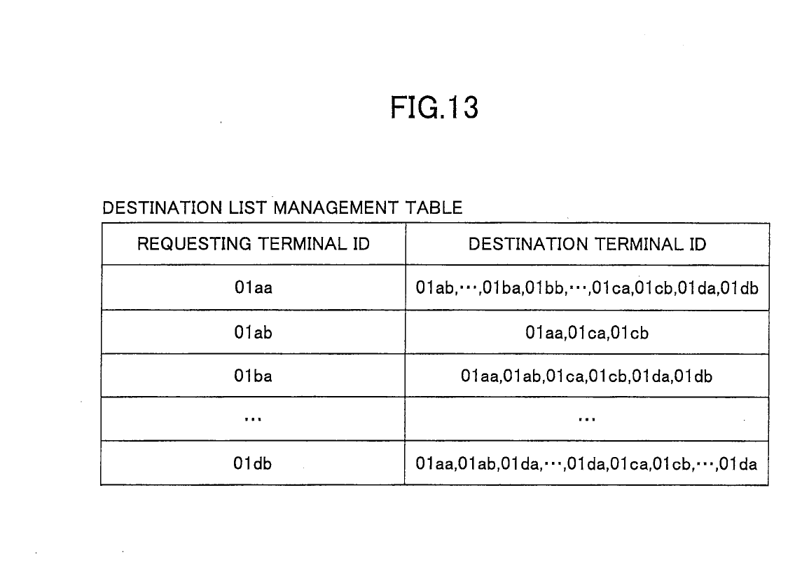

Further, the non-volatile memory 5000 includes a destination list management DB 5004 that includes a destination list management table such as shown in FIG. 13. FIG. 13 is a conceptual diagram showing the destination list management table. The destination list management table manages, for the terminal ID of the requesting terminal device that requests to start a video conference, the terminal IDs of the destination terminals that are registered as candidates for the destination terminal. In the destination list management table, the terminal ID of the requesting terminal is associated with the terminal IDs of the terminals that are registered as the candidates for the destination terminal. For example, the destination list management table shown in FIG. 13 indicates that the terminal 10ab having the terminal ID of “01ab,” the terminal 10ba having the terminal ID of “01ba,” and the terminal 10bb having the terminal ID of “01bb” are the candidates for the destination terminal that can be requested to start a video conference from the requesting terminal device 10aa having the terminal device ID of “01aa.” The candidates for the destination terminal may be updated by adding or removing a candidate in accordance with a request for adding or removing the candidate from the requesting terminal to the management system 50.

(Session Management Table)

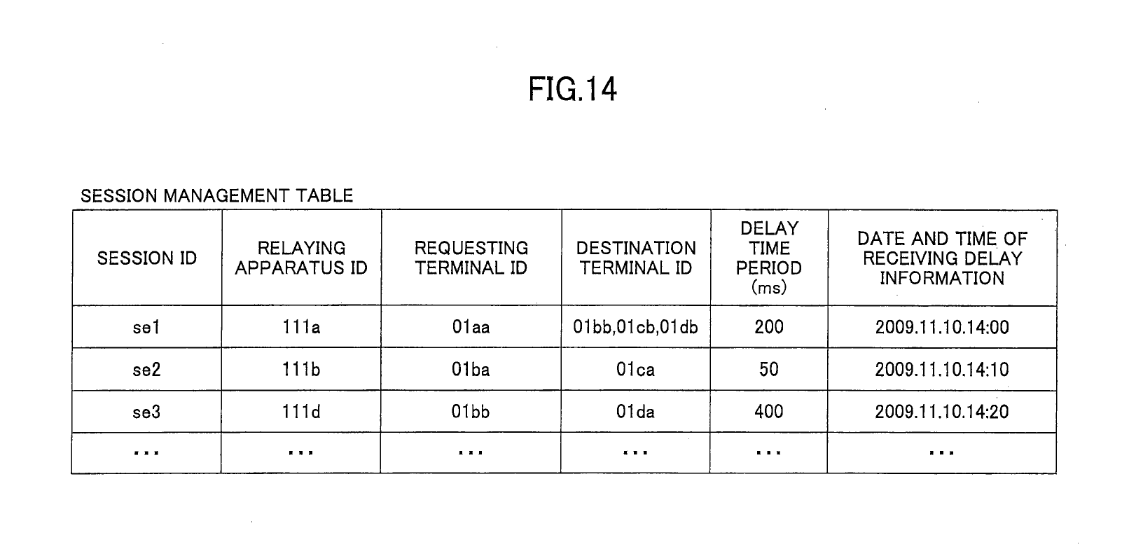

Further, the non-volatile memory 5000 includes a session management DB 5005 that includes a session management table such as shown in FIG. 14. FIG. 14 is a conceptual diagram of the session management table. The session management table manages, for each of session IDs that are used for identifying corresponding sessions in which content data is communicated among the terminals, a relaying apparatus ID of the relaying apparatus 30 that is used for relaying image data and audio data; the terminal ID of the requesting terminal 10; the terminal ID of the destination terminal; a delay time period (ms) for receiving image data at the destination terminal; and date and time of receiving delay information, which is transmitted from the destination terminal and which indicates the delay time period, by the management system 50. In the session management table, each of the selection session IDs is associated with the relaying apparatus ID of the relaying apparatus 30 that is used for relaying image data and audio data; the terminal ID of the requesting terminal; the terminal ID of the destination terminal; the delay time period (ms) for receiving image data at the destination terminal; and the date and time of receiving delay information by the management system 50. For example, the session management table shown in FIG. 14 indicates that the relaying apparatus 30a (which has the relaying apparatus ID of “111a”) that is selected in a session that is executed while using the session ID (se1) is relaying image data and audio data among the requesting terminal 10aa (which has the terminal device ID of “01aa”), the destination terminal 10bb (which has the terminal device ID of “01bb”), the destination terminal 10cd (which has the terminal device ID of “01cb”), and the destination terminal 10db (which has the terminal device ID of “01db”). The session management table shown in FIG. 14 also indicates that a delay time period of the image data at “14:00, Nov. 10, 2009” is 200 ms. When the video conference is performed between two terminals 10, the date and time of receiving the delay information may be managed based on the delay information that is transmitted from the requesting terminal, instead of the destination terminal. However, when the video conference is performed among three or more terminals 10, the date and time of receiving the delay information is managed based on the delay information that is transmitted from one of the terminals 10, which is receiving the image data and the audio data.

(Quality Management Table)

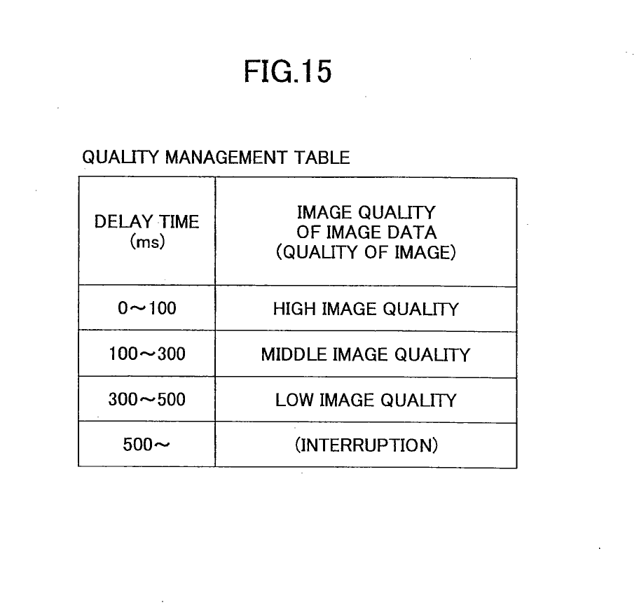

Further, the non-volatile memory 5000 includes a quality management DB 5007 that includes a quality management table such as shown in FIG. 15. FIG. 15 is a conceptual diagram showing the quality management table. The quality management table manages image quality of image data (quality of the image) that is relayed by the relaying apparatus 30. In the quality management table, delay time periods (ms) of the image data at the requesting terminal or at the destination terminal are associated with the corresponding types of the image quality.

(Attribute Management Table)

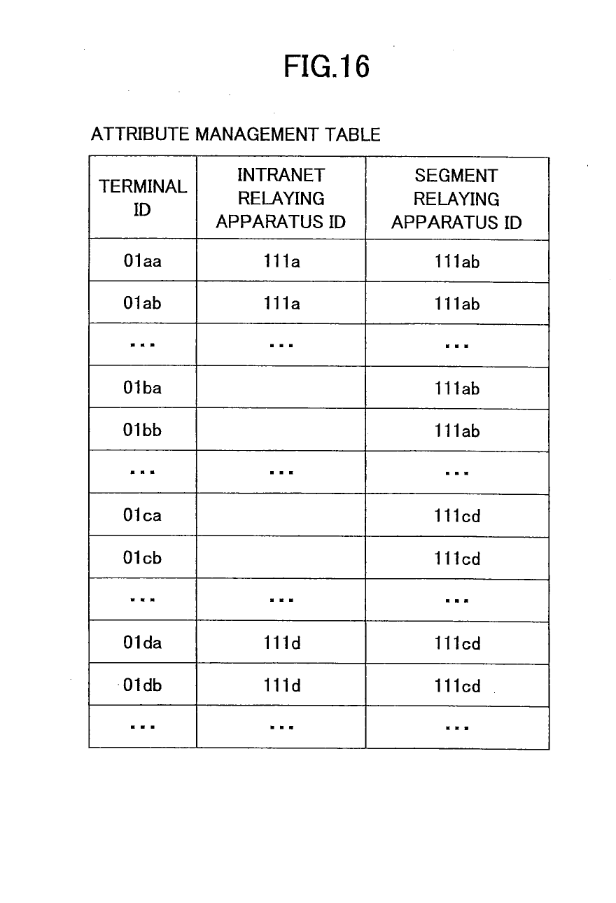

The non-volatile memory 5000 includes an attribute management DB 5008, which includes an attribute management table such as shown in FIG. 16. FIG. 16 is a conceptual diagram showing the attribute management table. In the attribute management table, each of the terminal IDs of the corresponding terminals 10, which are managed by the management system 50, is associated with first attribute information indicating a first attribute of the terminal 10 and second attribute information indicating a second attribute of the terminal 10. The attribute management table manages, for each of the terminal IDs of the corresponding terminals 10, the first attribute information and the second attribute information. Here, the first attribute information is, for example, information of an attribute with respect to a predetermined communication network (intranet) to which the terminal 10 is connected. Specifically, the first attribute information is a relaying apparatus ID for identifying the relaying apparatus 30, which is connected to the predetermined communication network (the relaying apparatus ID is referred to as the “intranet relaying apparatus ID,” hereinafter). The second attribute information is, for example, information of an attribute with respect to an area in which the terminal 10 is connected to the communication network 2. Specifically, the second attribute information is a relaying apparatus ID for identifying the relaying apparatus 30, which is connected to the communication network in the predetermined area (the relaying apparatus ID is referred to as the “segment relaying apparatus ID,” hereinafter). Namely, in the attribute management table which is shown in FIG. 16, each of the terminal IDs of the corresponding terminals 10 is associated with the relaying apparatus ID of the relaying apparatus 30, which is preferentially assigned for relaying image data and audio data. In this manner, the attribute management table manages the terminal IDs and the relaying apparatus IDs.

(Functional Elements of the Transmission Management System)

Next, functional elements of the transmission management system 50 are explained in detail. In the explanation below, while explaining the functional elements of the management system 50, there are explained relationships between the functional elements and the major components (among the components shown in FIG. 5) for achieving the functional elements.

The communication unit 51 is executed by the network I/F 209 shown in FIG. 5. The communication unit 51 transmits various types of data (information) to and receives various types of data (information) from another terminal, another apparatus, or another system through the communication network 2. The terminal authentication unit 52 searches the terminal device authentication management table of the non-volatile memory 5000 (cf., FIG. 11) for the terminal ID and the password by using the terminal device ID and the password included in the log-in request information that is received through the communication unit 51 as a search key. The terminal authentication unit 52 authenticates the terminal 10 by determining whether the terminal ID and the password that are the same as the terminal ID and the password included in the log-in request information is managed by the terminal device authentication management table.

In order to manage an operating state of the requesting terminal that requests to log-in, the state management unit 53 associates the terminal ID of the requesting terminal with the an operating state of the requesting terminal, date and time of receiving the log-in request information by the management system 50, and the IP address of the requesting terminal. The state management unit 53 stores the terminal ID of the requesting terminal, the operating state of the requesting terminal, the date and time of receiving the log-in request information by the management system 50, and the IP address of the requesting terminal in the terminal management table (cf. FIG. 12), and thereby the state management unit 53 manages the operating state of the requesting terminal. The state management unit 53 changes the operating state of the terminal management table (cf., FIG. 12) from the on-line to off-line, based on a state information indicating that the power supply is to be turned off, which is transmitted from the terminal 10 as a user switches the state of the power switch 109 from the ON state to OFF state.

The terminal extracting unit 54 searches the destination list management table (cf. FIG. 13) of the destination list management DB 5004 for the terminal ID by using the terminal ID of the requesting terminal that requests to log-in as a key, and the terminal extracting unit 54 extracts the terminal ID by reading out the terminal IDs of the candidates for the destination terminal that can communicate with the requesting terminal. Further, the terminal extracting unit 54 searches the destination list management table (cf. FIG. 13) of the destination list management DB 5004 for the terminal ID by using the terminal ID of the requesting terminal that requests to log-in as the key, and the terminal extracting unit 54 extracts a terminal ID of another requesting terminal that registers the terminal ID of the requesting terminal as a candidate for the destination terminal.

The terminal state acquisition unit 55 searches the terminal management table (cf. FIG. 12) of the terminal management DB 5003 for the operating states of the candidates for the destination terminal by using the corresponding terminal IDs of the candidates for the destination terminal which are extracted by the terminal extracting unit 54, and the terminal state acquisition unit 55 reads out, for each of the terminal IDs that is extracted by the terminal extracting unit 54, the corresponding operating state. In this manner, the terminal state acquisition unit 55 can obtain the operating states of the candidates for the destination terminal that can communicate with the requesting terminal, which requests to log-in. Further, the terminal state acquisition unit 55 searches the terminal management table of the terminal management DB 5003 for the operating state of the requesting terminal by using the terminal ID of the requesting terminal as the key, and thereby the terminal state acquisition unit 55 extracts the operating state of the requesting terminal, which requests to log-in.

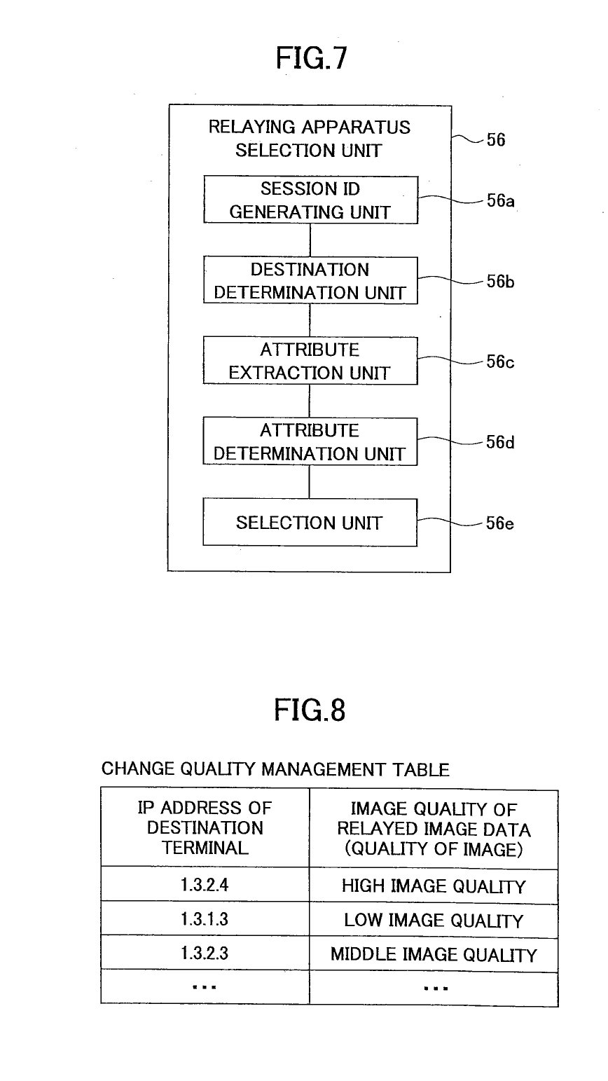

The relaying apparatus selection unit 56 selects, for each session in which content data is communicated among the terminals 10, the relaying apparatus 30, which is used for relaying image data and audio data. To do this, the relaying apparatus selection unit 56 achieves a session ID generating unit 56a, a destination determination unit 56b, an attribute extraction unit 56c, an attribute determination unit 56d, and a selection unit 56e, which are shown in FIG. 7, by an instruction from the CPU 201, which is shown in FIG. 5. Here, FIG. 7 is a functional block diagram, which shows the relaying apparatus selection unit 56 of FIG. 6B in detail.

The session ID generating unit 56a generates a session ID for identifying a session, in which content data is communicated among the terminals 10. The destination determination unit 56b determines whether a terminal ID of a requesting terminal which requests for a video conference is the same as a terminal ID of a destination terminal which is requested to participate in the video conference. The attribute extraction unit 56c searches the attribute management table (cf. FIG. 16) of the attribute management DB 5008 for attributes, based on the terminal IDs of the requesting terminal and the destination terminal. In this manner, the attribute extraction unit 56c extracts the corresponding attributes. The attribute determination unit 56d determines whether the attributes of the corresponding terminals, which are extracted by the attribute extraction unit 56c, are the same. The selection unit 56e selects a relaying apparatus, based on the attributes which are extracted by the attribute extraction unit 56c.

The session management unit 57 manages the session management table of the non-volatile memory 5000 (cf. FIG. 14). In the session management table, each of the session IDs generated by the session ID generating unit 56a is associated with the corresponding terminal ID of the requesting terminal and the corresponding terminal ID of the destination terminal. The session IDs, the corresponding terminal IDs of the requesting terminals, and the corresponding terminal IDs of the destination terminals are stored in the session management table. Further, the session management unit 57 stores, for each of the session IDs, the relaying apparatus ID of the corresponding relaying apparatus 30, which is selected by the selecting unit 56e, in the session management DB 5005 (cf. FIG. 14), and thereby the session management unit 57 manages, for each of the session IDs, the relaying apparatus ID of the corresponding relaying apparatus 30.

The quality determination unit 58 searches the quality management table (cf. FIG. 15) of the quality management DB 5007 for the image quality by using the delay time period as a search key, and the quality determination unit 58 extracts the image quality of the image data corresponding to the delay time period. In this manner, the quality determination unit 58 determines the image quality of the image data, which is relayed by the relaying unit 30. The storing and reading unit 59 is executed by the HDD 205 shown in FIG. 5. The storing and reading unit 59 stores various types of data into the non-volatile memory 5000, and reads out various types of data stored in the non-volatile memory 5000. The delay time management unit 60 searches the terminal management table (cf. FIG. 12) for the terminal ID by using the IP address of the destination terminal as a search key, and thereby the delay time management unit 60 extracts the corresponding terminal ID. Further, in the session management table of the session management DB 5005 (cf. FIG. 14), the delay time management unit 60 stores the delay time period indicated in the delay information into a field for the delay time period of the record, which includes the extracted terminal ID.

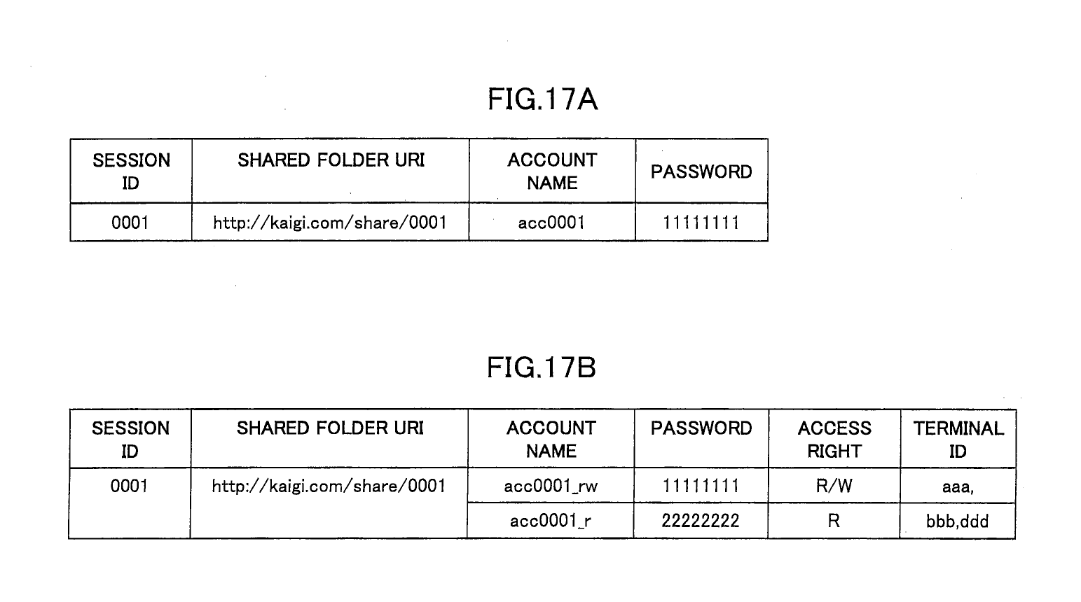

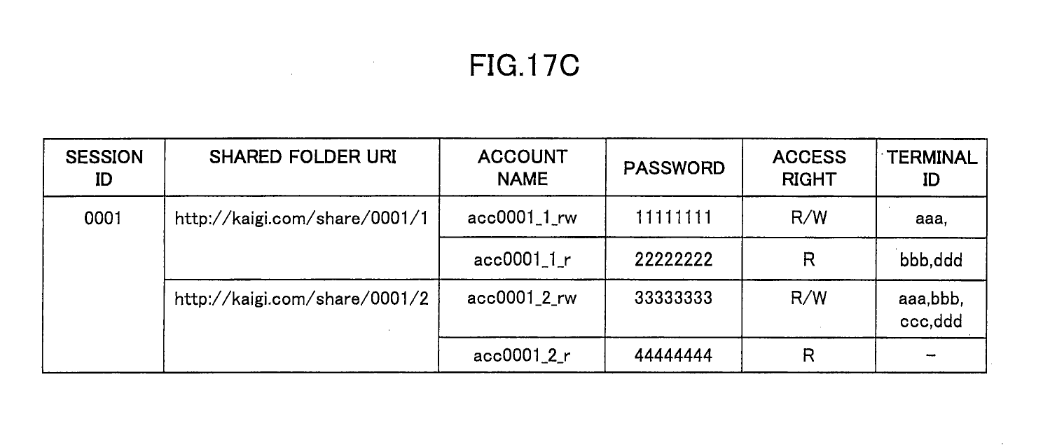

Subsequent to establishing a session by the management system 50, the shared folder management unit 61 mainly performs the following processes.
Causing the file temporary storage device 40 to create the shared folder 47 which is to be shared by the terminals 10 which participate in the session.
Create a shared folder table 48 (cf. FIGS. 17A, 17B, and 17C).

In the shared folder table 48 (which is explained later), a shared folder URI, an account name, and a password are registered. The shared folder URI indicates the location of the shared folder 47. The account name and the password are included in the account information. Additionally, access control information is registered in the shared folder table 48. This is explained later.

The shared folder management unit 61 transmits a record to the file temporary storage device 40 each time one record of the shared folder table 48 is created. The shared folder management unit 61 transmits the shared folder URI, the account name, and the password to the terminals 10 and the file temporary storage device 40.

<File Temporary Storage Device>

Next, functional units of the file temporary storage device 40 are explained. The file temporary storage device 40 includes a folder storage unit 41, a shared folder creation unit 42, an access control unit 43, a file synchronization unit 44, a communication unit 45, and a file management DB 46.

(Shared Folder Table)

FIG. 17A shows an example of the shared folder table 48, which is created by the management system 50. The shared folder table 48 is transmitted to the file temporary storage device 40, and the file management DB 46 stores the shared folder table 48. The management system 50 stores the same for backup purposes. In the shared folder table 48, the “session ID” is associated with the “shared folder URI,” the “account name,” and the “password.” The “session ID” is retrieved from the session management table. The “shared folder URI” is created by the shared folder management unit 61.

The shared folder URI indicates the location of the shared folder 47 in accordance with the URI schema. For the case of FIG. 17A, in the session (conference) having the session ID of “0001,” the shared folder 47 is created at “http://kaigi.com/share/0001.” In many cases, the URI includes a part of the URL of the file temporary storage device 40, or the URI includes the whole URL of the file temporary storage device 40.

The “account name” is identification information for the file temporary storage device 40 to identify the terminal 10. The “password” is the authentication information for the terminal 10 to load the shared folder 47. When a combination of the “account name” and the “password,” which is transmitted from the terminal 10, coincides with a combination of the “account name” and the “password,” which is registered in the shared folder table 48, the file temporary storage device 40 allows loading of the shared folder 47.

Access right for reading a file of the shared folder 47 and for writing a file of the shared folder 47 is given to the terminal 10. Namely, all the terminals 10 have the access right for reading and writing. The access right may be limited only for reading. Similarly, the access right may be limited only for writing.

FIGS. 17B and 17C are examples of the shared folder table 48. These are explained later.

The folder storage unit 41 is achieved by the HD 204, which is shown in FIG. 5. The folder storage unit 41 is a resource for storing the shared folder 47. Namely, the above-described URI indicates the folder storage unit 41.

When the shared folder creation unit 42 receives a request for creating a shared folder from the shared folder management unit 61, the shared folder creation unit 42 creates, for each session, an independent shared folder 47. The folder may be referred to as a “directory.” In this case, the shared folder is the shared directory. The shared folder creation unit 42 deletes the shared folder 47 when the conference is terminated. In many cases, one shared folder 47 is created for a single session. However, it is possible that a plurality of shared folders 47 is created for a single session.

The access control unit 43 determines whether the terminal 10 has the access right for writing by referring to the shared folder table 48. Similarly, the access control unit 43 determines whether the terminal 10 has the access right for reading by referring to the shared folder table 48.

The file synchronization unit 44 manages sharing of a file, so that a file of the share folder 47 which is loaded by a terminal 10 can be accessed by another terminal 10, by communicating with the file synchronization unit 24 of the terminal 10. Namely, a file which is stored in the shared folder 47 can be displayed or opened on the PC 120, which is connected to the other terminal 10. The entity of the file is stored in the file temporary storage device 40. In a normal state, each of the terminals 10 stores only the file name of the file (which includes the icon of the file).

The file which is written by the PC 120 on the terminal 10 is uploaded to the shared folder 47 by the folder synchronization unit 26 of the terminal 10 by communicating with the folder synchronization unit 44 of the file temporary storage device 40. No files remain in the terminal 10. Further, the folder synchronization unit 44 of the file temporary storage device 40 transmits the file name to other terminals 10 with which the session is established. Accordingly, the file name can be referred to from all the terminals (PC), and the file can be read, provided that the access right for reading is given.

The file synchronization unit 24 of the terminal 10 and the file synchronization unit 44 of the file temporary storage device 40 share a file, for example, by using a protocol such as the Server Message Block (SMB) or the Common Internet File System (CIFS). The file sharing is achieved in such a manner that one of devices, which are connected through a network, transmits a request to a file system of another one of the devices, and the one of the devices retrieves the processed result. For example, when one of devices transmits a request for a file to another one of the devices, the other one of the devices reads out the file, and the other one of the devices transmits the file to the one of the devices. Alternatively, when one of devices transmits a file to another one of the devices, the other one of the devices writes the file, and the other one of the devices transmits to the one of the devices that the other one of the devices has written the file.

For a case in which the file synchronization units 24 and 44 share a file by the SMB, a SMB service is called. For the case of the SMB, the file sharing is provided as a client-server type service (a service such that a client requests a service, and the server provides the service). In the embodiment, the file temporary storage device 40 may be a server or a client, and the terminal 10 may be a server or a client. Accordingly, the terminal 10 and the file temporary storage device 40 have both a client SMB service and a server SMB service. Here, as a protocol for the file sharing, the WebDAV, the Network File System (NFS), or the like may be utilized.

<PC>

Next, functional units of the PC 120 are explained in detail. Since a hardware configuration of the PC 120 is the same as that of the management system 50, an explanation of the hardware configuration is omitted. In many cases, the PC 120 is a personal computer. However, it suffices if the PC 120 is an information processing device including a display, such as a tablet terminal, a smart phone, or a mobile telephone.

The PC 120 includes an operation receiving unit 71, a file operating unit 72, a file DB 73, and a communication unit 74. The communication unit 74 is achieved by the external device I/F 215, which is shown in FIG. 5. The communication unit 74 transmits a file to the terminal 10, and receives a file from the terminal 10. The communication unit 74 may be a USB interface, a Bluetooth host, or a wireless LAN interface, for example.

The file DB 73 is achieved by the HD 204, which is shown in FIG. 5. The file DB 73 stores various types of files. Examples of the file include files which are created by various types of applications, such as a document file, a file for presentation, or a spreadsheet file. In addition to these data files, the file DB 73 stores an executable file of an application (eg., *.exe *.dll).

The operation receiving unit 71 is achieved by the keyboard 211 and the mouse 212, which are shown in FIG. 5. The operation receiving unit 71 receives an operation on the PC 120 by a participant. Since the terminal 10 (or the mount drive 22) is recognized as a storage device by the PC 120, the operation receiving unit 71 may receive the following operations, which are operated by the participant.
An operation for copying a file in the file DB 73 to the terminal 10.
An operation for moving a file in the file DB 73 to the terminal 10.
An operation for deleting a file in the terminal 10.

When the operation receiving unit 71 receives such a file operation, the file operating unit 72 operates on the file. For example, when a participant performs an operation for copying a file of the file DB to the terminal 10, the file operating unit 72 transmits the file of the file DB to the terminal 10 through the communication unit 74. The PC communication unit 21 of the terminal 10 stores the received file in the mount drive 22. The display 208 of the PC 120 displays a file name of the file, which is copied to the mount drive 22 of the terminal 10.

<<Processing and Operations>>

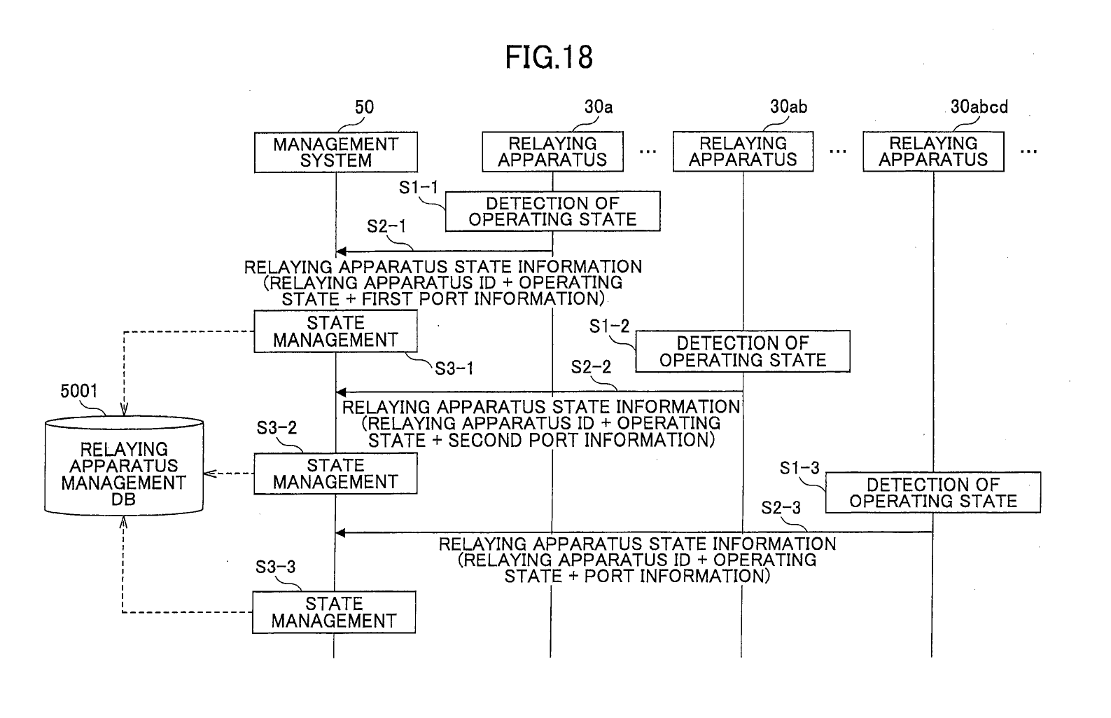

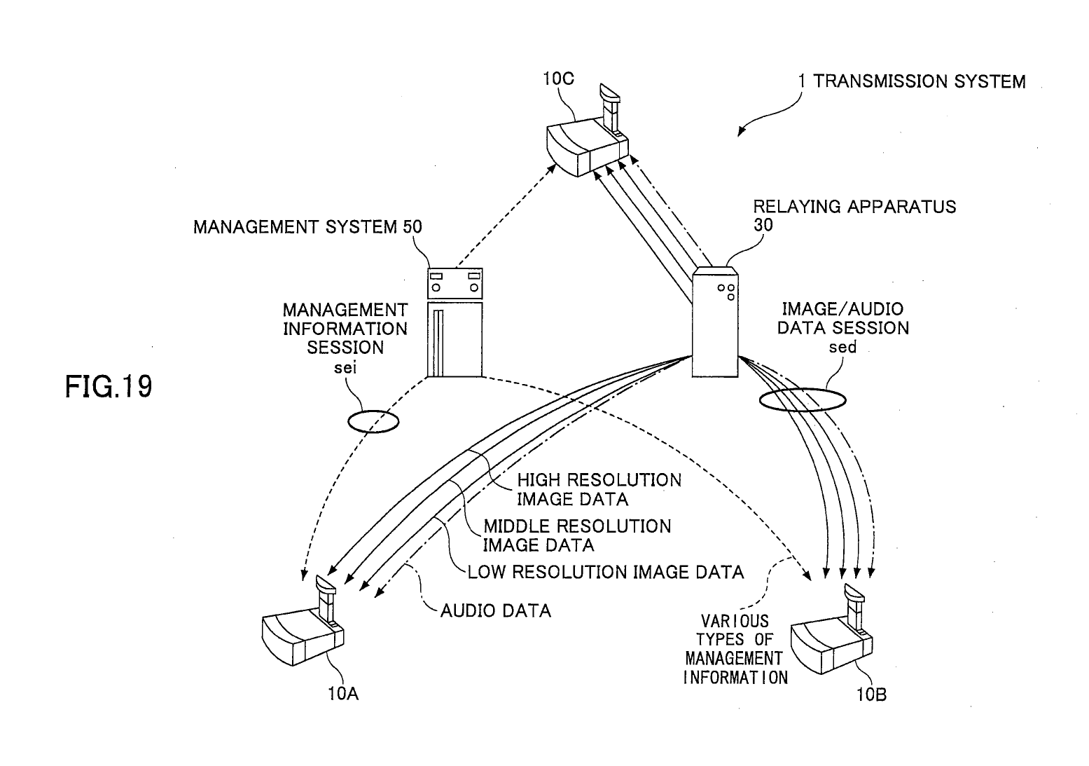

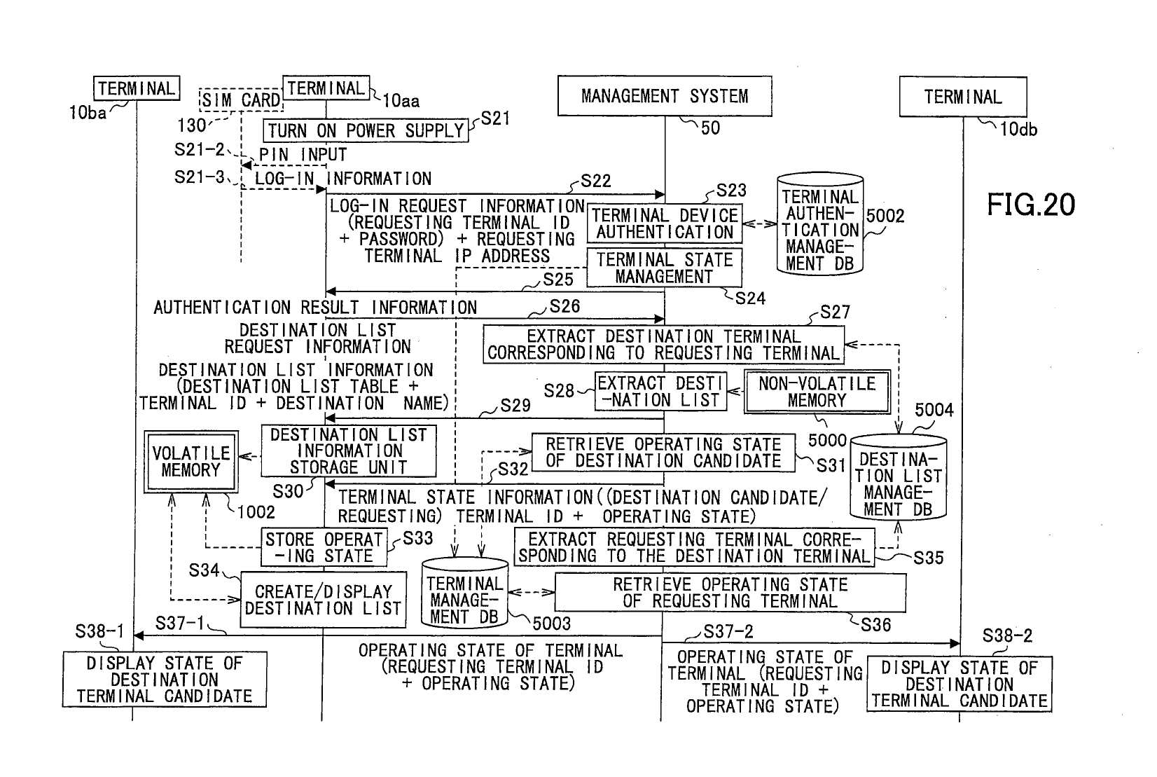

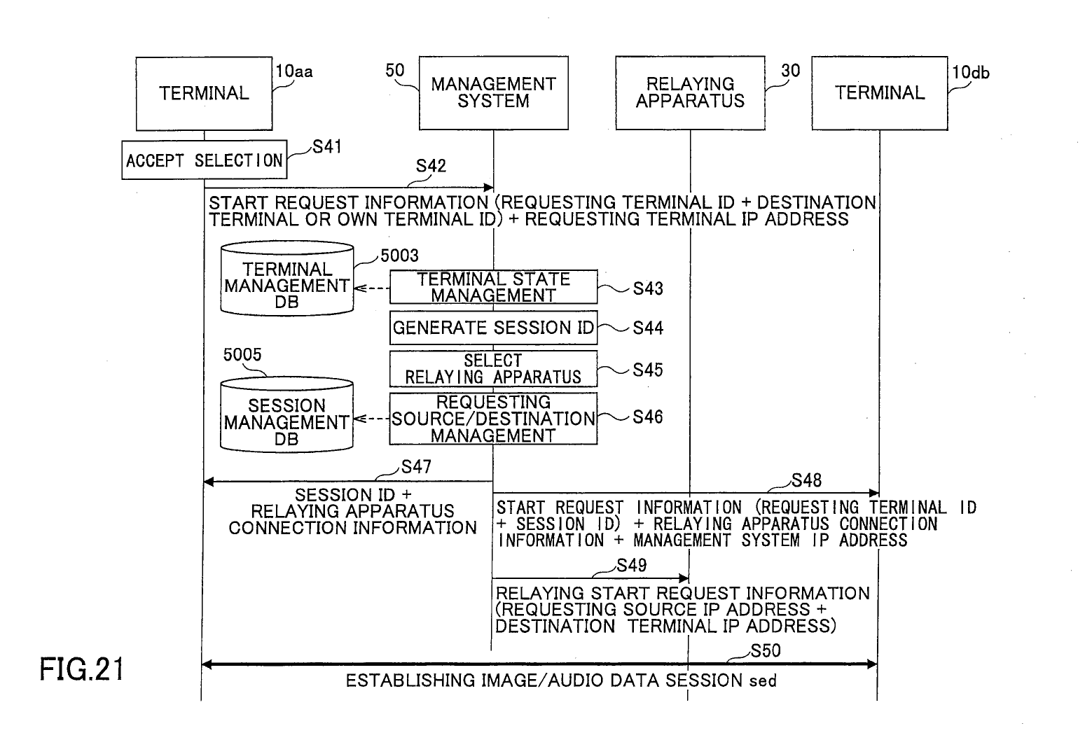

The configuration and functions (or units) of the transmission system 1 according to the embodiment are described above. Hereinafter, there is explained a processing method in the transmission system 1 according to the embodiment by referring to FIGS. 18-22. FIG. 18 is a sequence diagram showing a process of managing state information indicating states of the corresponding relaying apparatuses 30. The state information is transmitted from the corresponding relaying apparatuses 30 to the management system 50. FIG. 19 is a conceptual diagram showing a state of transmitting and receiving image data, audio data, and various types of management information in the transmission system 1. FIG. 20 is a sequence diagram showing processes in a preparatory phase of starting communications among a plurality of the terminals 10. FIG. 21 is a sequence diagram showing a process of selecting the relaying apparatus 30. FIG. 22 is a conceptual diagram showing the destination list according to the embodiment.

First, there is explained the process of managing the state information indicating the states of the corresponding relaying apparatuses 30 that is transmitted from the corresponding relaying apparatuses 30 to the management system 50 by referring to FIG. 18. In each of the relaying apparatuses 30, the state detection unit 32 shown in FIG. 6D regularly detects an operating state of the relaying apparatus 30 itself (step S1-1-step S1-3). The state detection unit 32 detects a number of ports (available port number) which are the ports of the relaying apparatus 30 itself and which can be used for communication with the terminal 10, and a number of ports (used port number), among the available ports, which are used for the communication with the terminal 10. In order for the management system 50 to manage the operating states of the corresponding relaying apparatuses 30 in real time, the communication unit 31 of each of the relaying apparatuses 30 regularly transmits the state information to the management system 50 through the communication network 2 (steps S2-1-S2-3). The state information includes the relaying apparatus IDs of the corresponding relaying apparatuses 30 and the operating states detected by the state detection unit 32 of the corresponding relaying apparatuses 30. The state information also includes port information including the above-described available port number and the used port number.

In the above-described steps (step S2-1-step S2-3) for transmitting the state information, when the relaying apparatus 30 transmits the state information through a firewall, it is preferable for the relaying apparatus 30 to perform secure communication to ensure the security. Here, the secure communication means that communication is performed in such a manner that a third party cannot understand contents of the communication. Examples of the secure communication include communications using the Transport Layer Security (TLS), the Secure Sockets Layer (SSL), or a tunneling service. For example, in the transmission system 1a of FIG. 1A, the communication units 31 of the relaying apparatuses (30a, and 30d) can transmit the state information to the management system 50 by using the SSL. When the communication units 31 of the relaying apparatuses (30a, and 30d) may not perform the SSL communications, the communication units 31 can map the communications onto corresponding secure ports. The mapping can be achieved by a known tunneling service, such as the multiplatform SSL tunneling proxy (Stunnel). Specifically, the communication unit 31 can establish a secure connection with the management system 50 by mapping the SSL port onto the port of the mail server.

Next, the communication unit 51 of the management system 50 receives the state information which is transmitted from the relaying apparatuses 30. Here, for the case in which the communication is mapped, the communication unit 51 can receive the state information through the tunneling service of the management system 50. The management system 50 stores, for each of the relaying apparatus IDs, the corresponding received state information in the relaying apparatus management table (cf. FIG. 10) of the non-volatile memory 5000 through the storing and reading unit 59. In this manner, the management system manages the state information for each of the relaying apparatus IDs (step S3-1-step S3-3). With this, for each of the relaying apparatus IDs, one of the operating states of the “on-line state,” the “off-line state,” or “out-of-order” is stored and managed in the relaying apparatus management table, such as shown in FIG. 10. Further, for each of the relaying apparatus IDs, port information including an available port number and a used port number is stored in the relaying apparatus management table. Furthermore, for each of the relaying apparatus IDs, the date and time of receiving the state information by the management system 50 are stored in the relaying apparatus management table. For a case in which the state information is not transmitted from a relaying apparatus 30, an operating state field portion and a receiving date and time field portion in the corresponding record of the relaying apparatus management table (which is shown in FIG. 10) become blank, or the operating state field portion and the receiving date and time field portion in the corresponding record show the operating state and the date and time of receiving for the previous time.

Next, there is explained a state of the transmission system 1, in which image data, audio data, and various types of management information are transmitted and received, by referring to FIG. 19. As shown in FIG. 19, in the transmission system 1, a management information session sei is established among the terminal 10A, the terminal 10B, and the terminal 10C, through the management system 50. Additionally, among the terminals 10A, 10B, and 10C, four sessions are established through the relaying apparatus 30 for transmitting and receiving high-resolution image data, middle-resolution image data, low-resolution image data, and audio data, respectively. Here, these four sessions are collectively indicated as an image/audio data session sed.

Next, there is explained a process of transmitting and receiving various types of management information between the terminal 10aa and the terminal 10db at a preparatory stage prior to starting communication by referring to FIG. 20. FIG. 20 shows processes of transmitting and receiving various types of management information. Here, all of the various types of management information are transmitted and received by the management information session sei.

When a user of the terminal 10aa turns on the power switch 109 (which is shown in FIG. 3), the operation input receiving unit 12 (which is shown in FIG. 6C) receives the turning ON of the power supply, and the operation input receiving unit 12 turns ON the power supply (step S21).

When the terminal 10aa is compatible with the SIM card 130, the SIM card 130 is made accessible by inputting a PIN to the SIM card 130 (step S21-2). Then, log-in information is retrieved from the SIM card 130 (step S21-3). The terminal 10aa may store the PIN. Alternatively, a PIN input screen may be provided, and a user may be prompted to input the PIN. The SIM card 130 may store the terminal ID and the password as the log-in information, and that log-in information may be retrieved. However, usually, in an authentication process using a SIM card, a key which is stored inside the SIM card is not output. Instead, within the SIM card, the SIM applies an operation, in which the key is utilized, to a specific value which is input by a server, and the SIM card returns a value which can only be calculated by the SIM to the server. In this manner, client authentication is performed with respect to the server.

It can be changed, depending on implementation, as to whether the PIN input is enabled or disabled. In addition, it can also be changed, depending on implementation, which type of access is enabled by the PIN input. For example, when no PINs are input, both the reading and writing may be disabled, and when a correct PIN is input, both the reading and writing may be enabled. A function may be provided such that, when an erroneous PIN is input multiple times, the SIM is locked.

Subsequently, the log-in requesting unit 13 automatically transmits log-in request information (which indicates a log-in request) from the communication unit 11 to the management system 50 through the communication network 2 (step S22). The log-in request information includes the terminal ID and the password, which are for identifying the terminal 10aa as a requesting source. The terminal ID and the password are read out from the non-volatile memory 1000 through the storing and reading unit 19, and transmitted to the communication unit 11. When the log-in request information is transmitted from the terminal 10aa to the management system 50, the management system 50, which is a receiving side, can recognize an IP address of the terminal 10aa, which is a transmitting side.

Subsequently, the terminal authentication unit 52 of the management system 50 searches the terminal authentication management table (cf. FIG. 11) of the non-volatile memory 5000 for the terminal ID and the password by using the terminal ID and the password, which are included in the log-in request information received through the communication unit 51, as keys. The terminal authentication unit 52 performs the terminal authentication by determining whether the terminal ID and the password, which are the same as the terminal ID and the password included in the log-in request information, are managed by the terminal authentication management DB (step S23).

When the terminal authentication unit 52 determines that the terminal ID and the password, which are the same as the terminal ID and the password included in the log-in request information, are managed by the terminal management table of the terminal management DB 5003, and thereby the terminal authentication unit 52 determines that the log-in request is from the terminal 10 having a valid usage right, the state management unit 53 associates the terminal ID of the terminal 10aa with, for each of the records indicated by the destination names, the operating state, the date and time of receiving the log-in request information, and the IP address of the terminal 10aa, and stores the terminal ID of the terminal 10aa, the operating state, the date and time of receiving the log-in request information, and the IP address of the terminal 10aa into the terminal management table (step S24). In this manner, in the terminal management table shown in FIG. 12, the terminal ID of “01aa” is associated with the operating state of “the online state,” the receiving date and time of “2009.11.10.13:40,” and the terminal IP address of “1.2.1.3,” and thereby the terminal management table manages the terminal ID, the operating state, the receiving date and time, and the terminal device IP address.

The communication unit 51 of the management system 50 transmits authentication result information indicating the result of the authentication that is obtained by the terminal authentication unit 52 to the requesting terminal (terminal 10aa) that requests to log-in through the communication network 2 (step S25).

Next, post-processes of the authentication are explained for a case in which the authentication by the terminal authentication unit 53 is successful. When the terminal 10aa receives authentication result information indicating that the terminal 10aa is determined to be a terminal having a legitimate usage right, the communication unit 11 transmits destination list request information indicating that a destination list is requested to the management system 50 through the communication network 2 (step S26). In this manner, the communication unit 51 of the management system 50 receives the destination list request information.

Next, the terminal extracting unit 54 searches the destination list management table (cf. FIG. 13) of the destination list management DB 5004 for the terminal ID of the destination terminal by using the terminal ID “01aa” of the requesting terminal (terminal 10aa) which is requesting to log-in as a search key. In this manner, the terminal extracting unit 54 extracts the terminal IDs of the candidates of the destination terminal, which can communicate with the requesting terminal (terminal 10aa) by reading out the terminal IDs of the candidates (step S27). The terminal extracting unit 54 also searches the terminal management table (cf., FIG. 12) of the terminal management DB for a destination name by using the extracted terminal ID as a search key. In this manner, the terminal extracting unit 54 extracts the destination name corresponding to the terminal ID by reading out the destination name. Here, the terminal IDs (“01ab,” “01ba,” “01bb,” . . . ) of the destination terminals (10ab, 10ba, 10bb, . . . ) corresponding to the terminal device ID “01aa” of the requesting terminal (terminal 10aa) are extracted. In addition, the terminal device names (“Company A, Tokyo Office, AB terminal,” “Company B, Osaka Office, BA terminal,” . . . ), which are corresponding to the extracted terminal device IDs, are extracted.

Subsequently, the communication unit 51 of the management system 50 reads out data of the destination list table (which is the data of the destination list table 311-1 of FIG. 22) from the non-volatile memory 5000 through the storing and reading unit 50 (step S28). At the same time, the communication unit 51 transmits “destination list information (destination list table, terminal ID, destination name),” which includes the destination list table, and which includes the terminal ID and the destination name extracted by the terminal extracting unit 54, to the requesting terminal (terminal 10aa) (step S29). In this manner, in the requesting terminal (terminal 10aa), the communication unit 11 receives the destination list information, and the storing and reading unit 19 stores the destination list information in the volatile memory 1002 (step S30).

As described above, according to the embodiment, the destination list is not managed by the terminals 10, but the management system 50 centrally manages the destination list information of all the terminals 10. Accordingly, even if a new terminal 10 is introduced to the transmission system 1, a terminal 10 as a new model is introduced to the transmission system 1 in place of an already included terminal 10, or an appearance of the destination list table is changed, since the management system 50 collectively handles these processes, complexity of updating the destination list information in each of the terminals can be eliminated.

The terminal state acquisition unit 55 of the management system searches the terminal device management table (cf. FIG. 12) for the operating states of the terminals 10ab, 10ba, 10bb, . . . by using the terminal IDs “01ab,” “01ba,” “01bb,” . . . , of the candidates of the destination terminal as search keys. The terminal state acquisition unit 55 obtains the operating states of the terminals 10ab, 10ba, 10bb, . . . , by reading out the operating states for the corresponding terminal IDs, which are extracted by the terminal extracting unit 54 (step S31).

Subsequently, the communication unit 51 transmits “terminal state information” to the requesting terminal (terminal 10aa) through the communication network 2 (step S32). Here, the “terminal state information” includes the terminal ID “01ab” as the search key, which is used at step S27, and the corresponding operating state “on-line (being communicatable)” of the destination terminal (terminal 10ab). Similarly, as a part of step S32, the communication unit 51 individually transmits remaining “terminal state information” to the requesting terminal (terminal 10aa). Here, the remaining “terminal state information” is, for example, the “terminal state information” including the terminal ID of “01ba” and the operating state of “on-line (temporarily suspended)” of the corresponding destination terminal (terminal 10ba).

Subsequently, the storing and reading unit 19 of the requesting terminal (terminal 10aa) sequentially stores the state information of the terminals, which are received from the management system 50, into the volatile memory 1002 (step S33). By receiving the state information of each of the terminals 10, the requesting terminal (terminal 10aa) can retrieve corresponding current operating state information of the terminals 10, which are candidates for the destination terminal. Here, the destination terminal can communicate with the requesting terminal (terminal 10aa).

Subsequently, the destination list creation unit 20 of the requesting terminal (terminal 10aa) creates a destination list based on the destination list information, which is stored in the volatile memory 1002, and the state information of the terminals 10. Here, the destination list indicates the states of the terminals 10 as the destination candidates. At the same time, the display control unit 16 controls the timing for displaying the destination list on the display 120 (which is shown in FIG. 3) (step S34).

By doing these, the destination list is displayed on the display 120aa, as shown in FIG. 22. The destination list is in a state such that, in the destination list table 311-1, the icons 311-3a and the like are displayed, which indicate corresponding destination names 311-2 and state information.

Referring again to FIG. 20, the terminal extracting unit 54 of the management system searches the destination list management table (cf. FIG. 13) of the destination list management DB 5004 for a terminal ID of another requesting terminal by using the terminal ID “01aa” of the requesting terminal (terminal 10aa), which requests to log-in, as a search key. In this manner, the terminal extracting unit 54 extracts the terminal ID of the other requesting terminal, which registers the terminal ID “01aa” of the requesting terminal (terminal 10aa) as a candidate for the destination terminal (step S35). In the destination list management table (which is shown in FIG. 13), the terminal IDs of the other extracted terminals are “01ab,” “01ba,” and “01db.”

Subsequently, the terminal state acquisition unit 55 of the management system 50 searches the terminal management table (cf. FIG. 12) of the terminal management DB 5003 for the operating state of the requesting terminal by using the terminal ID “01aa” of the requesting terminal (terminal 10aa), which requests to log-in, as a search key. In this manner, the terminal state acquisition unit 55 retrieves the operating state of the requesting terminal (terminal 10aa), which requests to log-in (step S36).

Then, the communication unit 51 transmits “terminal state information” to the terminals (10ba, and 10db) (step S37-1, and step S37-2). Here, among the terminals (10ab, 10ba, and 10db) corresponding to the terminal IDs (“01ab,” “01ba,” and “01db”), which are extracted at step S35, the operating states of the terminals (10ba, and 10db) are “on-line” in the terminal management table (cf. FIG. 12) of the terminal management DB 5003. The terminal ID “01aa” of the requesting terminal (terminal 10aa) and the operating state “on-line,” which are retrieved at step S36, are included in the “terminal state information.” When the communication unit 51 transmits the terminal state information to the terminals (10ba, and 10db), the communication unit 51 refers to the IP addresses of the terminals (10ba, and 10db), which are managed by the terminal management table (which is shown in FIG. 12), based on the corresponding terminal IDs (“01ba,” and “01db”). In this manner, the terminal ID “01aa” and the operating state “on-line” of the requesting terminal (terminal 10aa), which requests to log-in, can be transmitted to the other destination terminals (10db, and 10ba), which can communicate with the requesting terminal (terminal 10aa), which requests to log-in, as a destination.

In other terminals 10, similar to step S21, when a user turns on the power supply 109 (which is shown in FIG. 3), the operation input receiving unit (which is shown in FIG. 6C) receives the turning ON of the power supply, and performs the processes which are the same as those of steps S22-S38-1, and S38-2. Thus, explanations of these are omitted.

Next, there are explained processes for the terminal to start communicating with another terminal by referring to FIG. 21. FIG. 21 shows the processes in which various types of management information are transmitted and received only by the management information session sei. In the embodiment, the requesting terminal (terminal 10aa) can request to start communication by selecting at least one of the destination terminals, whose operating states are on-line, among the terminals 10 as the destination candidates, based on the terminal state information which is received at step S32, or by selecting the requesting terminal itself (terminal 10aa). Here, selecting the requesting terminal itself (terminal 10aa) means that the requesting terminal (terminal 10aa) requests connecting only the requesting terminal itself to the relaying apparatus 30. Hereinafter, there are explained the processes of requesting to start communication.

When a user of the requesting terminal (terminal 10aa) selects a destination terminal (which is assumed to be the terminal 10db, here) by pressing the operation button 108 (which is shown in FIG. 3), the operation input receiving unit 12 (which is shown in FIG. 6C) receives a request to start communication (step S41). The communication unit 11 of the terminal 10aa transmits start request information to the management system 50 (step S42). Here, the start request information includes terminal ID of the terminal 10aa and the terminal ID of the selected destination terminal, and the start request information indicates the request to start communication. In this manner, the communication unit 51 of the management system 50 receives the start request information, and at the same time recognizes the IP address of the terminal 10aa, which is the transmission source.

In the terminal management DB 5003 (cf. FIG. 12), the state management unit 53 changes operation state field portions of the record including the terminal ID of the requesting terminal (terminal 10aa) and the terminal ID of the destination terminal (terminal 10db), respectively, to be “busy,” based on the terminal ID of the requesting terminal (terminal 10aa) and the terminal ID of the destination terminal (terminal 10db) (step S43). In this state, the terminals (10aa, and 10db) are not starting the communication yet; however, the states of the terminals (10aa, and 10db) are busy states. Thus, if another terminal 10 attempts to communicate with the terminals (10aa, and 10db), a voice or an indication indicating a busy state is output.

Next, the management system 50 performs a process for selecting the relaying apparatus 30. In this case, the session ID generating unit 56a generates a session ID “se1” (step S44). The session ID “se1” is for identifying a session (an image/audio data session sed) for executing the communication with the destination terminal, which is requested by the requesting terminal (terminal 10aa).

Subsequently, the relaying apparatus selection unit 56 of the management system 50 selects the relaying apparatus 30 for relaying the communication between the requesting terminal (terminal 10aa) and the destination terminal, based on the relaying apparatus management DB 5001 and a selection management DB (step S45). Hereinafter, the process of selecting the relaying apparatus 30 is concretely explained.

First, the destination determination unit 56b determines whether the terminal ID of the destination terminal (terminal 10db), which is included in the start request information transmitted from the requesting terminal (terminal 10aa), is the same as the terminal ID of the requesting terminal (whether the requesting terminal itself is selected as the destination). When the terminal ID of the destination terminal is the same as the terminal ID of the requesting terminal, the selection unit 56e selects the relaying apparatus 30abcd (a common relaying apparatus). At the time of selecting the relaying apparatus 30, the communication network 2, to which a terminal that subsequently participates in this session is connected, is unknown, and an area, in which the terminal is connected to the communication network 2, is unknown. Thus, it is preferable to select a relaying apparatus to which all the terminals can be connected.

When the terminal ID of the destination terminal is not the same as the terminal ID of the requesting terminal, the attribute extraction unit 56c searches the attribute management table (cf. FIG. 16) of the attribute management DB for the relaying apparatus ID, based on the terminal IDs of the requesting terminal (terminal 10aa) and the destination terminal (terminal 10db). In this manner, the attribute extraction unit 56c extracts the corresponding intranet relaying apparatus IDs. Then, the attribute determination unit 56d determines whether the extracted intranet relaying apparatus IDs are the same (whether it is possible for the requesting terminal and the destination terminal to use the same intranet relaying apparatus). When the extracted intranet relaying apparatus IDs are the same, the selection unit 56e selects the relaying apparatus (an intranet relaying apparatus) which is identified by the extracted intranet relaying apparatus ID. In this manner, the selected relaying apparatus and all the terminals which participate in the session are connected to the same intranet. Consequently, the communication path is shortened, and the transmission rate is increased. At the same time, since the transmitted content data does not cross a firewall, security is ensured.

Here, even if the intranet relaying apparatus IDs, which are extracted by the attribute extraction unit 56c, are the same, depending on the state of the intranet relaying apparatus which is identified by the intranet relaying apparatus ID, subsequent processes are executed. In this case, the management system 50 searches the relaying apparatus management table (cf. FIG. 10) of the non-volatile memory 5000 for the operation state, based on the relaying apparatus ID of the intranet relaying apparatus. In this manner, the management system 50 extracts the corresponding operating state. When the extracted operating state is “off-line,” the management system 50 executes the subsequent processes. In another example, the management system 50 searches the relaying apparatus management table (cf. FIG. 10) for the used port number and the available port number, based on the relaying apparatus ID of the intranet relaying apparatus. When an operating rate, which is calculated based on the extracted used port number and the available port number, is greater than a predetermined value, the management system 50 executes the subsequent processes.

When the relaying apparatus IDs, which are extracted by the attribute extraction unit 56c, are not the same, the attribute extraction unit 56c searches the attribute management table (cf. FIG. 16) of the attribute management DB for the segment relaying apparatus ID, based on the terminal IDs of the requesting terminal (terminal 10aa) and the destination terminal (terminal 10db). In this manner, the attribute extraction unit 56c extracts the corresponding segment relaying apparatus IDs. Then, the attribute determination unit 56d determines whether the extracted segment relaying apparatus IDs are the same (whether the requesting terminal and the destination terminal can use the same segment relaying apparatus). When the extracted segment relaying apparatus IDs are the same, the selection units 56e selects the relaying apparatus (the segment relaying apparatus) which is identified by the extracted segment relaying apparatus ID. In this manner, the selected relaying apparatus and all the terminals which participate in the session are connected to the communication network 2 in the same segment. Consequently, the communication path is shortened, and the transmission rate is increased.

Here, even if the segment relaying apparatus IDs, which are extracted by the attribute extraction unit 56c, are the same, depending on the state of the segment apparatus which is identified by the segment relaying apparatus ID, subsequent processes executed. In this case, the management system 50 searches the relaying apparatus management table (cf. FIG. 10) of the non-volatile memory 5000 for the operation state, based on the relaying apparatus ID of the segment relaying apparatus. In this manner, the management system 50 extracts the corresponding operating state. When the extracted operating state is “off-line,” the management system 50 executes the subsequent processes. In another example, the management system 50 searches the relaying apparatus management table (cf. FIG. 10) for the used port number and the available port number, based on the relaying apparatus ID of the segment relaying apparatus. When an operating rate, which is calculated based on the extracted used port number and the available port number, is greater than a predetermined value, the management system 50 executes the subsequent processes.

When the extracted segment terminal IDs are not the same, the selection unit 56e selects the relaying apparatus 30abcd (a common relaying apparatus). This is because it is not possible for the terminals which participate in the session to use the same communication network relaying apparatus 30 or the same segment relaying apparatus 30.

After completion of the process of selecting the relaying apparatus 30, the session management unit 57 stores the session ID “se1” which is generated at step S44; the terminal ID of the requesting terminal (terminal 10aa); the terminal ID of the destination terminal (terminal 10db); and the relaying apparatus ID of the selected relaying apparatus in the session management table (cf. FIG. 14) of the session management DB 5005 in the non-volatile memory, and thereby the session management unit 57 manages them.

Next, the communication unit 51 (which is shown in FIG. 6B) transmits the session ID which is generated by the session ID generating unit 56a and relaying apparatus connection information to the requesting terminal (terminal 10aa) through the communication network 2 (step S47). The relaying apparatus connection information may include the IP address of the relaying apparatus 30; the authentication information; the port number, and the like. In this manner, the requesting terminal (terminal 10aa) may recognize the relaying apparatus connection information. Here, the relaying apparatus connection information is used for connecting the requesting terminal (terminal 10aa) to the relaying apparatus 30 which is used for relaying image and audio data during execution of the session having the session ID of “se1.”

Next, the communication unit 51 transmits the start request information including the terminal ID of the requesting terminal (terminal 10aa) and the session ID “se1”; the relaying apparatus connection information which is used for connecting a terminal to the relaying apparatus 30; and the IP address of the management system 50 to the destination terminal (terminal 10db) (step S48). In this manner, the communication unit 11 of the terminal 10db receives the start request information. At the same time, the communication unit 11 of the terminal 10db recognizes the relaying apparatus connection information which is used for connecting a terminal to the relaying apparatus 30 (which is used for relaying the content data), and the IP address “1.1.1.2” of the management system 50, which is the transmission source.

Subsequently, the communication unit 51 of the management system 50 transmits relaying start request information indicating a request to start relaying to the relaying apparatus 30, which is selected through the communication network 2 (step S49). The relaying start request information includes IP addresses of the requesting terminal (terminal 10aa) and the destination terminal (terminal 10db), respectively, to which the content data is relayed. In this manner, the relaying apparatus 30 establishes a session (an image/audio data session sed) for communicating low-resolution image data, middle-resolution image data, high-resolution image data, and audio data between the terminals 10aa and 10db (step S50). With this, the terminals 10 can start a video conference.

<Outline of File Sharing Operation>

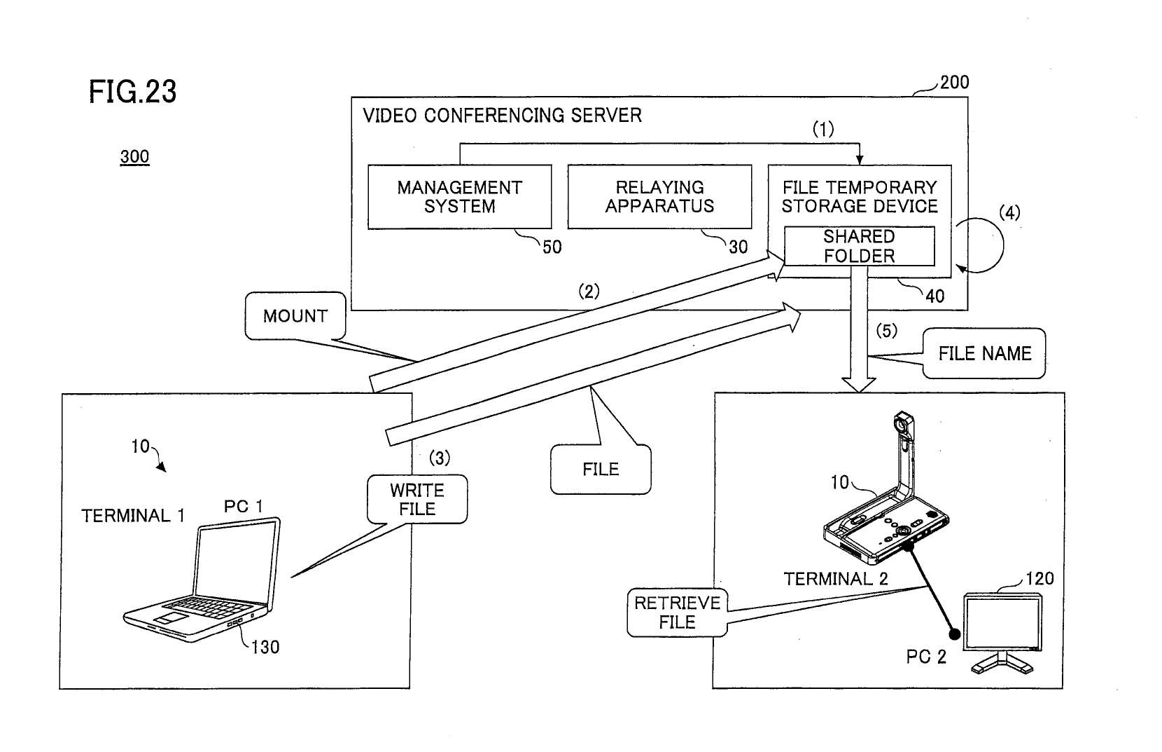

FIG. 23 is a schematic diagram illustrating an outline of example of an electronic conference system 300. The electronic conference system 300 includes a video conferencing server 200 and two or more bases. In FIG. 23, the terminal 1 at the left side includes a PC (PC 1). By attaching a SIM card 130 to the PC 1, the terminal 10 is established. In the terminal 2 at the right side, a PC (PC 2) is connected to a dedicated terminal 10.

The video conferencing server 200 includes the transmission management system (management system) 50; the relaying apparatus 30; and the file temporary storage device 40. The management system 50 provides a service for managing communication among terminals, which participate in a conference. Thus, for example, the management system 50 generates a session ID for identifying a session in which content data such as video and/or audio data is communicated among the terminals. By the session ID, the terminals can be identified which share files in the electronic conference system 300.

The relaying apparatus 30 provides a service for relaying content data. The relaying apparatus 30 optimizes a relay path of content data and resolution by monitoring delay time, for example.

The file temporary storage device 40 provides a service for sharing files among the terminals which participate in a conference. An example is explained in which a file of the PC 1 in FIG. 23 is shared between the terminal 1 and the terminal 2.

(1) When a conference is started, the management system 50 causes the file temporary storage device 40 to create a shared folder. The file temporary storage device 40 creates the shared folder, which is to be shared among the terminals which participate in the conference. The file temporary storage device 40 transmits a shared folder's URI (Uniform Resource Identifier) and account information to the terminals 1 and 2.

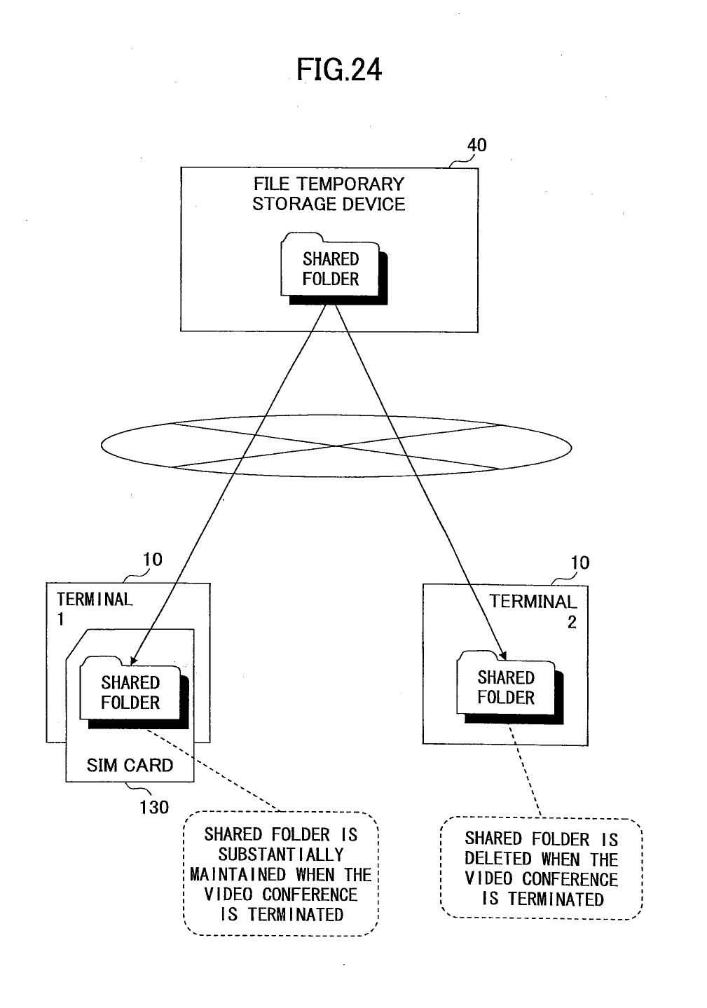

(2) The terminals 1 and 2 mount their folders to the shared folder's URI by using the account information. Here, “to mount” means to enable the shared folder of the file temporary storage device 40 to be used by the terminals 1 and 2, similar to the case in which the terminals 1 and 2 use their own folders. In the dedicated terminal 2, the shared folder is mounted to any portion in the storage area in the terminal 10. In the terminal 1, which includes the PC 1 and the SIM card 130, the shared folder is mounted to a secure storage area inside the SIM card 130. FIG. 24 indicates that state. Here, when the contents of the shared folder are stored inside the SIM card 130 by copying prior to unmounting the shared folder, the shared folder may be mounted to any storage area inside the PC 1.

(3) After the shared folder is mounted, if the PC 1 of the terminal 1 writes a file into the shared folder, the terminal 1 detects writing of the file, and the terminal 1 transmsits the file to the file temporary storage device 40.

(4) The file temporary storage device 40 stores the file in the shared folder.

(5) The file temporary storage device 40 transmits a file name, which is stored in the shared folder, to the terminal 2 to which the shared folder is mounted. The entity of the file is not transmitted to the terminal 2, until an explicit request is received. A user of the PC 2 sees the file name, and if the file is necessary, the user of PC 2 may send a request for mounting the file to the file temporary storage device 40. If there is such a user operation, the PC 2 retrieves the entity of the file from the shared folder through the terminal 2, and the PC 2 may display the entity of the file on a display.

(6) When the conference is terminated, the shared folders of the file temporary storage device 40, the terminal 1, and the terminal 2 are unmounted, and the contents of the shared folders are deleted. However, in the terminal 1, which includes the PC 1 and the SIM card 130, the shared folder is copied onto another portion of the SIM card 130, prior to unmounting, and the contents of the shared folder are substantially maintained. If it is possible to perform unmounting while retaining the data of the shared folder (a case in which the shared folder is changed into a normal folder by unmounting, without deleting the contents of the shared folder), it is not necessary to copy the shared folder to the other portion.

That is because, for the case of the dedicated terminal 2, which may be used by an unspecified user, a security problem may be caused by leaving the contents of the shared folder. For the case of the SIM card 130, which is individually managed by the corresponding user, and which can perform access control based on the PIN, such a security problem may not be caused. Furthermore, there is an advantage such that the shared file can be carried as it is and utilized. For the case of the dedicated terminal 2, if a file which is stored in the shared folder is to be used after terminating the conference, the file may be copied to the PC 2, for example, prior to unmounting the shared folder.

In this manner, a file can be shared between the terminal 1 and the terminal 2, only by writing the file into the shared folder by the PC 1 of the terminal 1. Moreover, with such a configuration, security and usability of the system can be ensured.

In the electronic conference system 300 according to the embodiment, since the file is shared by a service which is different from the relaying apparatus 30, which transmits the content data, the file can be shared among the terminals without affecting the transmission and reception of the content data. Further, since the file temporary storage device 40 manages the file while associating the file with the session ID, the file temporary storage device 40, which is a service different from the management system 50, can manage the sharing of the file. Further, since the file is shared among the terminals having the same session ID, security can be ensured by the session ID.

### An Example

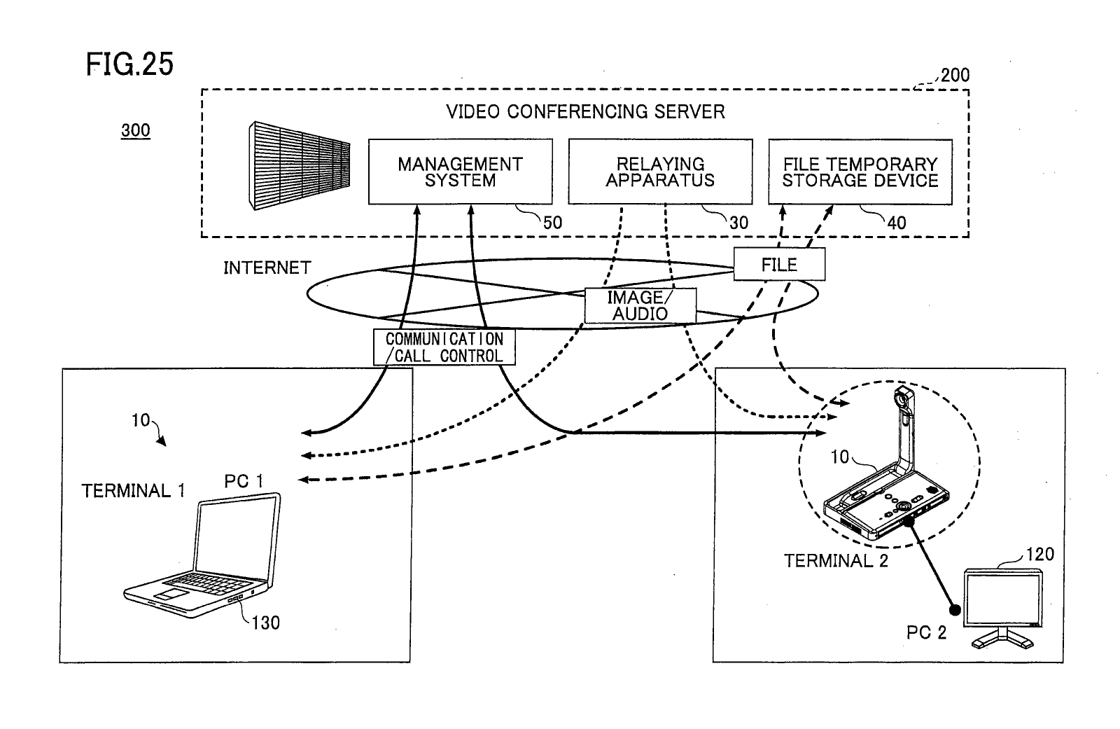

FIG. 25 shows an example of an outline of the electronic conference system 300. The electronic conference system 300 includes the video conferencing server 200 and two or more bases. The video conferencing server 200 includes the management system 50, the relaying apparatus 30, and the file temporary storage device 40. The management system 50 and the relaying apparatus 30 are already explained. It is not necessary that the management system 50, the relaying apparatus 30, and the file temporary storage device 40 be implemented as individual different information processing apparatuses. The management system 50, the relaying apparatus 30, and the file temporary storage device 40 may be implemented in a single information processing apparatus. In the embodiment, this information processing apparatus is referred to as the video conferencing server 200.

As explained above, the management system 50 performs communication control such as establishing a session among terminals 10. The relaying apparatus 30 relays the image data and audio data so that the image data and audio data are transmitted through an optimized path, which is selected by the relaying apparatus 30 for the image data and audio data. The file temporary storage device 40 enables sharing of files among terminals 10.

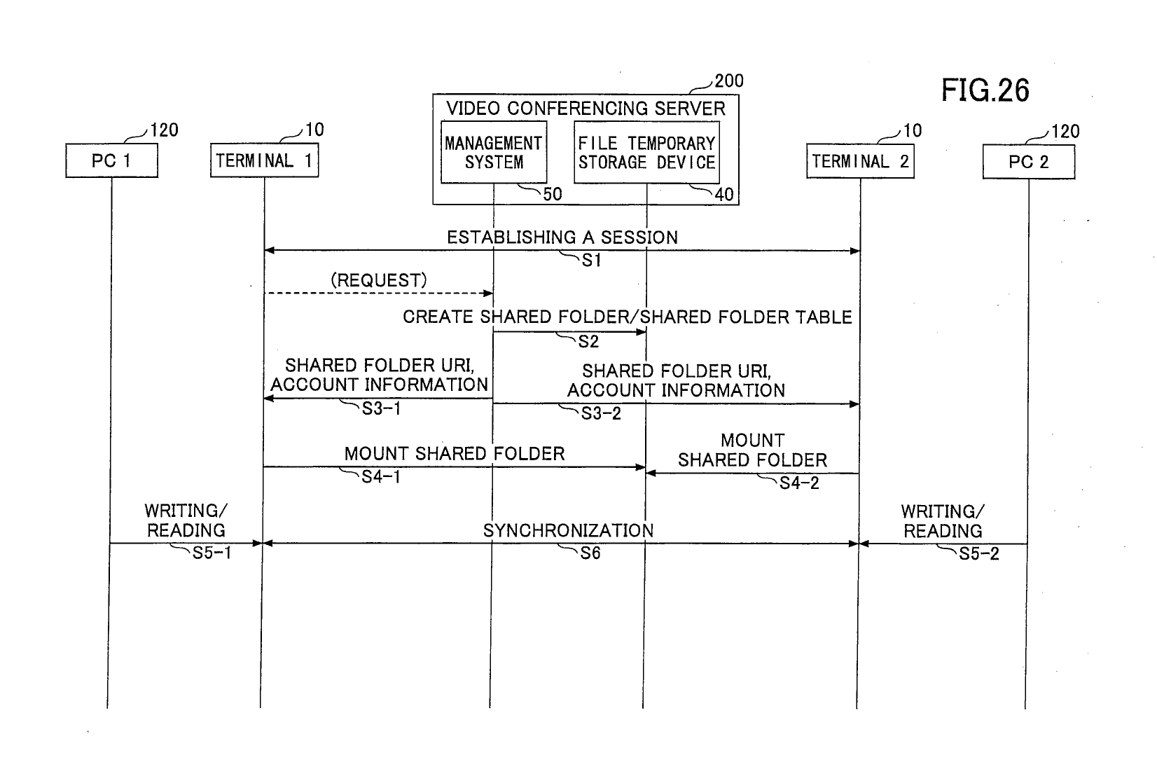

FIG. 26 is an example of a sequence diagram showing procedures for each of the terminals 10 of the electronic conference system 300 to transmit and receive files.

S1. Establishment of Session

A session is established between the terminal 1 and the terminal 2 by the above-described procedure.

S2. The shared folder management unit 61 of the management system 50 causes the file temporary storage device 40 to create the shared folder 47, and creates the shared folder table 48, subsequent to the above-described steps S47 and S48, for example. Since, for the management system 50, the URI of the shared folder 47 is unknown, the management system 50 receives the URI from the file temporary storage device 40. Accordingly, the shared folder creation unit 42 of the file temporary storage device 40 creates the shared folder 47, and the shared folder creation unit 42 transmits the shared folder URI of the shared folder 47 to the management system 50.

The shared folder management unit 61 of the management system 50 transmits the shared folder table 48 including the shared folder URI to the file temporary storage device 40.

Alternatively, the management system 50 may create the shared folder URI in advance. Namely, the shared folder management unit 61 creates the shared folder URI by adding a session ID, for example, to the URL of the file temporary storage device 40. By reporting the shared folder URI as the shared folder table 48 to the file temporary storage device 40, the shared folder creation unit 42 creates the shared folder 47 at the shared folder URI.

The file temporary storage device 40 updates the shared folder table 48 by adding a record to the shared folder table 48 of the file management DB 46.

As described above, when the management system 50 creates the shared folder table 48, the management system 50 creates the account information (the account name and the password). Each of the terminals 10 has the access rights for reading and writing, except for a case in which the management system 50 particularly limits the access rights.

In FIG. 26, after establishing the session, the management system 50 automatically creates the shared folder 47. However, the shared folder 47 may be created only if a request (the “request” indicated by the dashed-line) is received from the terminal 1 (or which may be the terminal 2). In this manner, for a conference in which the shared folder 47 is not utilized, a resource for preparing the shared folder 47 can be saved, and the load may be reduced.

Further, each of the terminals 10 may request establishment of the above-described shared folder table 48 during mounting the mount drive 22.

S3-1/3-2. Notification of the shared folder URI and the account information

When the shared folder 47 is created in the file temporary storage device 40, the shared folder management unit 61 reports the shared folder URI and the account information to each of the terminals 10 which participate in the conference.

S4-1/4-2. Mounting of the shared folder The folder mount units 23 of the terminals 1 and 2 mount the shared folder 47 to the terminals 1 and 2, respectively. For example, a command for mounting is as follows, for a case in which the SMB is utilized.

mount_shared folder_URI account name_password_path to the destination of mounting

The SMB is a protocol for establishing file sharing or printer sharing. By using server/client software “Samba” in which the protocol is implemented, a file can be shared among Linux (registered trademark) device and Windows (registered trademark) devices. Further, an account can be created, and an access right can be set for each of the files or folders.

For a protocol other than the SMB, the command name and the format are different. However, it is the same as the SMB in a point that the mounting can be performed. Other protocols for creating a folder on a network and for sharing a file through the network include WebDAV, CIFS, and NFS, for example.

In this manner, the file synchronization unit 24 and the file synchronization unit 44 communicate, and the shared folder 47 is mounted on the paths, which are specified by the “destination paths of the mounting” of the terminals 1 and 2. The file synchronization unit 44 manages the account names of the terminals 1 and 2 on which the shared folder 47 is mounted, while associating the account names with the shared folder URI. Since the shared folder 47 is managed on the basis of an account name, it is possible that a plurality of the terminals have the same account name.

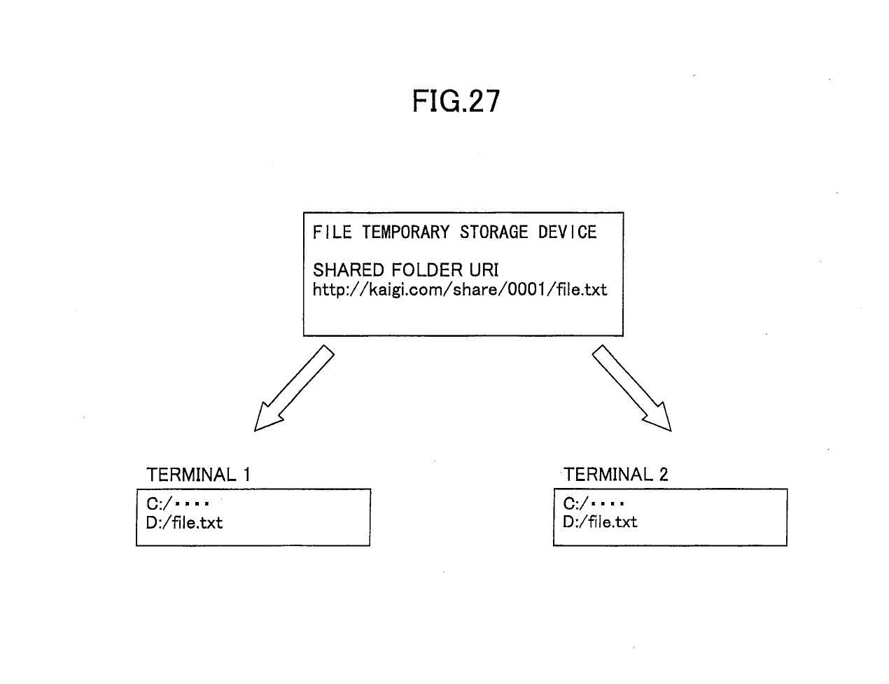

FIG. 27 schematically shows an example of mounting of the shared folder 47. Suppose that the shared folder URI of the file temporary storage device 40 is “http://kaigi.com/share/0001.” Since the terminals 1 and 2 mount the shared folder 47 by specifying this URI, the shared folder 47 is mounted on the terminals 1 and 2. For example, when the terminals 1 and 2 specify the D drives as the destinations of the mounting, the shared folder 47 is mounted as the D drives.

When the file “file.txt” is stored in the shared folder 47 of the file temporary storage device 40, the file synchronization units 24, and 44 communicate, and a file name of “file.txt” is displayed on the D drives of the terminals 1 and 2 (the entity of the file is stored in the shared folder 47).

At the start of the conference, when the previous shared folder is stored in the secure storage area of the SIM card 130, the previous shared folder may be shared again by mounting a new shared folder and subsequently copying the previous shared folder onto the new shared folder.

Further, since the conference is not always held among the same parties, a user may select as to whether to share the previous shared folder. Further, a plurality of the shared folders may be stored, and a user may select a folder to be shared depending on the party of the conference. Alternatively, a shared folder which is associated with the party of the conference may be automatically selected.

S5-1/5-2. Writing/Reading

For example, a file is written in the D drive. Here, it is assumed that terminal 1 writes the file.

S6. Synchronization

The file synchronization unit 24 detects the writing in the D drive. The file synchronization unit 24 specifies the shared folder 47 of the file temporary storage device 40 and transmits the file to the shared folder 47. The file synchronization unit 44 stores the file in the shared folder 47, and the file synchronization unit 44 transmits the file name to the terminal 1 and to the terminal 2, on which the shared folder 47 is mounted. On the D drives of the terminals 1 and 2, the same file name is displayed. The terminal 1 may transmit the file and the terminal ID, and the file temporary storage device 40 may identify the session ID from the terminal ID. If the session ID is identified, the other terminal which participates in the same conference can be identified and the shared folder URI can be retrieved from the shared folder table 48.

[Access Control]

Access control is explained. The file temporary storage device 40 can control access to the shared folder 47 depending on the access right on the reading and/or writing.

FIG. 17B is a diagram showing an example of the shared folder table 48 for controlling the access. Compared to FIG. 17A, it can be found that in the shared folder table 48 of FIG. 17B, the access right is registered with the account name. Namely, the terminal having the terminal ID of “aaa” has an account name of “acc0001_rw,” and has the access right for both reading and writing. The terminals having the terminal IDs of “bbb” or “ddd” have an account name of “acc0001_r,” and have the access right only for reading.

The shared folder management unit 61 gives the access right to the terminal in accordance with the predetermined rules below.
Access right for reading and writing is given to a terminal for which a session is established from the start of the conference, and access right only for reading is given to a terminal which participates in the conference after the start of the conference.
A terminal which starts the conference suitably requests the management system 50 for the access right at the start of the conference.

The shared folder management unit 61 may not give any access right to a terminal by not transmitting the account information to the terminal. In FIG. 17B, no account information is transmitted to a terminal other than the terminals having the terminal IDs of “aaa,” “bbb,” or “ddd” (e.g., a terminal having a terminal ID of “ccc”).

FIG. 17C is a diagram for illustrating another example of the shared folder table 48. In FIG. 17C, a plurality of the shared folders 47 is registered for a single session ID. In this case, for each of the shared folders, access rights for corresponding terminals can be set. For example, the terminals having the terminal ID of “bbb” or “ddd” have the access right only for reading with respect to the shared folder “http://kaigi.com/share/0001/1.” The terminals having the terminal ID of “bbb” or “ddd” have the access right for reading and writing with respect to the shared folder “http://kaigi.com/share/0001/2.” For a case in which there are two shared folders 47, each of the terminals mounts the two folders 47.

The plurality of shared folders 47 is utilized as described below.
The terminal requests to use the plurality of shared folders 47 at the beginning of the conference.
In addition to the shared folder 47 such as shown in FIG. 17B, always an additional shared folder 47 is prepared and the access rights for reading and/or writing are transmitted to all the terminals.

Only the terminal side may perform the access control, or the file temporary storage device 40 side may perform the access control. Alternatively, both the terminal side and the file temporary storage device 40 side may perform the access control. Namely, the access control may be performed by any one of the shared folder 47 of the file temporary storage device 40 and the D drives of the terminals 1 and 2.

For Writing

When the access control is performed by the shared folder 47 of the file temporary storage device 40, the access control unit 43 prevents writing of a file from the terminals 1 and 2 based on the access right.

When the access control is performed by the D drives of the terminals 1 and 2, the file synchronization units 24 prevent writing of a file from the terminals 1 and 2 based on the access right.

For Reading

When the access control is performed by the shared folder 47 of the file temporary storage device 40, the access control unit 43 does not transmit the file name to the terminal not having the access right for reading. When the access control is performed by the D drives of the terminals 1 and 2, the D drives discard the file name even if the file name is transmitted from the file temporary storage device 40, and the file synchronization units 24 do not display the file name.

[Example of File Sharing]

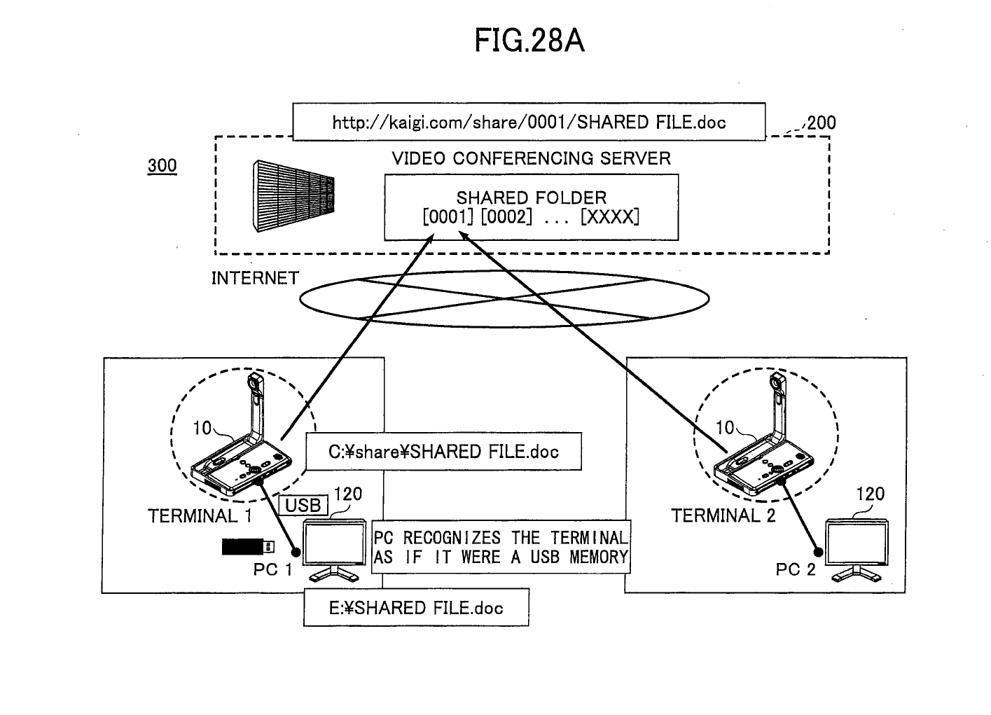

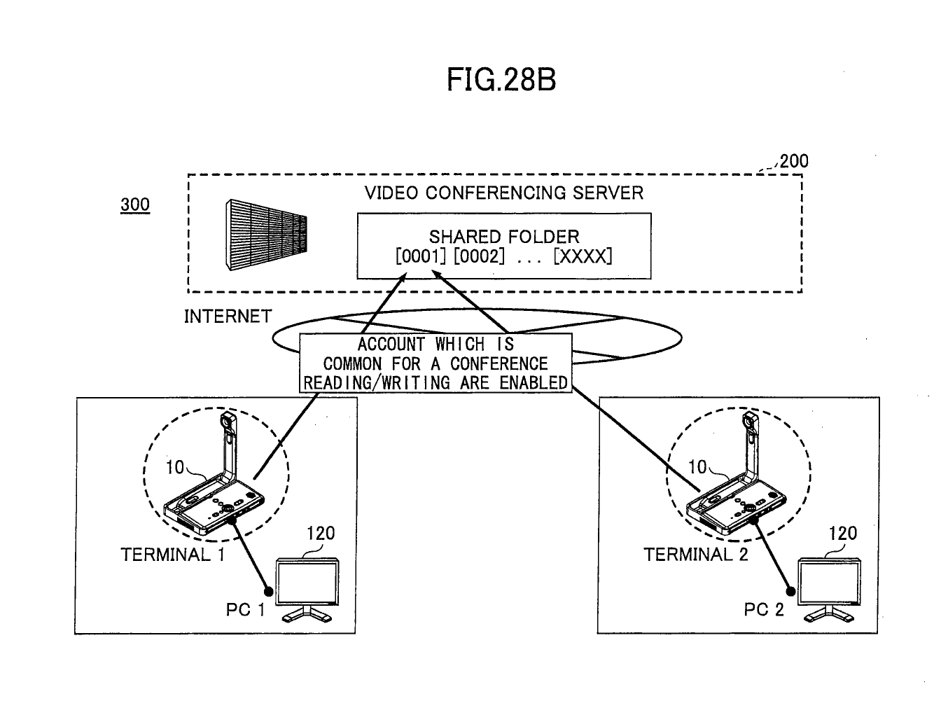

FIGS. 28A and 28B are diagrams schematically illustrating an example of file sharing. It is assumed that the shared folder table 47 of FIG. 17A is utilized. Namely, the terminals 1 and 2 can read and write.

In FIG. 28A, “http://kaigi.com/share/001” is the shared folder 47. In the shred folder 47, a file of the “shared file.doc” is stored. On the terminal 1, for example, a drive of “C:/Share” is mounted. Since the terminals 1 and 2 can be recognized as USB memories from the PC 1 and the PC2, respectively, file management systems of the PC 1 and the PC 2 display them as “E:/shared file.doc.” The E drive is the drive of a USB memory.

In FIG. 28B, a common account is set for the conference. Since the terminals 1 and 2 can read and write, the PC 1 and the PC 2 can share the file which is stored in the “http://kaigi.com/share/0001.”

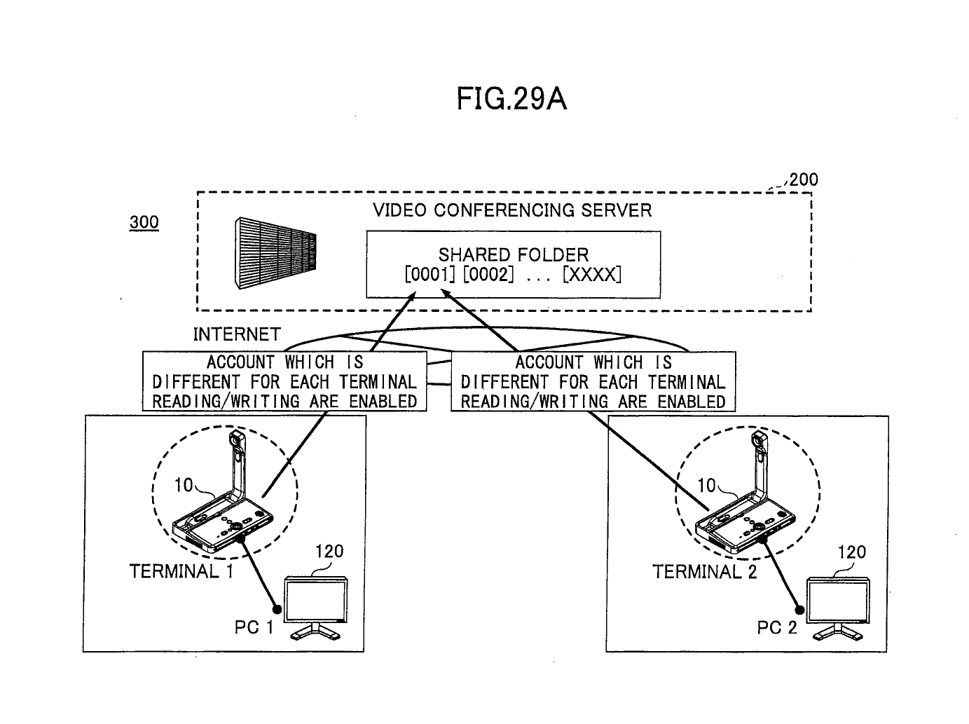

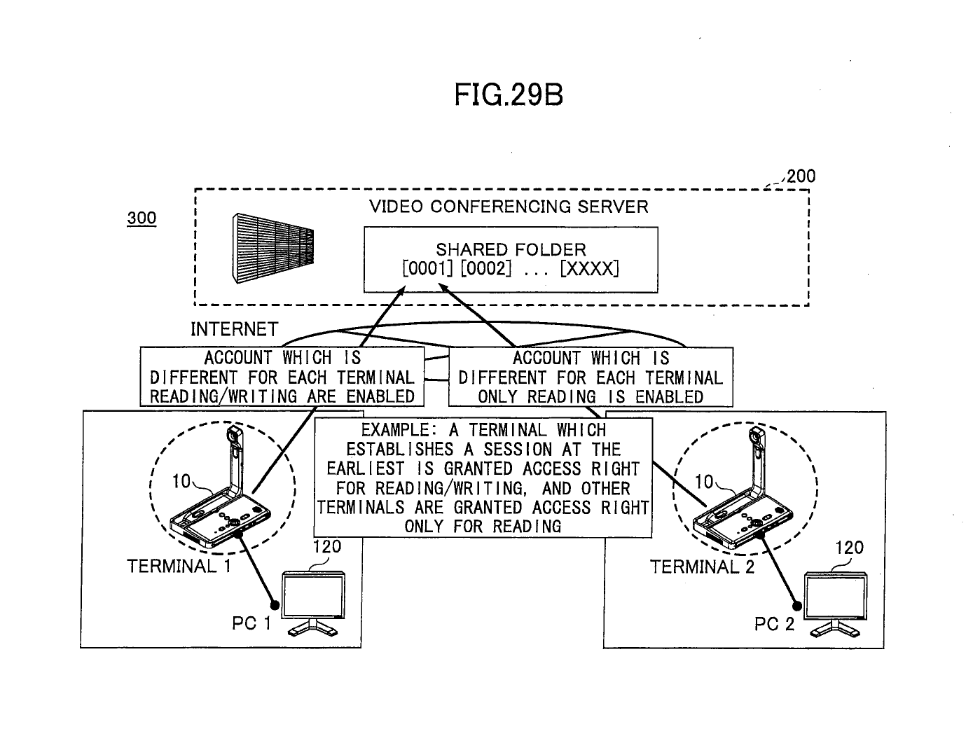

FIGS. 29A and 29B are diagrams schematically illustrating examples of file sharing. As the shared folder table 48 of FIG. 17B, different accounts are registered for different terminals 10. Namely, as the access right of the terminal 1, reading and writing can be individually registered. As the access right for the terminal 2, reading and writing can be individually registered. In FIG. 29A, both the terminals 1 and 2 can read and write, for example.

In FIG. 29B, only the terminal 1, which starts the conference, can read and write, and for the other terminals only the access right for reading is granted. Such access control can be achieved by giving the access right for reading and writing, by the shared folder management unit 61, only to the terminal on which the shared folder 47 is mounted at the earliest timing, or to the terminal which requests to create the shared folder 47 at the earliest timing.

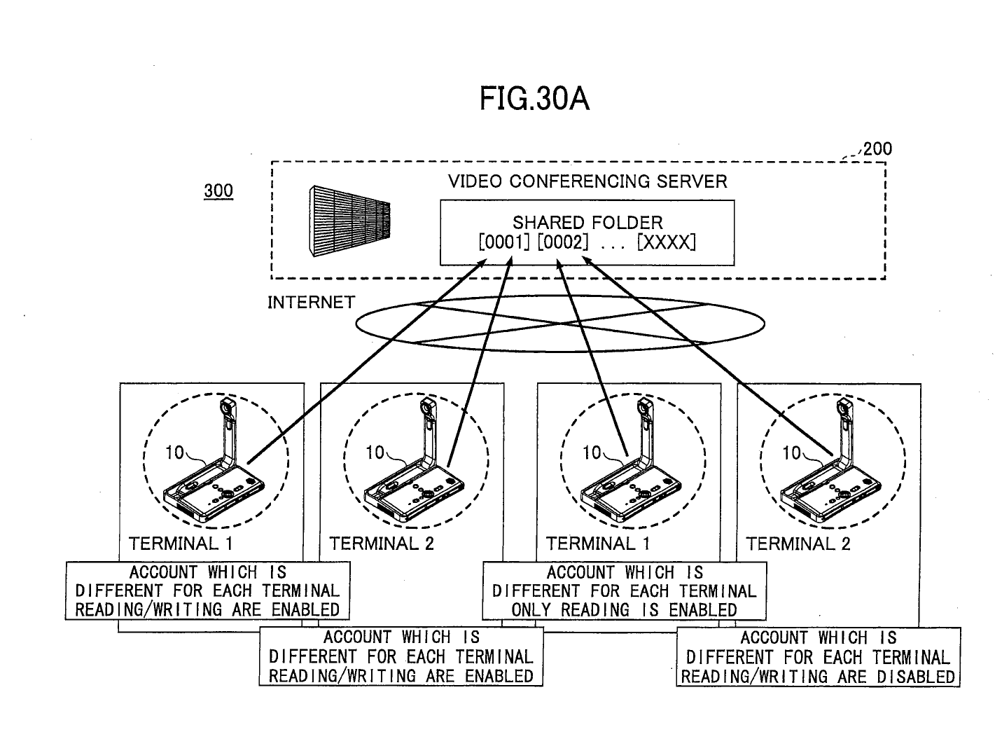

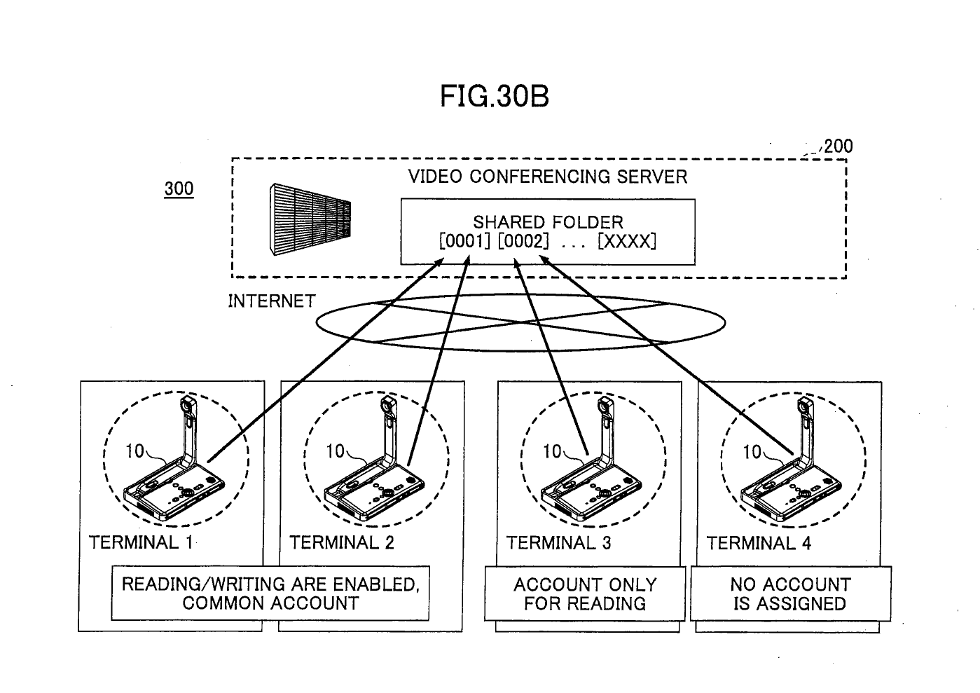

FIGS. 30A and 30B are diagrams schematically illustrating examples of file sharing. As the shared folder table 48 of FIG. 17C, different accounts are registered for different terminals. Namely, for a single conference, two shared folders, which are “http://kaigi.com/share/0001” and “http://kaigi.com/share/0002”, are created.

In FIG. 30A, the terminal 1 can read and write with respect to the shared folder “0001,” however, the terminal 1 can only read with respect to the shared folder “0002.” The terminal 2 can read and write with respect to the shared folder “0001,” however, the terminal 2 cannot read and write with respect to the shared folder “0002.”

FIG. 30B shows four terminals 1-4. A common access right is set for the terminals 1 and 2. The terminals 1 and 2 can read and write with respect to the shared folder “0001.” The terminal 3 can only read with respect to the shared folder “0001.” The access right is not granted for the terminal 4 with respect to the shared folder “0001.” With respect to the shared folder “0002,” the access rights can be individually set for the terminals, or a common access right can be set for the terminals.

By controlling the access right in such a diversified manner, for example, when the conference is a multi-base electronic conference (by the terminals 1, 2, 3, and 4), the management system 50 or the individual terminals can easily achieve the access control such that “the terminals 1 and 2 can read and write; the terminal 3 can only read; and terminal 4 cannot read or write.”

For example, when a conference is conducted among a main office and branch offices, the management system 50 may set the system such that the terminals at the main office can read and write, and the terminals at the branch offices can only read. Consequently, control can be enabled such that documents and data can be distributed from the main office to the branch offices, but documents and data may not uploaded from the branch offices (to prevent tampering of the documents).

As described above, with the electronic conference system 300 according to the embodiment, the terminal 1 and the terminal 2 can share the same file only by writing the file by the PC 1 onto the terminal 1.

### Another Example

Hereinafter, another example of the electronic conference system 300 according to the embodiment is explained in which the terminal 3, which participates in the conference after the start of the conference, can share a file with the terminals 1 and 2. It is assumed that a terminal, which participates in the conference after the start of the conference, is the terminal 3. In this case, synchronization of the file is also enabled when the management system 50 transmits the shared folder URI and the account information to the terminal 3.

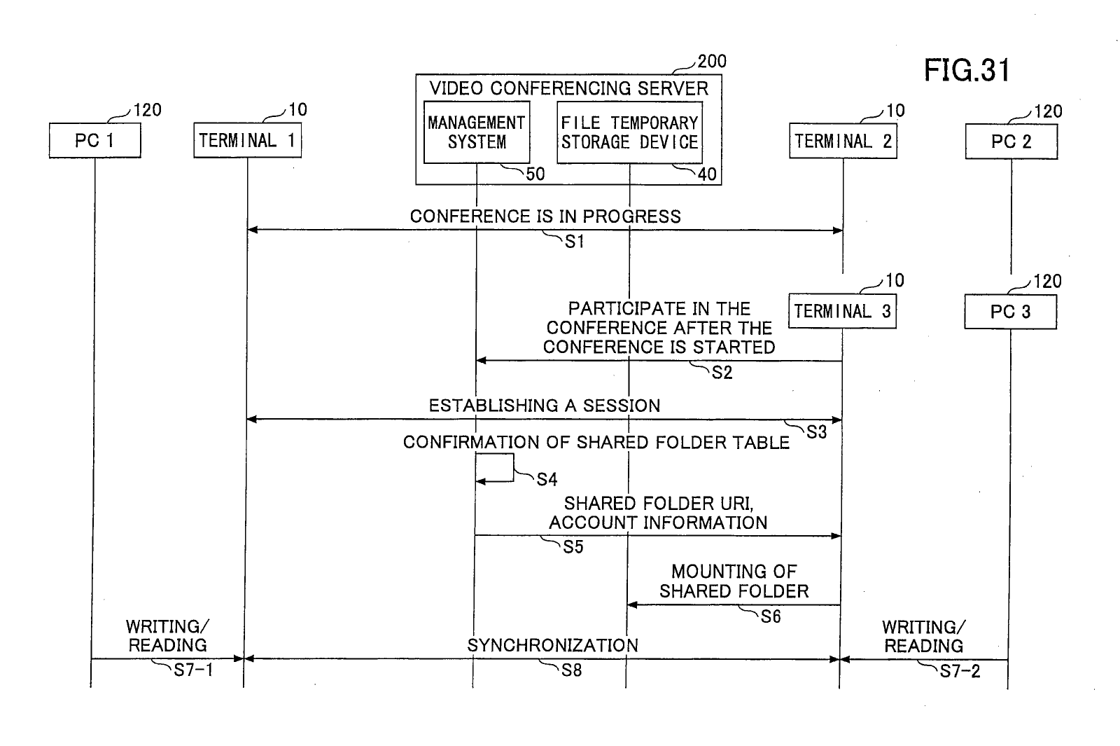

FIG. 31 is a sequence diagram of an example of procedures for the terminals of the electronic conference system 300 to transmit and receive files.

S1. During Conference

The conference is already started between the terminal 1 and the terminal 2. A session is already established.

S2. Participate in the Conference in the Middle

When the power supply of the terminal 3 is turned on, the log-in requesting unit 13 requests the management system 50 to log-in, A user of the PC 3, which is connected to the terminal 3, participates in the conference after the start of the conference by specifying one of the destination terminals (which performs the conference).

S3. Establishment of Session

The management system 50 establishes a session between the terminal 3 and the terminals 1 and 2. The management system 50 identifies the session ID and the other terminals of the conference, in which the terminal 3 is to participate, by referring to the session management table based on the destination terminal.

S4. Confirmation of Shared Folder Table

The shared folder management unit 61 transmits the session ID to the file temporary storage device 40, and thereby the shared folder management unit 61 retrieves the URI of the shared folder 47 and the shared folder table 48 of the conference.

At this time, the access control information is generated. The management system 50 may grant the access right for reading only to the terminal 3, which participates in the conference after the start, or the management system 50 may grant the access right in response to the request from the terminal 3.

S5. Notification of the Shared Folder URI and the Shared Folder Table

The shared folder management unit 61 transmits the shared folder URI and the account information to the terminal 3, which participates in the conference after the start.

S6. Mounting of the Shared Folder

The folder mount unit 23 of the terminal 3 mounts the shared folder 47. By the mounting, synchronization is started between the shared folder 47 of the file temporary storage device 40 and the drive, which is mounted on the terminal. The file synchronization unit 44 transmits the file name of the file, which is stored in the shared folder 47, to the terminal 3. In this manner, the PC 3 can display the file name of the drive which is mounted on the terminal 3 to the display 208, as if it were a USB memory.

According to this example, upon participating in the conference, a file can be shared with the terminal, which participates in the conference after the conference is started. Here, the file has been shared among the parties, prior to the participation of the terminal.

### Another Example

In this example, there is explained the shred folder 47 after terminating the conference. When a file is stored in the shared folder 47 as the above-described examples, it is not preferable to leave as it is from the perspective of security. I is preferable to delete the file.

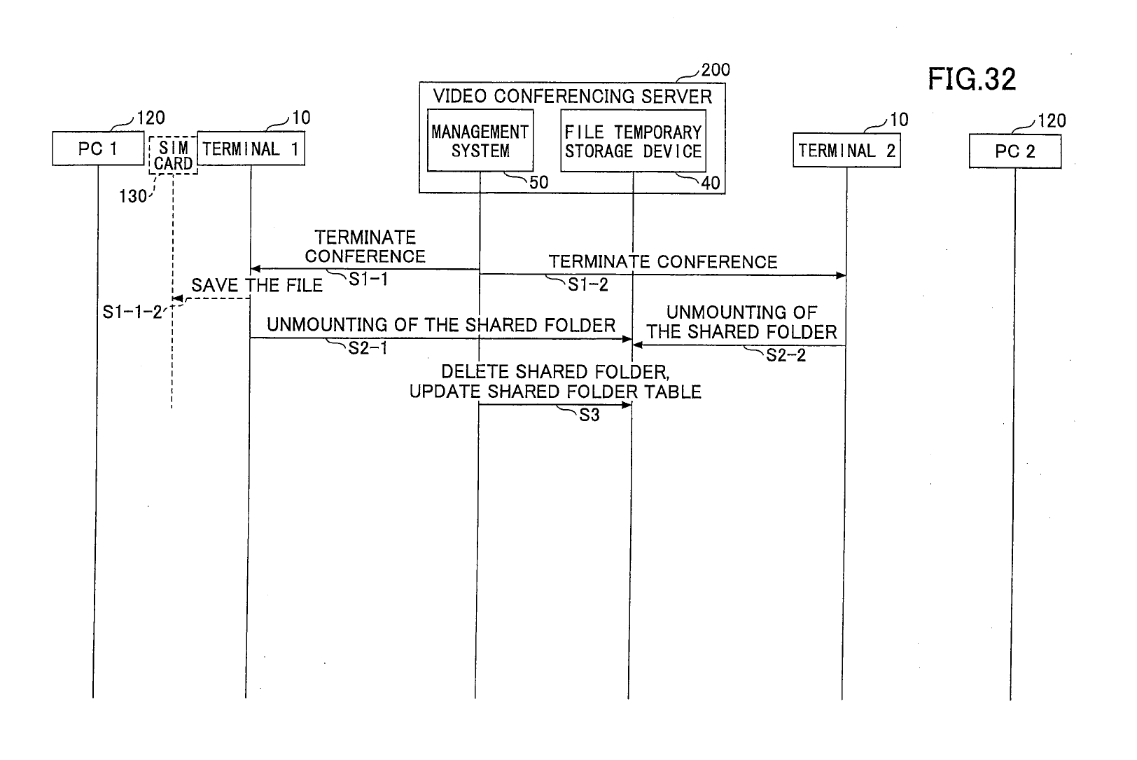

FIG. 32 is a sequence diagram showing an example of procedures for terminating the conference of the electronic conference system 300.

S1-1, S1-2 Termination of the Conference

Examples of the trigger of terminating the conference include notification by one or more terminals 10 of the termination of the conference to the management system 50; and no responses by all the terminals 10 included in the session management table in response to an inquiry from the management system 50. Here, it is assumed that the conference is terminated under management of the management system 50. When the conference is terminated, the management system 50 reports it to the terminals 1 and 2.

S1-1-2 Holding of the Shared Folder

In the terminal 10 which is compatible with the SIM card 130, the contents of the shared folder are stored by copying them into another area of the SIM card 130, prior to unmounting. Here, for the case in which unmounting is performed while leaving the data in the shared folder (the case in which the shared folder is changed into a normal folder by unmounting, and the contents may not be deleted), it is not necessary to copy the data to the other area. Further, the contents may be automatically stored in the SIM card 130. Alternatively, at the time of terminating the conference, the user may be queried whether the contents are to be stored, and the user may determined whether or not to store the contents. Here, since the PIN is already input at the activation of the terminal, the SIM card 130 is in a state in which a file can be written in the SIM card 130. Depending on the implementation, an input of the PIN may be required for each access.

S2-1, 2-2 Unmounting of the Shared Folder

When the folder mount units 23 of the terminals 1 and 2 detect termination of the conference, the folder mount units 23 unmount the shared folder 47 with respect to the file temporary storage device 40. The following is an example of a SMB unmount command:

unmount_destination path of the mounting Further, by unmounting, the file synchronization units 24 delete the D drives which are mounted on the terminals 1 and 2, respectively. By doing this, the PC 1 and the PC 2 become unable to display the file name of the D drives.

S3 Deletion of the Shared Folder

When the conference is terminated, the shared folder creation unit 42 prompts the file temporary storage device 40 to delete the shared folder 47 from the folder storage unit 41, based on the session ID of the terminated conference. The shared folder creation unit 42 deletes all the files which are transmitted from the terminals 10 by deleting the shared folder 47.

Further, the access control unit 43 updates the shared folder table 48 by deleting the terminated conference from the shared folder table 48 of the file management DB 46.

According to this example, the files can be deleted from the file temporary storage device 40 in accordance with the termination of the conference. Consequently, the security can be prevented from being lowered.

### Another Example

In this example, a more secure electronic conference system 300 is explained.

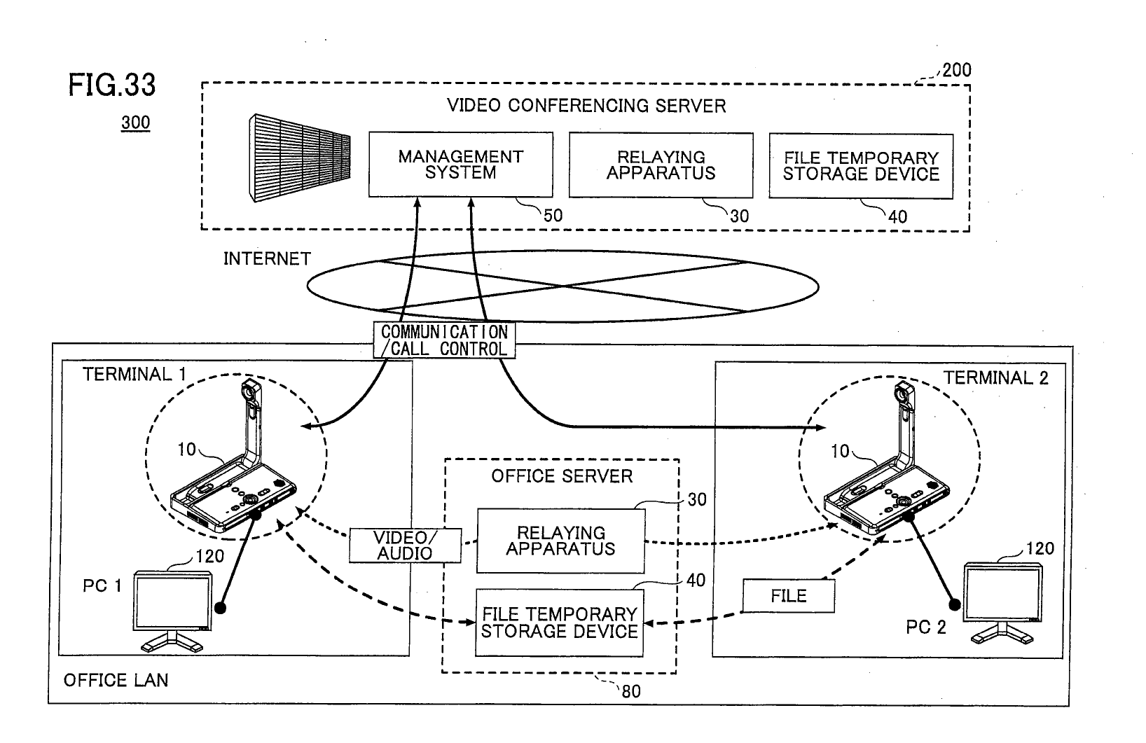

FIG. 33 is a schematic configuration diagram of the electronic conference system 300 according to this example. In FIG. 33, each of components having the same configuration as that of FIG. 25 is denoted by the same reference numeral, and the explanations of the components are omitted.

In FIG. 33, the terminal 1 and the terminal 2 are connected by an office LAN. Further, an office server 80 is installed in the office, and the relaying apparatus 30 and the file temporary storage device 40 are installed in the office server 80. Here, it is not necessary for the office server 80 to be physically installed in the office. The office server 80 may be an external server which is connected by a secure line such as a Virtual Private Network (VPN).

Since the management system 50, which has already established a session, sets a relaying apparatus ID in the session management table, the management system 50 has already identified the relaying apparatus 30 which relays video and audio. Accordingly, by comparing the network addresses in the IP addresses of the relaying apparatus 30 and the terminals 10, it can be found that the terminals 1 and 2 are using the office server 80, which is connected to the office LAN. When the network addresses are not directly retrieved, the IP addresses may be requested from the DNS. If it is determined that the host names are the same, it can be found that the terminals 1 and 2 and the relaying apparatus 30 are connected to the same LAN.

In the configuration such as shown in FIG. 33, since the terminals 1 and 2 can utilize a video/audio router in a private network (e.g., the office LAN), the conference can be performed without leaking the video data and audio data to the outside. In this case, by installing the file temporary storage device 40 in the office LAN, the security for sharing the file can be improved.

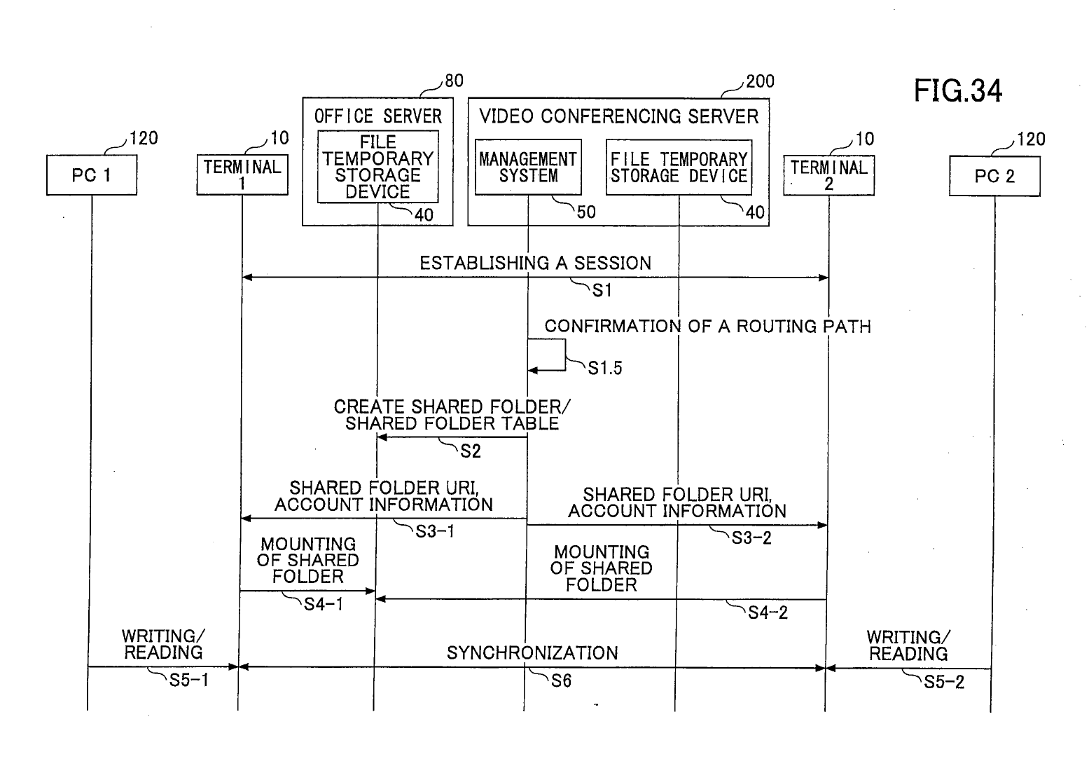

FIG. 34 is a sequence diagram showing an example of procedures for the terminals in the electronic conference system 300 to transmit and receive files. FIG. 34 is substantially the same as FIG. 26 of the first one of the above-described examples. However, FIG. 34 is different from FIG. 26 in a point that the management system 50 confirms a routing path after starting the conference.

S1.5 Confirmation of the Routing Path

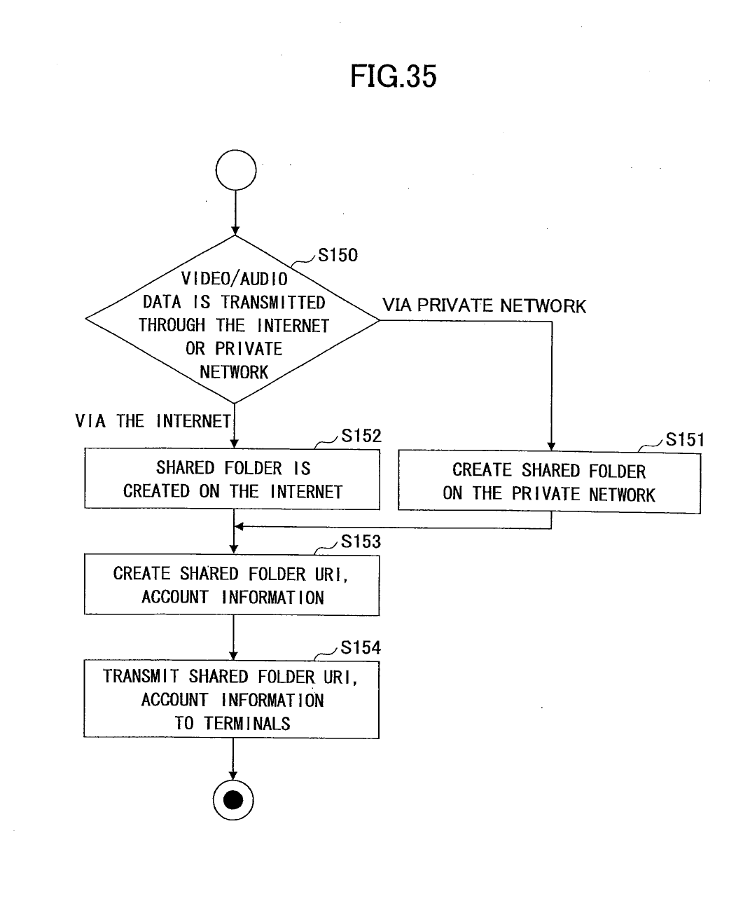

FIG. 35 is a flowchart showing an example of procedures for the management system 50 to confirm the routing path.

The management system 50 confirms the routing path of the conference immediately after starting the conference (S150).

When the Internet is utilized, the shared folder 47 is created on the outside (on the Internet), similar to the case of the first one of the above-described examples (S152).

When the private network is utilized, the shared folder 47 is created inside a server (e.g., a part of the office server 80 or the relaying apparatus 30) which is installed in the private network (S151).

The subsequent processes are the same as those of the first one of the above-described examples. Namely, the management system 50 creates the shared folder URI and the account information, and the management system 50 transmits them to the file temporary storage device 40 (S153).

Further, the management system 50 transmits the shared folder URI and the account information to the terminals 1 and 2 (S154).

In this manner, the terminals 1 and 2 mount the mount drives 22 on the specified URI, without recognizing the location where the files are stored.

According to this example, the shared folder URI may be changed depending on the terminals which participate in the conference. If the private network is utilized, the file can be completely prevented from leaking outside. Consequently, the security risk can be significantly reduced.

The present invention is not limited to the specifically disclosed embodiment, and variations and modifications may be made without departing from the scope of the present invention.

The present application is based on and claims the benefit of priority of Japanese Priority Application No. 2012-201144, filed on Sep. 13, 2012, the entire contents of which are hereby incorporated herein by reference.

What is claimed is:

1. A communication system including a plurality of terminals which participate in a conference and a file sharing apparatus configured to provide a file to the terminals, the communication system comprising:
an attribute storage unit configured to store attributes of the terminals;
a shared folder location information notification unit configured to transmit location information of a shared folder, wherein the shared folder is created based on the attributes of the terminals which participate in the conference; and
a shared folder storage unit configured to store the location information of the shared folder and identification information of the terminals which mount the shared folder, wherein the shared folder storage unit is configured to associate conference identification information with the location information of the shared folder and the identification information of the terminals,
wherein the file sharing apparatus includes
the shared folder which is created at a location indicated by the location information of the shared folder; and
a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference, and
wherein each of the terminals includes
a folder mount unit configured to mount the shared folder on the terminal; and
a second file synchronization unit configured to transmit a second file to the shared folder, wherein the second file is stored in a storage area created by the mounting.

2. The communication system according to claim 1,
wherein the folder mount unit is configured to specify a first secure memory area of a SIM card or a second secure memory area of a large capacity storage associated with the SIM card as a destination of the mounting.

3. The communication system according to claim 2,
wherein, when the shared folder of a previous conference is stored in one of the first secure memory area and the second secure memory area, the file sharing apparatus is configured to cause the shared folder of the previous conference to be automatically shared for a current conference.

4. The communication system according to claim 2,
wherein, when a plurality of the shared folders is stored in the first secure memory area or the second secure memory area, the file sharing apparatus is configured to cause the shared folders to be automatically or manually selected, depending on a counterpart of the current conference.

5. The communication system according to claim 1,
wherein each of the attributes of the terminals stored in the attribute storage unit includes a first attribute of a predetermined communication network and a second attribute of an area, wherein the terminal is connected to the network in the area.

6. The communication system according to claim 1,
wherein the conference identification information is session information for identifying a session in which data is communicated among the terminals.

7. An information processing apparatus for providing a file to a plurality of terminals wherein the terminals participate in a conference, and each of the terminals includes a folder mount unit configured to mount a shared folder to the terminal; a second synchronization unit configured to transmit a second file to the shared folder, wherein the second file is stored in a storage area created by the mounting, the information processing apparatus comprising:
an attribute storage unit configured to store attributes of the terminals;
a shared folder location information notification unit configured to transmit location information of the shared folder, wherein the shared folder is created based on the attributes of the terminals which participate in the conference;
a shared folder storage unit configured to store the location information of the shared folder and identification information of the terminals which mount the shared folder, wherein the shared folder storage unit is configured to associate conference identification information with the location information of the shared folder and the identification information of the terminals;
the shared folder which is created at a location indicated by the location information of the shared folder; and
a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference.

8. A terminal configured to connected to a communication system,
wherein the communication system includes
a plurality of terminals which participate in a conference;
a file sharing apparatus configured to provide a file to the terminals;
an attribute storage unit configured to store attributes of the terminals;
a shared folder location information notification unit configured to transmit location information of a shared folder, wherein the shared folder is created based on the attributes of the terminals which participate in the conference; and
a shared folder storage unit configured to store the location information of the shared folder and identification information of the terminals which mount the shared folder, wherein the shared folder storage unit is configured to associate conference identification information with the location information of the shared folder and the identification information of the terminals,
wherein the file sharing apparatus includes
the shared folder which is created at a location indicated by the location information of the shared folder; and
a first file synchronization unit configured to transmit the file to the terminals, wherein, when a first file is stored in the shared folder from a first terminal, the first file synchronization unit is configured to transmit first file information to the terminals other than the first terminal which participate in the conference, wherein the first terminal participates in the conference, and
wherein the terminal comprises:
a folder mount unit configured to mount the shared folder on the terminal; and
a second file synchronization unit configured to transmit a second file to the shared folder, wherein the second file is stored in a storage area created by the mounting.
